(19) United States
(12) Patent Application Publication
(10) Pub. No.: US 2026/0053095 A1
(43) Pub. Date: Feb. 26, 2026

(54) HEADER TRAILER SYSTEM

(71) Applicant: DOSE STEEL WORKS, INC., Story City, IA (US)

(72) Inventor: Brett Dose, Ankeny, IA (US)

(21) Appl. No.: 19/308,676

(22) Filed: Aug. 25, 2025

Related U.S. Application Data
(60) Provisional application No. 63/686,999, filed on Aug. 26, 2024.

(51) Int. Cl. A01D 75/00; B62D 13/02; B62D 63/06; B62D 63/08

(52) U.S. Cl. CPC A01D 75/002; B62D 13/025; B62D 63/068; B62D 63/08

(57) ABSTRACT

In one or more arrangements, a trailer system is presented. In one or more arrangements, the trailer system includes a front wheel assembly having wheels and a rear wheel assembly having wheels. In one or more arrangements, the wheels of the front wheel assembly turn when the trailer is performing a turn and the wheels of the rear wheel assembly turn when the trailer is performing a turn. In one or more arrangements, the trailer system is configured to support an agricultural implement.

### CROSS-REFERENCE TO RELATED APPLICATIONS

This application claims the benefit of U.S. Provisional Application No. 63/686,999 titled HEADER TRAILER SYSTEM and filed on Aug. 26, 2024, the entirety of which is hereby incorporated by reference herein, including any and all figures, tables, drawings, and other information.

### FIELD OF THE DISCLOSURE

This disclosure relates to a trailer. More specifically, this disclosure relates to a trailer configured to facilitate the transportation of an agricultural implement, such as a combine header.

### OVERVIEW OF THE DISCLOSURE

In order to facilitate efficiency in farming row crops, agricultural implements such as combine headers have become larger to allow farmers to cover more rows with each pass through a field. While this created efficiency in farming operations, this has caused certain agricultural implements to far exceed road width restrictions.

With specific reference to combine headers, a combine having a 6-row header attached is capable of being driven down the road without violating road width restrictions. However, once the combine header goes beyond 6 rows, which is desirable to increase efficiency in farming operations, the combine header must be removed from the combine and placed on a trailer to transport.

Current combine header trailers support the headers, however they are rigid and incapable of allowing a combine to turn tight corners without causing the trailer to jackknife and damage the combine (or other towing vehicle such as a truck) and the trailer itself. This creates safety hazards as well as requires equipment to be replaced due to damage. This is especially troublesome when considering many rural roads may not have wide clearances and other vehicles may be traveling on those same roads, making it impossible to perform wider turns, where possible.

Therefore, for all the reasons stated above, and the reasons stated below, there is a need in the art for an improved header trailer which can take tight turns without causing damage to the combine (or other towing vehicle) and the trailer itself. Thus, it is a primary objective of the disclosure to provide a header trailer that improves upon the state of the art.

Another objective of the disclosure is to provide a header trailer which is safe to operate.

Yet another objective of the disclosure is to provide a header trailer which is able to comply with road travel restrictions.

Yet another objective of the disclosure is to provide a header trailer which is relatively easy to build.

Another objective of the disclosure is to provide a header trailer which is relatively friendly to build.

Yet another objective of the disclosure is to provide a header trailer which can be built relatively quickly and efficiently.

Another objective of the disclosure is to provide a header trailer which is easy to operate.

Yet another objective of the disclosure is to provide a header trailer which is relatively cost friendly to manufacture.

Another objective of the disclosure is to provide a header trailer which is relatively easy to transport.

Yet another objective of the disclosure is to provide a header trailer which is aesthetically appealing.

Another objective of the disclosure is to provide a header trailer which is robust.

Another objective of the disclosure is to provide a header trailer which is relatively inexpensive.

Yet another objective of the disclosure is to provide a header trailer which is not easily susceptible to wear and tear.

Another objective of the disclosure is to provide a header trailer which has a long useful life.

Yet another objective of the disclosure is to provide a header trailer which is efficient to use and operate.

These and other objects, features, or advantages of the disclosure will become apparent from the specification, figures, and claims.

### SUMMARY OF THE DISCLOSURE

In one or more arrangements, a trailer system is presented. In one or more arrangements, the trailer system includes a front wheel assembly having wheels and a rear wheel assembly having wheels. In one or more arrangements, the wheels of the front wheel assembly rotate when the trailer is performing a turn and the wheels of the rear wheel assembly rotate when the trailer is performing a turn. In one or more arrangements, the trailer system is configured to to support an agricultural implement. In one or more arrangements, the rear wheel assembly includes a slew bearing to allow for smooth turning of the wheels of the rear wheel assembly. In one or more arrangements, the front wheel assembly and the rear wheel assembly are operably connected via a steering assembly which translates the turning of the wheels of the front wheel assembly to the turning of the wheels of the rear wheel assembly.

### BRIEF DESCRIPTION OF THE FIGURES

FIG. 1 is a perspective view of a header trailer system in accordance with one or more arrangements; the view showing the system having a tongue assembly, a front wheel assembly, a steering assembly, rear wheel assemblies, and a frame assembly.

FIG. 2 is a perspective view of a header trailer system in accordance with one or more arrangements; the view showing the system having a tongue assembly, a front wheel assembly, a steering assembly, rear wheel assemblies, and a frame assembly.

FIG. 3 is a perspective view of a header trailer system in accordance with one or more arrangements; the view showing the system having a tongue assembly, a front wheel assembly, a steering assembly, rear wheel assemblies, and a frame assembly.

FIG. 4 is a perspective view of a header trailer system in accordance with one or more arrangements; the view showing the system having a tongue assembly, a front wheel assembly, a steering assembly, rear wheel assemblies, and a frame assembly.

FIG. 5 is a side view of a header trailer system in accordance with one or more arrangements; the view showing the system having a tongue assembly, a front wheel assembly, a steering assembly, rear wheel assemblies, and a frame assembly.

FIG. 6 is a side view of a header trailer system in accordance with one or more arrangements; the view showing the system having a tongue assembly, a front wheel assembly, a steering assembly, rear wheel assemblies, and a frame assembly.

FIG. 7 is a front view of a header trailer system in accordance with one or more arrangements; the view showing the system having a tongue assembly, a front wheel assembly, rear wheel assemblies, and a frame assembly.

FIG. 8 is a rear view of a header trailer system in accordance with one or more arrangements; the view showing system having a front wheel assembly, rear wheel assemblies, and a frame assembly.

FIG. 9 is a top view of a header trailer system in accordance with one or more arrangements; the view showing the system having a tongue assembly, a front wheel assembly, a steering assembly, rear wheel assemblies, and a frame assembly.

FIG. 10 is a bottom view of a header trailer system in accordance with one or more arrangements; the view showing the system having a tongue assembly, a front wheel assembly, a steering assembly, rear wheel assemblies, and a frame assembly.

FIG. 11 is a perspective view of a header trailer system in accordance with one or more arrangements; the view showing the system having a tongue assembly, a front wheel assembly, a steering assembly, and rear wheel assemblies.

FIG. 12 is a side view of a header trailer system in accordance with one or more arrangements; the view showing the system having a tongue assembly, a front wheel assembly, a steering assembly, and rear wheel assemblies.

FIG. 13 is a top view of a header trailer system in accordance with one or more arrangements; the view showing the system having a tongue assembly, a front wheel assembly, a steering assembly, and rear wheel assemblies.

FIG. 14 is a bottom view of a header trailer system in accordance with one or more arrangements; the view showing the system having a tongue assembly, a front wheel assembly, a steering assembly, and rear wheel assemblies; the view showing the system making a turn.

FIG. 15 is a bottom view of a header trailer system in accordance with one or more arrangements; the view showing the system having a tongue assembly, a front wheel assembly, a steering assembly, and rear wheel assemblies; the view also showing the system making a turn.

FIG. 16 is a bottom view of a header trailer system in accordance with one or more arrangements; the view showing the system having a tongue assembly, a front wheel assembly, a steering assembly, and rear wheel assemblies; the view also showing the front wheel assembly, and the tongue assembly turned 180 degrees from their forward positions.

FIG. 17 is a detail view of a header trailer system in accordance with one or more arrangements; the view showing the system having a tongue assembly, a front wheel assembly, a steering assembly, and rear wheel assemblies; the detail view also showing the tongue assembly, front wheel assembly, steering assembly, and rear wheel assemblies in the following situations: (1) when each are at their forward position; (2) when each are performing a turn to one side which causes the tongue assembly and front wheel assembly to be rotated 90 degrees from the forward position; (3) when each are performing a turn which causes the tongue assembly and front wheel assembly to be rotated 180 degrees from the forward position; and (4) when each are performing a turn to the other side which causes the tongue assembly and front wheel assembly to be rotated 270 (or 90) degrees from the forward position.

FIG. 18 is a detail view of a header trailer system in accordance with one or more arrangements; the view showing the system having a tongue assembly, a front wheel assembly, a partial steering assembly; the detail view also showing the tongue assembly, front wheel assembly, and partial steering assembly in the following situations: (1) when each are at their forward position; (2) when each are performing a turn to one side which causes the tongue assembly and front wheel assembly to be rotated 90 degrees from the forward position; (3) when each are performing a turn which causes the tongue assembly and front wheel assembly to be rotated 180 degrees from the forward position; and (4) when each are performing a turn to the other side which causes the tongue assembly and front wheel assembly to be rotated 270 (or 90) degrees from the forward position.

FIG. 19 is a detail view of a header trailer system in accordance with one or more arrangements; the view showing the system having a partial steering assembly and rear wheel assemblies; the detail view also showing the partial steering assembly and rear wheel assemblies in the following situations: (1) when each are at their forward position; (2) when each are performing a turn to one side which causes the tongue assembly and front wheel assembly to be rotated 90 degrees from the forward position; (3) when each are performing a turn which causes the tongue assembly and front wheel assembly to be rotated 180 degrees from the forward position; and (4) when each are performing a turn to the other side which causes the tongue assembly and front wheel assembly to be rotated 270 (or 90) degrees from the forward position.

FIG. 20 is an exploded view of a header trailer system in accordance with one or more arrangements; the view showing the system having a tongue assembly, a front wheel assembly, and a partial steering assembly.

FIG. 21 is an exploded view of a rear wheel assembly of a header trailer system in accordance with one or more arrangements.

FIG. 22 is a top view of a header trailer system in accordance with one or more arrangements; the view showing the system having a tongue assembly, a front wheel assembly, a steering tube, a rear wheel assembly, and a frame assembly.

FIG. 23 is a perspective view of a header trailer system in accordance with one or more arrangements; the view showing the system having a tongue assembly, a front wheel assembly, a steering tube, a rear wheel assembly, and a frame assembly.

FIG. 24 is a top view of a header trailer system in accordance with one or more arrangements; the view showing the system having a tongue assembly, a front wheel assembly, a steering tube, and a rear wheel assembly; the view showing the system making a turn.

FIG. 25 is a top view of a header trailer system in accordance with one or more arrangements; the view showing the system having a tongue assembly, a front wheel assembly, a steering tube, and a rear wheel assembly; the view showing the system making a turn.

FIG. 26 is a side view of a header trailer system in accordance with one or more arrangements; the view showing the system having a tongue assembly, a front wheel assembly, a steering tube, and a rear wheel assembly.

FIG. 27 is a top view of a header trailer system in accordance with one or more arrangements; the view showing the system having a tongue assembly, a front wheel assembly, a steering tube, and a rear wheel assembly.

FIG. 28 is a bottom view of a header trailer system in accordance with one or more arrangements; the view showing the system having a tongue assembly, a front wheel assembly, a steering tube, a rear wheel assembly, and a frame assembly.

FIG. 29 is a side view of a header trailer system in accordance with one or more arrangements; the view showing the system having a tongue assembly, a front wheel assembly, a steering tube, a rear wheel assembly, and a frame assembly.

FIG. 30 is a front view of a header trailer system in accordance with one or more arrangements; the view showing the system having a tongue assembly, a front wheel assembly, a steering tube, a rear wheel assembly, and a frame assembly.

FIG. 31 is a side view of a header trailer system in accordance with one or more arrangements; the view showing the system having a tongue assembly, a front wheel assembly, a steering tube, a rear wheel assembly, and a frame assembly.

FIG. 32 is a rear view of a header trailer system in accordance with one or more arrangements; the view showing the system having a tongue assembly, a steering tube, a rear wheel assembly, and a frame assembly.

FIG. 33 is an exploded view of a header trailer system in accordance with one or more arrangements; the view showing the system having a tongue assembly, a front wheel assembly, and a partial steering tube.

FIG. 34 is a detail view of a tongue assembly and front wheel assembly of a header trailer system in accordance with one or more arrangements; the view showing the tongue assembly and front wheel assembly; the detail view also showing the tongue assembly and front wheel assembly in the following situations: (1) when each are at their forward position; (2) when each are performing a turn to one side; and (3) when each are performing a turn to the other side.

FIG. 35 is an exploded view of a header trailer system in accordance with one or more arrangements; the view showing the system having a tongue assembly, a front wheel assembly, a steering tube, and a rear wheel assembly.

FIG. 36 is a perspective view of a header trailer system in accordance with one or more arrangements; the view showing the system having a tongue assembly, a front wheel assembly, a steering tube, a rear wheel assembly, and a frame assembly.

FIG. 37 is a perspective view of a header trailer system in accordance with one or more arrangements; the view showing the system having a tongue assembly, a front wheel assembly, a steering tube, a rear wheel assembly, and a frame assembly.

FIG. 38 is a perspective view of a header trailer system in accordance with one or more arrangements; the view showing the system having a tongue assembly, a front wheel assembly, a steering tube, a rear wheel assembly, and a frame assembly.

FIG. 39 is a perspective view of a header trailer system in accordance with one or more arrangements; the view showing the system having a tongue assembly, a front wheel assembly, a steering tube, a rear wheel assembly, and a frame assembly.

FIG. 40 is a detail view of a header trailer system in accordance with one or more arrangements; the view showing the tongue assembly, a front wheel assembly, a steering tube, and a rear wheel assembly; the detail view also showing the tongue assembly, a front wheel assembly, a steering tube, and a rear wheel assembly in the following situations: (1) when each are at their forward position; (2) when each are performing a turn to one side; and (3) when each are performing a turn to the other side.

FIG. 41 is an exploded view of a rear wheel assembly of a header trailer system in accordance with one or more arrangements.

FIG. 42 is a detail view of a header trailer system in accordance with one or more arrangements; the view showing the system having a partial steering tube and a rear wheel assembly; the detail view also showing the partial steering assembly and the rear wheel in the following situations: (1) when each are at their forward position; (2) when each are performing a turn to one side; and (3) when each are performing a turn to the other side.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages, benefits, and/or improvements discussed herein may not be provided by various disclosed embodiments, or implementations thereof. The claimed embodiments are not so limited and should not be interpreted as being restricted to embodiments which provide such advantages or improvements. Similarly, it should be understood that various embodiments may not address all or any objects of the disclosure or objects of the invention that may be described herein. The claimed embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of an agricultural implement trailer, specifically a combine header trailer. However, the embodiments are not so limited. It is appreciated that the embodiments may be adapted for use in other applications which may be improved by the disclosed structures, arrangements and/or methods. The system is merely shown and described as being used in the context of a combine header trailer for ease of description and as one of countless examples.

### Header Trailer System

With reference to the figures, a header trailer system 10 (or simply “system 10”) is presented. System 10 is formed of any suitable size, shape, and design and is configured to facilitate the transportation of agricultural implements such as a combine header. In the arrangement shown, as one example, system 10 has a forward end 12, a rearward end 14, a left side 16, a right side 18, a top side 20, and a bottom side 22. In the arrangement shown, as one example, system 10 includes a tongue assembly 24, a front wheel assembly 26, a steering assembly 28, a rear wheel assembly 30, and a frame assembly 32.

In the arrangement shown, as one example, system 10 is capable of performing sharp turns without causing damage to the combine (or other towing vehicle) or the trailer itself. In order to do so, in the arrangement shown as one example, system 10 includes an elongated tongue assembly 24 which provides sufficient clearance between the combine (or other towing vehicle) and the remainder of system 10, such as frame assembly 32. In the arrangement shown, as one example, system 10 also includes a front wheel assembly 26 which is capable of rotating 360 degrees, thereby allowing the front wheels to turn more sharply. Additionally, in the arrangement shown, as one example, system 10 includes a steering assembly 28 which operably transfers the rotation of the front wheel assembly 26 to the rear wheel assemblies 30, meaning system 10 provides for all-wheel steering.

Finally, in the arrangement shown, as one example, the setup of the rear wheel assemblies 30 allows for the wheels of the rear wheel assemblies 30 to accommodate for the heavy weight of combine headers, specifically, the wheels of the rear wheel assemblies 30 have a camber which causes the wheels to extend outward as they extend upward from the road when there is no combine header on system 10. However, in this arrangement as one example, once a combine header (or other farm implement) is placed on system 10, the weight of the combine header (or other farm implement) forces the upper end of the wheels inward such that they are approximately parallel with respect to the surface of the road.

### Tongue Assembly 24:

In the arrangement shown, as one example, system 10 includes tongue assembly 24. Tongue assembly 24 is formed of any suitable size, shape, and design and is configured to connect system 10 to a combine or other towing vehicle in order to transport system 10 and the agricultural implements placed on system 10, such as a combine header. In the arrangement shown, as one example, tongue assembly 24 includes a coupler 34, an elongated tube 36, and connection members 38.

Coupler 34: In the arrangement shown, as one example, tongue assembly 24 includes coupler 34. Coupler 34 is formed of any suitable size, shape, and design and is configured to operably connect to the hitch of a combine, tractor, truck, or other towing vehicle in order to facilitate connection between such towing vehicle and system 10. Coupler 34 may be any type of trailer coupler used in the industry. In the arrangement shown, as one example, coupler 34 is operably connected to elongated tube 36.

Elongated Tube 36: In the arrangement shown, as one example, tongue assembly 24 includes elongated tube 36. Elongated tube 36 is formed of any suitable size, shape, and design and is configured to operably connect coupler 34 to the remainder of system 10 and provide sufficient clearance between the towing vehicle and the remainder of system 10, including frame assembly 32.

In the arrangement shown, as one example, elongated tube 36 is formed of a single, unitary member that is formed in a manufacturing process such as machining, forming, rolling, bending, or the like to form a unitary and monolithic member. Alternatively, elongated tube 36 may be formed of multiple pieces that are connected or assembled to one another through any means of connection including welding, bolting, friction fitting, screwing, or the like. In the arrangement shown, as one example, elongated tube 36 is formed primarily of a metallic material such as steel, aluminum, chromium, or any other metallic material, alloy, and/or composite thereof. Alternatively, elongated tube 36 may be formed of a non-metallic material such as a plastic material, a fiberglass material, or any other non-metallic material and/or composite thereof.

In the arrangement shown, as one example, elongated tube 36 is an elongated square tube extending between a first end 40 and a second end 42. While in the arrangement shown. as one example, elongated tube 36 is shown as a square tube, any other shape, design, or layout of elongated tube 36 may be used in order to connect coupler 34 to the remainder of system 10. In the arrangement shown, as one example, elongated tube 36 operably connects to coupler 34 at its first end 40, and to connection members 38 at its second end 42.

Connection Members 38: In the arrangement shown, as one example, tongue assembly 24 includes connection members 38. Connection members 38 are formed of any suitable size, shape, and design and are configured to operably connect tongue assembly 24 to front wheel assembly 26. In the arrangement shown, as one example, connection members 38 are oval-shaped members which connect to the second end 42 of elongated tube 36 and to the bracket 52 of the torsion axle 46 of front wheel assembly 26.

While tongue assembly 24 and its component parts have been described according to the arrangement shown, as one example, it will be understood by those skilled in the art that any other configuration of tongue assembly 24 and its component parts may be used in order to connect system 10 to a combine or other towing vehicle in order to transport system 10 and the agricultural implements placed on system 10, such as a combine header.

### Front Wheel Assembly 26:

In the arrangement shown, as one example, system 10 includes front wheel assembly 26. Front wheel assembly 26 is formed of any suitable size, shape, and design and is configured to operably connect to tongue assembly 24, steering assembly 28, and frame assembly 32, and help facilitate the movement and turning of system 10 when system 10 is on the road. In the arrangement shown, as one example, front wheel assembly 26 includes a torsion axle 46, wheels 48, and a slew bearing 50.

Torsion Axle 46: In the arrangement shown, as one example, front wheel assembly 26 includes torsion axle 46. Torsion axle 46 is formed of any suitable size, shape, and design and is configured to operably connect front wheel assembly 26 to tongue assembly 24 and to operably connect the wheels 48 of front wheel assembly 26 to slew bearing 50. In the arrangement shown, as one example, torsion axle 46 includes a bracket 52, an axle tube 54, an arm 56, a spindle 58, and a hub 60.

In the arrangement shown, as one example, torsion axle 46 is formed of multiple pieces that are connected or assembled to one another through welding, bolting, and friction fitting, however any other means of connecting or assembling the multiple pieces may be used. In the arrangement shown, as one example, torsion axle 46 is formed primarily of a metallic material such as steel, aluminum, chromium, or any other metallic material, alloy, and/or composite thereof. Alternatively, torsion axle 46 may be formed of a non-metallic material such as a plastic material, a fiberglass material, or any other non-metallic material and/or composite thereof.

In the arrangement shown, as one example, torsion axle 46 includes a bracket 52. Bracket 52 is formed of any suitable size, shape, and design and is configured to operably connect to the connection members 38 of tongue assembly 24 and to the inner member 68 of slew bearing 50. In the arrangement shown, as one example, bracket 52 is a metallic, generally rectangular member with openings configured to receive screws, bolts, or other means of connection therein in order to operably connect bracket 52 to connection members 38 of tongue assembly 24 and to the inner member 68 of slew bearing 50. In the arrangement shown, as one example, bracket 52 also includes an opening (not shown) for axle tube 54 to extend therethrough.

Additionally, in the arrangement shown, as one example, bracket 52 includes an upper opening which is configured to receive a portion of first tie rod 90 of steering assembly 28 therein and hold such portion of first tie rod 90 therein within close and tight tolerances. With first tie rod 90 held in close and tight tolerances within the upper opening of bracket 52, bracket 52 helps operably connect front wheel assembly 26 to steering assembly 28. In the arrangement shown, as one example, this arrangement of first tie rod 90 being received within the upper opening of bracket 52 allows first tie rod 90 to rotate along with bracket 52, thereby allowing steering assembly 28 to operate and transfer the rotation of wheels 48 of front wheel assembly 26 to the wheels 170 of rear wheel assemblies 30.

In the arrangement shown, as one example, torsion axle 46 includes axle tube 54. Axle tube 54 is formed of any suitable size, shape, and design and is configured to connect to bracket 52 and arm 56 of torsion axle 46. In the arrangement shown, as one example, axle tube 54 extends through both sides of bracket 52 in order to connect the two sides of torsion axle 46. That is, torsion axle 46 is mirrored such that it has an arm 56, spindle 58, and hub 60 on both ends of axle tube 54.

In the arrangement shown, as one example, at both the first and second end of axle tube 54 is an arm 56. Arms 56 is formed of any suitable size, shape, and design and is configured to operably connect to axle tube 54 and spindle 58. In the arrangement shown, as one example, spindle 58 is formed of any suitable size, shape, and design and is configured to connect to both arm 56 and hub 60. In the arrangement shown, as one example, hub 60 is configured to connect to the wheels 48 of front wheel assembly 26. In the arrangement shown, as one example, hub 60 includes threaded members 62 which are configured to extend through openings 64 in wheels 48 in order to properly position and connect wheels 48 to hub 60. In this way, torsion axle 46 operably connects wheels 48 of front wheel assembly 26 to the remainder of front wheel assembly 26.

Wheels 48: In the arrangement shown, as one example, front wheel assembly 26 includes wheels 48. Wheels 48 are formed of any suitable size, shape, and design and are configured to facilitate the driving of system 10 on a road. In the arrangement shown, as one example, wheels 48 include openings which are configured to operably receive and connect to hubs 60 of torsion axle 46. In the arrangement shown, as one example, wheels 48 include openings 64 which are configured to allow the threaded members 62 of hubs 60 to extend through wheels 48 in order to properly position and connect wheels 48 to hubs 60. More specifically, bolts are configured to be threaded onto threaded members 62 after the threaded members 62 are extended through the openings 64 of wheels 48, thereby connecting wheels 48 to hubs 60. In the arrangement shown, as one example, wheels 48 may be any type of wheel in the industry.

Slew Bearing 50: In the arrangement shown, as one example, front wheel assembly 26 includes slew bearing 50. Slew bearing 50 is formed of any suitable size, shape, and design and is configured to operably connect to torsion axle 46 as well as steering assembly 28 and frame assembly 32, and to help facilitate the turning of wheels 48. In the arrangement shown, as one example, slew bearing 50 includes an inner member 68, ball bearings (not shown), and an outer member 70.

In the arrangement shown, as one example, inner member 68 is a generally circular, planar member made of a metallic material. In the arrangement shown, as one example, inner member 68 has a thickness between an upper surface 72 and a lower surface (not shown) and an opening 76 extending through the geographic center of inner member 68. In the arrangement shown, as one example, inner member 68 also includes holes 78 configured to receive bolts therethrough.

In the arrangement shown, as one example, outer member 70 is also a generally circular, planar member made of a metallic material. In the arrangement shown, as one example, outer member 70 has a thickness between an upper surface 80 and a lower surface (not shown) and an opening 84 extending through the geographic center of outer member 70. In the arrangement shown, as one example, outer member 70 also includes holes 86 configured to receive bolts therethrough.

In the arrangement shown, as one example, the opening 84 in the center of outer member 70 is approximately sized such that the inner member 68 may rest within the opening 84 in outer member 70. In this manner, outer member 70 and inner member 68 form approximately concentric circles. In the arrangement shown, as one example, inner member 68 and outer member 70 includes grooves (not shown). In the arrangement shown, as one example, the groove in the outer member 70 is on its interior surface (not shown) and the groove in the inner member 68 is on its exterior surface (not shown). In the arrangement shown, as one example, ball bearings are placed in the grooves such that they rest within both the grooves in the inner member 68 and outer member 70. In this way, inner member 68 and outer member 70 are operably connected by the ball bearings, but the ball bearings allow inner member 68 and outer member 70 to rotate relative to each other.

In the arrangement shown, as one example, the inner member 68 of slew bearing 50 is configured to operably connect to the bracket 52 of torsion axle 46 by passing a bolt, screw, or other fastening member through the holes 78 of inner member 68 and through corresponding holes in bracket 52. In this way, slew bearing 50 operably connects to torsion axle 46.

In the arrangement shown, as one example, the outer member 70 of slew bearing 50 operably connects to the flange 270 of the vertical member 268 of front connection assembly 260 of frame assembly 32. In this way, slew bearing 50 also operably connects to frame 32. Finally, the opening 76 of inner member 68 (and the opening 84 of outer member 70) allow first tie rod 90 of steering assembly 28 to extend therethrough and connect to bracket 52 of torsion axle 46, thereby operably connecting the front wheel assembly 26 to steering assembly 28.

In one or more arrangements, this set up of slew bearing 50 provides a number of benefits and slew bearing 50 is advantageous to use in system 10. Specifically, compared to other types of bearings, slew bearings generally have lower friction, which leads to much greater durability, which means slew bearing 50 will not need to be replaced as often as other types of bearings may need to be. Further, slew bearings allow for smoother and more controlled rotation of the inner member 68 relative to the outer member 70, which produces smoother and more efficient turns of system 10. Finally, slew bearings are capable of supporting heavier loads than other types of bearings and because combine headers and other agricultural implements are extremely heavy, slew bearing 50 is capable of use even when other bearings would fail under the load. Therefore, it is advantageous to use slew bearing 50 compared to other bearings.

In the arrangement shown, as one example, when the vehicle towing system 10 turns, the tongue assembly 24 moves in the direction the vehicle is turning, which causes the bracket 52 of torsion axle 46 to move in that direction as well. When the bracket 52 of torsion axle 46 moves, the inner member 68 of slew bearing 50 rotates in that direction and the wheels 48 of front wheel assembly 26 of system 10 turn in that direction. In the arrangement shown, as one example, the ball bearings of slew bearing 50, which operably connect inner member 68 to outer member 70, allow inner member 68 to rotate while outer member 70 remains approximately unmoved relative to inner member 68. That is, while inner member 68 rotates, outer member 70 does not rotate (or at least not as much as inner member 68). In this manner, slew bearing 50 operates to allow wheels 48 to turn without bending or putting pressure on the frame assembly 32 of system 10. In the arrangement shown, as one example, when bracket 52 of torsion axle 46 moves, it also causes the first tie rod 90 of steering assembly 28, which is operably connected to bracket 52, to rotate. When first tie rod 90 rotates with bracket 52 of torsion axle 46, steering assembly 28 operates to transfer the turning of the wheels 48 of front wheel assembly 26 to the wheels 170 of rear wheel assemblies 30.

While front wheel assembly 26 and its component parts have been described according to the arrangement shown, as one example, it will be understood by those skilled in the art that any other configuration of front wheel assembly 26 and its component parts may be used in order to operably connect to tongue assembly 24, steering assembly 28, and frame assembly 32, and help facilitate the movement and turning of system 10 when system 10 is on the road.

### Steering Assembly 28:

In the arrangement shown, as one example, system 10 includes steering assembly 28. Steering assembly 28 is formed of any suitable size, shape, and design and is configured to operably transfer the rotation of the front wheel assembly 26 to the rear wheel assemblies 30, thereby providing system 10 with all-wheel steering. In the arrangement shown, as one example, steering assembly 28 includes a first tie rod 90 having a first pivot arm 92, a second tie rod 94, a third tie rod 96 having a second pivot arm 98 and a third pivot arm 100, a steering tube 102, at least one rear axle pivot arm 104, and a fourth tie rod 106.

First Tie Rod 90: In the arrangement shown, as one example, steering assembly 28 includes a first tie rod 90. First tie rod 90 is formed of any suitable size, shape, and design and is configured to operably connect to an upper opening in bracket 52 of torsion axle 46 of front wheel assembly 26 in order to operably connect steering assembly 28 to front wheel assembly 26.

In the arrangement shown, as one example, first tie rod 90 is generally cylindrical and elongated, however first tie rod 90 may be shaped or designed in any other manner including being elongated and generally rectangular in shape or triangular in shape, or any other shape or design.

In the arrangement shown, as one example, first tie rod 90 may be formed of a single, unitary member that is formed in a manufacturing process such as machining, extrusion, forming, casting, additive manufacturing, or the like to form a unitary and monolithic member. Alternatively, first tie rod 90 may be formed of multiple pieces that are connected or assembled to one another through bolting, welding, screwing, friction fitting, or the like or any other means of connecting two members. In the arrangement shown, as one example, first tie rod 90 is formed primarily of a metallic material such as steel, aluminum, chromium, or any other metallic material, alloy, and/or composite thereof. Alternatively, first tie rod 90 may be formed of a non-metallic material such as a plastic material, a fiberglass material, or any other non-metallic material and/or composite thereof.

In the arrangement shown, as one example, first tie rod 90 extends a length between a first end 108 and a second end 110. In the arrangement shown, as one example, the first end 108 of first tie rod 90 is positioned at the lower end of first tie rod 90 and is configured to be received within bracket 52 of torsion axle 46 of front wheel assembly 26. In the arrangement shown, as one example, this first end 108 of first tie rod 90 is held within close and tight tolerances in bracket 52. In the arrangement shown, as one example, first tie rod 90 extends upward from first end 108 to the second end 110. In the arrangement shown, as one example, the second end 110 of first tie rod 90 includes an opening configured to operably connect first pivot arm 92 to second end 110.

In the arrangement shown, as one example, first tie rod 90 includes first pivot arm 92. First pivot arm 92 is formed of any suitable size, shape, and design and is configured to rotate (at least substantially) with first tie rod 90 and operably transfer the rotation of first tie rod 90 to third tie rod 96 through second tie rod 94. In the arrangement shown, as one example, first pivot arm 92 is generally in the shape of an ovoid (or generally egg-shaped) with a first end having a radius that is either larger or smaller than the radius of the second end.

In the arrangement shown, as one example, the end having the larger radius includes an engagement member 112 which is inserted into the opening in the second end 110 of first tie rod 90. In the arrangement shown, as one example, when the engagement member 112 is placed into the opening in the second end 110 of first tie rod 90, the first pivot arm 92 is able to rotate with first tie rod 90. In the arrangement shown, as one example, first tie rod 90 is configured to rotate along with wheels 48 of front wheel assembly 26, all the way up to 360 degrees, and first pivot arm 92 is also configured to rotate all the way up to 360 degrees.

In the arrangement shown, as one example, the end of first pivot arm 92 with the smaller radius includes an opening 114 configured to operably receive and connect to the engagement member 120 on the first end 116 of second tie rod 94.

Second Tie Rod 94: In the arrangement shown, as one example, steering assembly 28 includes second tie rod 94. Second tie rod 94 is formed of any suitable size, shape, and design and is configured to help transfer the rotation of first tie rod 90 and first pivot arm 92 to third tie rod 96.

In the arrangement shown, as one example, second tie rod 94 is generally cylindrical and elongated, however second tie rod 94 may be shaped or designed in any other manner including being elongated and generally rectangular in shape or triangular in shape, or any other shape or design.

In the arrangement shown, as one example, second tie rod 94 may be formed of a single, unitary member that is formed in a manufacturing process such as machining, extrusion, forming, casting, additive manufacturing, or the like to form a unitary and monolithic member. Alternatively, second tie rod 94 may be formed of multiple pieces that are connected or assembled to one another through bolting, welding, screwing, friction fitting, or the like or any other means of connecting two members. In the arrangement shown, as one example, second tie rod 94 is formed primarily of a metallic material such as steel, aluminum, chromium, or any other metallic material, alloy, and/or composite thereof. Alternatively, second tie rod 94 may be formed of a non-metallic material such as a plastic material, a fiberglass material, or any other non-metallic material and/or composite thereof.

In the arrangement shown, as one example, second tie rod 94 extends a length between a first end 116 and a second end 118, and engagement members 120 are present at each of the first end 116 and second end 118 of second tie rod 94. In the arrangement shown, as one example, the first end 116 of second tie rod 94 is configured to operably connect to first pivot arm 92 of first tie rod 90. In the arrangement shown, as one example, the engagement member 120 present at the first end 116 of second tie rod 94 is configured to be inserted through the opening 114 of first pivot arm 92 and is operably connected to first pivot arm 92 through any means of connection including screwing, bolting, welding, friction fitting, or any other means of connection. In this way, second tie rod 94 is operably connected to first tie rod 90.

In the arrangement shown, as one example, the engagement member 120 present at the second end 118 of second tie rod 94 is configured to operably connect to second pivot arm 98 of third tie rod 96. More specifically, in the arrangement shown, as one example, the engagement member 120 present at the second end 118 of second tie rod 94 is configured to be inserted through the opening 126 of second pivot arm 98 of third tie rod 96 and is operably connected to second pivot arm 98 through any means of connection including screwing, bolting, welding, friction fitting, or any other means of connection. In this way, second tie rod 94 is operably connected to third tie rod 96.

Third Tie Rod 96: In the arrangement shown, as one example, steering assembly 28 includes a third tie rod 96. Third tie rod 96 is formed of any suitable size, shape, and design and is configured to operably connect to second tie rod 94 and to steering tube 102 in order to help transfer the rotation of first tie rod 90 (and wheels 48 of front wheel assembly 26) to the wheels 170 of rear wheel assemblies 30.

In the arrangement shown, as one example, third tie rod 96 is generally cylindrical and elongated, however third tie rod 96 may be shaped or designed in any other manner including being elongated and generally rectangular in shape or triangular in shape, or any other shape or design.

In the arrangement shown, as one example, third tie rod 96 may be formed of a single, unitary member that is formed in a manufacturing process such as machining, extrusion, forming, casting, additive manufacturing, or the like to form a unitary and monolithic member. Alternatively, third tie rod 96 may be formed of multiple pieces that are connected or assembled to one another through bolting, welding, screwing, friction fitting, or the like or any other means of connecting two members. In the arrangement shown, as one example, third tie rod 96 is formed primarily of a metallic material such as steel, aluminum, chromium, or any other metallic material, alloy, and/or composite thereof. Alternatively, third tie rod 96 may be formed of a non-metallic material such as a plastic material, a fiberglass material, or any other non-metallic material and/or composite thereof.

In the arrangement shown, as one example, third tie rod 96 extends a length between a first end 122 and a second end 124. In the arrangement shown, as one example, the first end 122 of third tie rod 96 is positioned at the top of third tie rod 96 and is configured to operably connect to second tie rod 94. In the arrangement shown, as one example, the first end 122 of third tie rod 96 includes second pivot arm 98. Second pivot arm 98 is formed of any suitable size, shape, and design and is configured to rotate as first tie rod 90 rotates, which subsequently causes third tie rod 96 to rotate, which operably transfers such rotation to third pivot arm 100. In the arrangement shown, as one example, second pivot arm 98 is generally in the shape of an ovoid (or generally egg-shaped) with a first end having a radius that is either larger or smaller than the radius of the second end.

In the arrangement shown, as one example, the end of second pivot arm 98 having a smaller radius includes an opening 126 configured to operably receive and connect to the engagement member 120 on the second end 118 of second tie rod 94, as previously described herein. In this way, second tie rod 94 is operably connected to third tie rod 96 through second pivot arm 98, and second pivot arm 98 is configured to rotate as second tie rod 94 moves in response to the rotation of first tie rod 90.

In the arrangement shown, as one example, second pivot arm 98 may be configured to rotate less than 180 degrees, however second pivot arm 98 is not so limited and second pivot arm 98 may be configured to rotate any number of degrees, even up to 360 degrees in alternative arrangements. In the arrangement shown, as one example, as first tie rod 90 rotates, first pivot arm 92 also rotates, which causes second tie rod 94 to be pulled forward or pushed backward. As second tie rod 94 is pulled forward or pushed backward, second pivot arm 98 is rotated along with second tie rod 94. Because second tie rod 94 is only pulled forward or pushed backward, the range of rotation of second pivot arm 98 is effectively less than the range of rotation of first pivot arm 92. In one or more arrangements, as examples, second pivot arm 98 may only rotate up to approximately 30 degrees clockwise and 30 degrees counterclockwise relative to the natural resting position of second pivot arm 98 when system 10 is traveling straight down a road. In further arrangements, as examples, second pivot arm 98 may only rotate up to approximately 45 degrees clockwise and 45 degrees counterclockwise relative to the natural resting position of second pivot arm 98 when system 10 is traveling straight down a road. In further alternative arrangements, as examples, second pivot arm 98 may be configured to rotate any number of degrees, even up to 360 degrees, relative to the natural resting position of second pivot arm 98 when system 10 is traveling straight down a road.

In the arrangement shown, as one example, the end of second pivot arm 98 having the larger radius includes an engagement member 128 which is inserted into an opening in the first end 122 of third tie rod 96. In the arrangement shown, as one example, when the engagement member 128 is placed into the opening in the first end 122 of third tie rod 96, the engagement member 128 is held within the opening in close and tight tolerances, such that the rotation of second pivot arm 98 causes third tie rod 96 to rotate.

In the arrangement shown, as one example, third tie rod 96 extends downward from first end 122 to second end 124. In the arrangement shown, as one example, the second end 124 of third tie rod 96 includes third pivot arm 100. Third pivot arm 100 is formed of any suitable size, shape, and design and is configured to operably connect to third tie rod 96 and steering tube 102, rotate with third tie rod 96, and operably transfer the rotation of third tie rod 96 to the turning of wheels 170 of rear wheel assemblies 30 through steering tube 102. In the arrangement shown, as one example, third pivot arm 100 is generally in the shape of an ovoid (or generally egg-shaped) with a first end having a radius that is either larger or smaller than the radius of the second end.

In the arrangement shown, as one example, the end of third pivot arm 100 having the larger radius includes an engagement member 130 which is inserted into an opening in the second end 124 of third tie rod 96. In the arrangement shown, as one example, when the engagement member 130 is placed into the opening in the second end 124 of third tie rod 96, the third pivot arm 100 is able to rotate with third tie rod 96.

In the arrangement shown, as one example, the degree of rotation of third tie rod 96 is nearly identical to the degree of rotation of second pivot arm 98, and the degree of rotation of third pivot arm 100 is nearly identical to the degree of rotation of third tie rod 96 and, consequently, the degree of rotation of third pivot arm 100 is nearly identical to the degree of rotation of second pivot arm 98. That means, just like second pivot arm 98, third pivot arm 100 may be configured to rotate less than 180 degrees, however third pivot arm 100 is not so limited and third pivot arm 100 may be configured to rotate any number of degrees, even up to 360 degrees in alternative arrangements. In the arrangement shown, as one example, as first tie rod 90 rotates, first pivot arm 92 also rotates, which causes second tie rod 94 to be pulled forward or pushed backward. As second tie rod 94 is pulled forward or pushed backward, second pivot arm 98 is rotated along with second tie rod 94. Because second tie rod 94 is only pulled forward or pushed backward, the range of rotation of second pivot arm 98 is effectively less than the range of rotation of first pivot arm 92. In one or more arrangements, as examples, second pivot arm 98 may only rotate up to approximately 30 degrees clockwise and 30 degrees counterclockwise relative to the natural resting position of second pivot arm 98 when system 10 is traveling straight down a road. In this arrangement, as one example, third pivot arm 100 likewise may only rotate up to approximately 30 degrees clockwise and 30 degrees counterclockwise relative to the natural resting position of third pivot arm 100 when system 10 is traveling straight down a road. In further arrangements, as examples, second pivot arm 98 may only rotate up to approximately 45 degrees clockwise and 45 degrees counterclockwise relative to the natural resting position of second pivot arm 98 when system 10 is traveling straight down a road. In this arrangement, as one example, third pivot arm 100 likewise may only rotate up to approximately 45 degrees clockwise and 45 degrees counterclockwise relative to the natural resting position of third pivot arm 100 when system 10 is traveling straight down a road. In further alternative arrangements, as examples, second pivot arm 98 may be configured to rotate any number of degrees, even up to 360 degrees, relative to the natural resting position of second pivot arm 98 when system 10 is traveling straight down a road. In this arrangement, as one example, third pivot arm 100 likewise may rotate any number of degrees, even up to 360 degrees, relative to the natural resting position of third pivot arm 100 when system 10 is traveling straight down a road.

In the arrangement shown, as one example, the end of third pivot arm 100 with the smaller radius includes an opening 132 configured to operably receive and connect to the engagement member 140 on the first end 136 of steering tube 102.

Steering Tube 102: In the arrangement shown, as one example, steering assembly 28 includes steering tube 102. Steering tube 102 is formed of any suitable size, shape, and design and is configured to transfer the rotation of third pivot arm 100 to the at least one rear axle pivot arm 104 and ultimately to wheels 170 of rear wheel assemblies 30.

In the arrangement shown, as one example, steering tube 102 is a generally square and elongated tube member, however steering tube 102 may be shaped or designed in any other manner including being elongated and generally cylindrical in shape or triangular in shape, or any other shape or design.

In the arrangement shown, as one example, steering tube 102 may be formed of a single, unitary member that is formed in a manufacturing process such as machining, extrusion, forming, casting, additive manufacturing, or the like to form a unitary and monolithic member. Alternatively, steering tube 102 may be formed of multiple pieces that are connected or assembled to one another through bolting, welding, screwing, friction fitting, or the like or any other means of connecting two members. In the arrangement shown, as one example, steering tube 102 is formed primarily of a metallic material such as steel, aluminum, chromium, or any other metallic material, alloy, and/or composite thereof. Alternatively, steering tube 102 may be formed of a non-metallic material such as a plastic material, a fiberglass material, or any other non-metallic material and/or composite thereof.

In the arrangement shown, as one example, steering tube 102 extends a length between a first end 136 and a second end 138, and engagement members 140 are present at each of the first end 136 and second end 138 of steering tube 102. In the arrangement shown, as one example, the first end 136 of steering tube 102 is configured to operably connect to third pivot arm 100 of third tie rod 96. In the arrangement shown, as one example, the engagement member 140 present at the first end 136 of steering tube 102 is configured to be inserted through the opening 132 of third pivot arm 100 and is operably connected to third pivot arm 100 through any means of connection including screwing, bolting, welding, friction fitting, or any other means of connection. In this way, steering tube 102 is operably connected to third tie rod 96.

In the arrangement shown, as one example, the engagement member 140 present at the second end 138 of steering tube 102 is configured to operably connect to at least one rear axle pivot arm 104. More specifically, in the arrangement shown, as one example, the engagement member 140 present at the second end 138 of steering tube 102 is configured to be inserted through the first opening 144 of at least one rear axle pivot arm 104 and is operably connected to the first opening 144 of at least one rear axle pivot arm 104 through any means of connection including screwing, bolting, welding, friction fitting, or any other means of connection. In this way, steering tube 102 is operably connected to the at least one rear axle pivot arm 104.

At least one Rear Axle Pivot Arm 104: In the arrangement shown, as one example, steering assembly 28 includes at least one rear axle pivot arm 104. Rear axle pivot arm(s) 104 are formed of any suitable size, shape, and design and are configured to rotate and operably transfer such rotation to the wheels 170 of rear wheel assemblies 30. In the arrangement shown, as one example, rear axle pivot arm(s) 104 are generally in the shape of an ovoid (or generally egg-shaped) with a first end having a radius that is either larger or smaller than the radius of the second end.

In the arrangement shown, as one example, there is a rear axle pivot arm 104 operably connected to each of the rear wheel assemblies 30. In the arrangement shown, as one example, there are two wheel assemblies 30, therefore there are two rear axle pivot arms 104. However, there may be any other number of rear wheel assemblies 30, such as one, two, three, four, five, six, seven, eight, nine, ten, or more rear wheel assemblies 30 and there may be a corresponding number of rear axle pivot arms 104. It is contemplated, and will be understood by those skilled in the art, that there may be various alternative arrangements where there may be a different number of rear axle pivot arms 104 than the number of rear wheel assemblies 30.

In the arrangement shown, as one example, rear axle pivot arms 104 may be formed of a single unitary member that is formed in a manufacturing process such as machining, punching, cutting, forming, casting, additive manufacturing, or the like to form a unitary and monolithic member. Alternatively, rear axle pivot arms 104 may be formed of multiple pieces that are connected or assembled to one another through welding or any other method of connecting two members. In the arrangement shown, as one example, rear axle pivot arms 104 are formed primarily of a metallic material such as steel, aluminum, chromium, or any other metallic material, alloy, and/or composite thereof. Alternatively, rear axle pivot arms may be formed of a non-metallic material such as a plastic material, a fiberglass material, or any other non-metallic material and/or composite thereof.

In the arrangement shown, as one example, the end of rear axle pivot arms 104 having a smaller radius includes a first opening 144 configured to operably receive and connect to the engagement member 140 on the second end 138 of steering tube 102, as previously described herein. In the arrangement shown, as one example, rear axle pivot arms 104 are configured to rotate as steering tube 102 moves in response to the rotation of third pivot arm 100 and third tie rod 96.

In the arrangement shown, as one example, rear axle pivot arms 104 may be configured to rotate less than 180 degrees, however rear axle pivot arms 104 are not so limited and rear axle pivot arms 104 may be configured to rotate any number of degrees, even up to 360 degrees in alternative arrangements. In the arrangement shown, as one example, as first tie rod 90 rotates, first pivot arm 92 also rotates, which causes second tie rod 94 to be pulled forward or pushed backward. As second tie rod 94 is pulled forward or pushed backward, second pivot arm 98, third tie rod 96, and third pivot arm 100 are rotated. As third pivot arm 100 rotates it, in turn, pulls forward or pushes backward steering tube 102. As steering tube 102 is pulled forward or pushed backward, rear axle pivot arms 104 rotate.

In the arrangement shown, as one example, the degree of rotation of rear axle pivot arms 104 is nearly identical to the degree of rotation of third pivot arm 100 (and thereby, second pivot arm 98 and third tie rod 96). That means, just like second pivot arm 98 and third pivot arm 100, rear axles pivot arms 104 may be configured to rotate less than 180 degrees, however rear axle pivot arms 104 are not so limited and rear axle pivot arms 104 may be configured to rotate any number of degrees, even up to 360 degrees in alternative arrangements. In one or more arrangements, as examples, second pivot arm 98, third tie rod 96, and third pivot arm 100 may only rotate up to approximately 30 degrees clockwise and 30 degrees counterclockwise relative to the natural resting position of second pivot arm 98, third tie rod 96, and third pivot arm 100, respectively, when system 10 is traveling straight down a road. In this arrangement, as one example, rear axle pivot arms 104 likewise may only rotate up to approximately 30 degrees clockwise and 30 degrees counterclockwise relative to the natural resting position of rear axle pivot arms 104 when system 10 is traveling straight down a road. In further arrangements, as examples, second pivot arm 98, third tie rod 96, and third pivot arm 100 may only rotate up to approximately 45 degrees clockwise and 45 degrees counterclockwise relative to the natural resting position of second pivot arm 98, third tie rod 96, and third pivot arm 100, respectively, when system 10 is traveling straight down a road. In this arrangement, as one example, rear axle pivot arms 104 likewise may only rotate up to approximately 45 degrees clockwise and 45 degrees counterclockwise relative to the natural resting position of rear axle pivot arms 104 when system 10 is traveling straight down a road. In further alternative arrangements, as examples, second pivot arm 98, third tie rod 96, and third pivot arm 100 may be configured to rotate any number of degrees, even up to 360 degrees, relative to the natural resting position of second pivot arm 98, third tie rod 96, and third pivot arm 100, respectively, when system 10 is traveling straight down a road. In this arrangement, as one example, rear axle pivot arms 104 likewise may be configured to rotate any number of degrees, even up to 360 degrees, relative to the natural resting position of rear axle pivot arms 104 when system 10 is traveling straight down a road.

In the arrangement shown, as one example, the end having the larger radius includes a spindle 146 having a first end 148 and a second end 150. Spindle 146 is formed of any suitable size, shape, and design and is configured to extend through a slew bearing 172 of rear wheel assemblies 30 and be received within bracket 178 of the first torsion axle 164 of rear wheel assemblies 30. In the arrangement shown, as one example, spindle 146 connects to rear axle pivot arms 104 at first end 148 and extends downward to second end 150. In the arrangement shown, as one example, the second end 150 of spindle 146 is held within close and tight tolerances in bracket 178 of the first torsion axle 164 of rear wheel assemblies 30.

In the arrangement shown, as one example, spindle 146 is configured to rotate with rear axle pivot arms 104. That is, when rear axle pivot arms 104 are caused to rotate by the movement of steering tube 102, spindle 146 also rotates. In the arrangement shown, as one example, when spindle 146 is held within close and tight tolerances in bracket 178, the rotation of spindle 146 causes bracket 178 of the first torsion axle 164 to rotate, which in turn causes wheels 170 of rear wheel assemblies 30 to rotate, thereby helping to facilitate the turning of system 10. In this way, steering assembly 28 operably connects to rear wheel assemblies 30 and helps facilitate the rotation of rear wheel assemblies 30.

In the arrangement shown, as one example, rear axle pivot arms 104 also include a second opening 152. In the arrangement shown, as one example, second opening 152 is positioned towards the center of rear axle pivot arms 104 and near first opening 144. In the arrangement shown, as one example, second opening 152 is configured to operably receive and connect to an engagement member 156 on either end 154 of fourth tie rod 106.

Fourth Tie Rod 106: In the arrangement shown, as one example, steering assembly 28 includes fourth tie rod 106. Fourth tie rod 106 is formed of any suitable size, shape, and design and is configured to help transfer the rotation of one rear axle pivot arm 104 to another rear axle pivot arm 104. In the arrangement shown, as one example, the steering tube 102 only connects to the rear axle pivot arm 104 which is operably connected to the closest rear wheel assembly 30. In various arrangements, as examples, there may be more than one rear wheel assembly 30, and fourth tie rod 106 is configured to connect each subsequent rear axle pivot arm 104 to the immediately preceding rear axle pivot arm 104. In various arrangements, there may be any number of fourth tie rods 106, in order to operably connect any number of rear axle pivot arms 104, this includes one, two, three, four, five, six, seven, eight, nine, ten, or more fourth tie rods 106.

In the arrangement shown, as one example, fourth tie rod 106 is generally cylindrical and elongated, however fourth tie rod 106 may be shaped or designed in any other manner including being elongated and generally rectangular in shape or triangular in shape, or any other shape or design. In the arrangement shown, as one example, fourth tie rod 106 may be formed of a single, unitary member that is formed in a manufacturing process such as machining, extrusion, forming, casting, additive manufacturing, or the like to form a unitary and monolithic member. Alternatively, fourth tie rod 106 may be formed of multiple pieces that are connected or assembled to one another through bolting, welding, screwing, friction fitting, or the like or any other means of connecting two members. In the arrangement shown, as one example, fourth tie rod 106 is formed primarily of a metallic material such as steel, aluminum, chromium, or any other metallic material, alloy, and/or composite thereof. Alternatively, fourth tie rod 106 may be formed of a non-metallic material such as a plastic material, a fiberglass material, or any other non-metallic material and/or composite thereof.

In the arrangement shown, as one example, fourth tie rod 106 extends a length between opposing ends 154, and engagement members 156 are present at each of the ends 154 of fourth tie rod 106. In the arrangement shown, as one example, the first end 154 of fourth tie rod 106 is configured to operably connect to a first rear axle pivot arm 104. In the arrangement shown, as one example, the engagement member 156 present at the first end 154 of fourth tie rod 106 is configured to be inserted through the second opening 152 of such first rear axle pivot arm 104 and is operably connected to such first rear axle pivot arm 104 through any means of connection including screwing, bolting, welding, friction fitting, or any other means of connection. In this way, fourth tie rod 106 is operably connected to such first rear axle pivot arm 104.

In the arrangement shown, as one example, the engagement member 156 present at the second end 154 of fourth tie rod 106 is configured to operably connect to either the first opening 144 or second opening 152 of a second rear axle pivot arm 104. More specifically, in the arrangement shown, as one example, the engagement member 156 present at the second end 154 of fourth tie rod 106 is configured to be inserted through either the first opening 144 or second opening 152 of such second rear axle pivot arm 104 and is operably connected to such second rear axle pivot arm 104 through any means of connection including screwing, bolting, welding, friction fitting, or any other means of connection. In this way, fourth tie rod 106 is operably connected to such second rear axle pivot arm 104.

This connection using fourth tie rod 106 continues for as many times as necessary to operably connect all the rear axle pivot arms 104. In the arrangement shown, as one example, the engagement members 156 on either ends 154 of the fourth tie rods 106 may be placed in either the first opening 144 or second opening 152 of rear axle pivot arms 104. There is no specific order that this needs to be in, it just depends on which opening, either first opening 144 or second opening 152, is available on such rear axle pivot arm 104.

With all of the rear axle pivot arms 104 connected via fourth tie rods 106, steering assembly 28 operably connects the front wheel assembly 26 to each of the rear wheel assemblies 30 such that the wheels 170 of each rear wheel assembly 30 are caused to rotate and/or turn when the wheels 48 of front wheel assembly 26 rotate and/or turn.

While steering assembly 28 and its component parts have been described according to the arrangement shown, as one example, it will be understood by those skilled in the art that any other configuration of steering assembly 28 and its component parts may be used in order to operably transfer the rotation of the front wheel assembly 26 to the rear wheel assemblies 30, thereby providing system 10 with all-wheel steering.

### Rear Wheel Assemblies 30:

In the arrangement shown, as one example, system 10 includes rear wheel assemblies 30. Rear wheel assemblies 30 are formed of any suitable size, shape, and design and are configured to operably connect to steering assembly 28 and frame assembly 32 and help facilitate the movement and turning of system 10 when system 10 is on the road. In the arrangement shown, as one example, rear wheel assemblies 30 have a first side 160 and a second side 162. In the arrangement shown, as one example, rear wheel assemblies include first torsion axle 164, a tie rod 166, a second torsion axle 168, wheels 170, slew bearings 172, and an axle frame 174.

First Torsion Axle 164: In the arrangement shown, as one example, rear wheel assemblies 30 include first torsion axle 164. First torsion axle 164 is formed of any suitable size, shape, and design and is configured to engage with and operably connect to spindle 146 of rear axle pivot arms 104 of steering assembly 28, thereby operably connecting rear wheel assemblies 30 to steering assembly 28. First torsion axle 164 is also formed of any suitable size, shape, and design and is configured to operably connect a wheel 170 of rear wheel assemblies 30 to a slew bearing 172. In the arrangement shown, as one example, first torsion axle 164 includes a bracket 178, an axle tube 180, an arm 182, a spindle 184, and a hub 186. In the arrangement shown, as one example, the first torsion axle 164 is present on the first side 160 of rear wheel assemblies 30.

In the arrangement shown, as one example, first torsion axle 164 is formed of multiple pieces that are connected or assembled to one another through welding, bolting, and friction fitting, however any other means of connecting or assembling the multiple pieces may be used. In the arrangement shown, as one example, first torsion axle 164 is formed primarily of a metallic material such as steel, aluminum, chromium, or any other metallic material, alloy, and/or composite thereof. Alternatively, first torsion axle 164 may be formed of a non-metallic material such as a plastic material, a fiberglass material, or any other non-metallic material and/or composite thereof.

In the arrangement shown, as one example, first torsion axle 164 includes a bracket 178. Bracket 178 is formed of any suitable size, shape, and design and is configured to operably connect to spindle 146 of rear axle pivot arms 104 of steering assembly 28, the inner member 200 of the slew bearing 172 on first side 160 of rear wheel assemblies 30, and to the tie rod 166 of rear wheel assemblies 30. In the arrangement shown, as one example, bracket 178 is a metallic, generally rectangular member with a first opening 190, a second opening 192, and holes configured to receive screws, bolts, or other means of connection therein in order to operably connect bracket 178 to the inner member 200 of the slew bearing 172 on first side 160 of rear wheel assemblies 30. In the arrangement shown, as one example, bracket 178 also includes an opening (not shown) for axle tube 180 to extend therethrough.

In the arrangement shown, as one example, the first opening 190 of bracket 178 is configured to receive a portion of spindle 146 of rear axle pivot arms 104 of steering assembly 28 therein and hold such portion of spindle 146 within close and tight tolerances. With spindle 146 held in close and tight tolerances within the first opening 190 of bracket 178, bracket 178 helps operably connect rear wheel assemblies 30 to steering assembly 28. In the arrangement shown, as one example, spindle 146 being received within the first opening 190 of bracket 178 allows bracket 178 to rotate along with spindle 146, thereby allowing steering assembly 28 to transfer the rotation of wheels 48 of front wheel assembly 26 to the wheel 170 on the first side 160 of rear wheel assemblies 30.

In the arrangement shown, as one example, the second opening 192 of bracket 178 is configured to receive a portion of the engagement member 226 of tie rod 166 therein and hold the engagement member 226 of tie rod 166 in close and tight tolerances therein. In this arrangement shown, as one example, as bracket 178 rotates, tie rod 166 is pulled and/or pushed side to side and tie rod 166 is operably connected to the opening 240 of the bracket 230 of the second torsion axle 168, thereby causing the bracket 230 of the second torsion axle 168 to rotate, and thereby causing the wheel 170 on the second side 162 of rear wheel assemblies 30 to rotate as well.

In the arrangement shown, as one example, first torsion axle 164 includes axle tube 180. Axle tube 180 is formed of any suitable size, shape, and design and is configured to connect to bracket 178 and arm 182 of first torsion axle 164. In the arrangement shown, as one example, axle tube 180 extends through both sides of bracket 178.

In the arrangement shown, as one example, axle tube 180 connects to arm 182. Arm 182 is formed of any suitable size, shape, and design and is configured to operably connect to axle tube 180 and spindle 184 of first torsion axle 164. In the arrangement shown, as one example, spindle 184 is formed of any suitable size, shape, and design and is configured to connect to both arm 182 and hub 186. In the arrangement shown, as one example, hub 186 is configured to connect to a wheel 170 on the first side 160 of rear wheel assemblies 30. In the arrangement shown, as one example, hub 186 includes threaded members (not shown) which are configured to extend through openings 196 in a wheel 170 in order to properly position and connect the wheel 170 to hub 186. In this way, first torsion axle 164 operably connects the wheel 170 on the first side 160 of rear wheel assemblies 30 to the remainder of rear wheel assembly 30.

Tie Rod 166: In the arrangement shown, as one example, rear wheel assemblies 30 include tie rod 166. Tie rod 166 is formed of any suitable size, shape, and design and is configured to help transfer the rotation of bracket 178 of first torsion axle 164 on the first side 160 of rear wheel assemblies 30 to the bracket 230 of second torsion axle 168 on the second side 162 of rear wheel assemblies 30.

In the arrangement shown, as one example, tie rod 166 is generally cylindrical and elongated, however tie rod 166 may be shaped or designed in any other manner including being elongated and generally rectangular in shape or triangular in shape, or any other shape or design.

In the arrangement shown, as one example, tie rod 166 may be formed of a single, unitary member that is formed in a manufacturing process such as machining, extrusion, forming, casting, additive manufacturing, or the like to form a unitary and monolithic member. Alternatively, tie rod 166 may be formed of multiple pieces that are connected or assembled to one another through bolting, welding, screwing, friction fitting, or the like or any other means of connecting two members. In the arrangement shown, as one example, tie rod 166 is formed primarily of a metallic material such as steel, aluminum, chromium, or any other metallic material, alloy, and/or composite thereof. Alternatively, tie rod 166 may be formed of a non-metallic material such as a plastic material, a fiberglass material, or any other non-metallic material and/or composite thereof.

In the arrangement shown, as one example, tie rod 166 extends a length between a first end 222 and a second end 224, and engagement members 226 are present at each of the first end 222 and second end 224 of tie rod 166. In the arrangement shown, as one example, the first end 222 of tie rod 166 is configured to operably connect to bracket 178 of first torsion axle 164 on the first side 160 of rear wheel assemblies 30. In the arrangement shown, as one example, the engagement member 226 present at the first end 222 of tie rod 166 is configured to be inserted through the first opening 190 of bracket 178 of first torsion axle 164 and is operably connected to bracket 178 through any means of connection including screwing, bolting, welding, friction fitting, or any other means of connection. In this way, tie rod 166 is operably connected to first torsion axle 164.

In the arrangement shown, as one example, the engagement member 226 present at the second end 224 of tie rod 166 is configured to operably connect to bracket 230 of second torsion axle 168 on the second side 162 of rear wheel assemblies 30. More specifically, in the arrangement shown, as one example, the engagement member 226 present at the second end 224 of tie rod 166 is configured to be inserted through the opening 240 of bracket 230 of second torsion axle 168 and is operably connected to bracket 230 of second torsion axle 168 through any means of connection including screwing, bolting, welding, friction fitting, or any other means of connection. In this way, tie rod 166 is operably connected to second torsion axle 168.

Second Torsion Axle 168: In the arrangement shown, as one example, rear wheel assemblies 30 include second torsion axle 168. Second torsion axle 168 is formed of any suitable size, shape, and design and is configured to engage with and operably connect to tie rod 166, thereby operably connecting second torsion axle 168 to first torsion axle 164 such that when the wheel 170 connected to first torsion axle 164 rotates and/or turns, the wheel 170 connected to the second torsion axle 168 also rotates and/or turns. Second torsion axle 168 is also configured to operably connect the wheel 170 on the second side 162 of rear wheel assemblies 30 to a slew bearing 172 on the second side 162 of rear wheel assemblies 30. In the arrangement shown, as one example, second torsion axle 168 includes a bracket 230, an axle tube 232, an arm 234, a spindle 236, and a hub 238. In the arrangement shown, as one example, the second torsion axle 168 is present on the second side 162 of rear wheel assemblies 30.

In the arrangement shown, as one example, second torsion axle 168 is formed of multiple pieces that are connected or assembled to one another through welding, bolting, and friction fitting, however any other means of connecting or assembling the multiple pieces may be used. In the arrangement shown, as one example, second torsion axle 168 is formed primarily of a metallic material such as steel, aluminum, chromium, or any other metallic material, alloy, and/or composite thereof. Alternatively, second torsion axle 168 may be formed of a non-metallic material such as a plastic material, a fiberglass material, or any other non-metallic material and/or composite thereof.

In the arrangement shown, as one example, second torsion axle 168 includes a bracket 230. Bracket 230 is formed of any suitable size, shape, and design and is configured to operably connect to the inner member 200 of the slew bearing 172 on second side 162 of rear wheel assemblies 30, and to the tie rod 166 of rear wheel assemblies 30. In the arrangement shown, as one example, bracket 230 is a metallic, generally rectangular member with an opening 240 and holes configured to receive screws, bolts, or other means of connection therein in order to operably connect bracket 230 to the inner member 200 of the slew bearing 172 on second side 162 of rear wheel assemblies 30. In the arrangement shown, as one example, bracket 230 also includes an opening (not shown) for axle tube 232 to extend therethrough.

In the arrangement shown, as one example, the opening 240 of bracket 230 is configured to receive a portion of the engagement member 226 of tie rod 166 therein and hold the engagement member 226 of tie rod 166 in close and tight tolerances therein. In this arrangement shown, as one example, as bracket 178 (of first torsion axle 164) rotates, tie rod 166 is pulled and/or pushed side to side and tie rod 166 is operably connected to the opening 240 of the bracket 230 of the second torsion axle 168, thereby causing the bracket 230 of the second torsion axle 168 to rotate, and thereby causing the wheel 170 on the second side 162 of rear wheel assemblies 30 to rotate as well.

In the arrangement shown, as one example, second torsion axle 168 includes axle tube 232. Axle tube 232 is formed of any suitable size, shape, and design and is configured to connect to bracket 230 and arm 234 of second torsion axle 168. In the arrangement shown, as one example, axle tube 232 extends through both sides of bracket 230.

In the arrangement shown, as one example, axle tube 232 connects to arm 234. Arm 234 is formed of any suitable size, shape, and design and is configured to operably connect to axle tube 232 and spindle 236 of second torsion axle 168. In the arrangement shown, as one example, spindle 236 is formed of any suitable size, shape, and design and is configured to connect to both arm 234 and hub 238. In the arrangement shown, as one example, hub 238 is configured to connect to a wheel 170 on the second side 162 of rear wheel assemblies 30. In the arrangement shown, as one example, hub 238 includes threaded members 242 which are configured to extend through openings 196 in a wheel 170 in order to properly position and connect the wheel 170 to hub 238. In this way, hub 238 of second torsion axle 168 operably connects the wheel 170 on the second side 162 of rear wheel assemblies 30 to the remainder of rear wheel assembly 30.

Wheels 170: In the arrangement shown, as one example, rear wheel assemblies 30 include wheels 170. Wheels 170 are formed of any suitable size, shape, and design and are configured to facilitate the driving of system 10 on a road. In the arrangement shown, as one example, wheels 170 include openings 196 which are configured to receive and connect to hub 186 of first torsion axle 164 and/or hub 238 of second torsion axle 168. In the arrangement shown, as one example, wheels 170 include openings 196 which are configured to allow the threaded members (not shown) of hub 186 of first torsion axle 164 and/or the threaded members 242 of hub 238 of second torsion axle 168 to extend through a portion of the wheels 170 in order to properly position and connect the wheels 170 to hub 186 and/or hub 238. More specifically, bolts are configured to be threaded onto the threaded members (not shown) of hub 186 and the threaded members 242 of hub 238 after they are extended through wheels 170, thereby connecting wheels 170 to the threaded members (not shown) of hub 186 and threaded members 242 of hub 238, and also to hub 186 and hub 238 themselves. In the arrangement shown, as one example, wheels 170 may be any type of wheel used in the industry.

In the arrangement shown, as one example, wheels 170 contain a camber which, when system 10 is at rest and unloaded, causes wheels 170 to extend upward from the ground at an angle outward. This camber is included to help accommodate for the weight of the agricultural implements, such as combine headers, that system 10 may be used to transport. Such agricultural implements, such as combine headers, weigh a massive amount and they are designed to be placed on the frame assembly 26 located in between the wheelbase of system 10. With the heavy weight placed in the middle of the wheelbase, the wheels 170 of rear wheel assemblies 30 tend to want to angle inward under such heavy loads. In order to accommodate for this, a camber is placed on wheels 170 such that they are angled outward when unloaded but are approximately perpendicular to the road when a load is placed on system 10.

In the arrangement shown, as one example, wheels 170 (and first torsion axle 164 and second torsion axle 168) are allowed to rotate relative to frame assembly 32 and axle frame 174 of rear wheel assemblies 30 due to slew bearings 172.

Slew Bearings 172: In the arrangement shown, as one example, rear wheel assemblies 30 include slew bearings 172 on each of the first side 160 and second side 162 of rear wheel assemblies 30. Slew bearings 172 are formed of any suitable size, shape, and design and are configured to operably connect to first torsion axle 164 and second torsion axle 168, respectively, as well as axle frame 174, and to help facilitate the turning of wheels 170. In the arrangement shown, as one example, slew bearings 172 include an inner member 200, ball bearings (not shown), and an outer member 202.

In the arrangement shown, as one example, inner member 200 is a generally circular, planar member made of a metallic material. In the arrangement shown, as one example, inner member 200 has a thickness between an upper surface 204 and a lower surface (not shown) and an opening 208 extending through the geographic center of inner member 200. In the arrangement shown, as one example, inner member 200 also includes holes 210 configured to receive bolts therethrough.

In the arrangement shown, as one example, outer member 202 is also a generally circular, planar member made of a metallic material. In the arrangement shown, as one example, outer member 202 has a thickness between an upper surface 212 and a lower surface (not shown) and an opening 216 extending through the geographic center of outer member 202. In the arrangement shown, as one example, outer member 202 also includes holes 218 configured to receive bolts therethrough.

In the arrangement shown, as one example, the opening 216 in the center of outer member 202 is approximately sized such that the inner member 200 may rest within outer member 202. In this manner, outer member 202 and inner member 200 form approximately concentric circles. In the arrangement shown, as one example, inner member 200 and outer member 202 include grooves (not shown). In the arrangement shown, as one example, the groove in the outer member 202 is on its interior surface (not shown) and the groove in the inner member 200 is on its exterior surface (not shown). In the arrangement shown, as one example, ball bearings are placed in the grooves such that they rest within both the grooves in the inner member 200 and outer member 202. In this way, inner member 200 and outer member 202 are operably connected by the ball bearings, but the ball bearings allow inner member 200 and outer member 202 to rotate relative to each other.

In the arrangement shown, as one example, the inner member 200 of the slew bearing 172 on the first side 160 of rear wheel assemblies 30 is configured to operably connect to the bracket 178 of first torsion axle 164 and the inner member 200 of the slew bearing 172 on the second side 162 of rear wheel assemblies 30 is configured to operably connect to the bracket 230 of second torsion axle 168. In the arrangement shown, as one example, the inner members 200 of slew bearings 172 are connected to their respective brackets by passing a bolt, screw, or other fastening member through the holes 210 of inner member 200 and through corresponding holes in the respective brackets. In this way, slew bearings 172 operably connect to first torsion axle 164 and second torsion axle 168.

In the arrangement shown, as one example, the outer member 202 of slew bearings 172 operably connect to the flanges 250 of the axle frame 174 of rear wheel assemblies 30. In this way, slew bearings 172 also operably connect to axle frame 174. Finally, the opening 208 of inner member 200 (and the opening 216 of outer member 202) allow spindle 146 of rear axle pivot arms 104 of steering assembly 28 to extend therethrough and connect to bracket 178 of first torsion axle 164 and/or bracket 230 of second torsion axle 168, thereby operably connecting the rear wheel assemblies 30 to steering assembly 28.

In the arrangement shown, as one example, this set up of slew bearings 172 provide a number of benefits and slew bearings 172 are advantageous to use in system 10. Specifically, compared to other types of bearings, slew bearings generally have lower friction, which leads to much greater durability, which means slew bearings 172 will not need to be replaced as often as other types of bearings may need to be. Further, slew bearings allow for smoother and more controlled rotation of the inner member 200 relative to the outer member 202, which produces smoother and more efficient turns of system 10. Finally, slew bearings are capable of supporting heavier loads than other types of bearings and because combine headers and other agricultural implements are extremely heavy, slew bearings 172 are capable of use even when other bearings would fail under the load. Therefore, it is advantageous to use slew bearings 172 compared to other bearings.

Axle Frame 174: In the arrangement shown, as one example, rear wheel assemblies 30 include axle frame 174. Axle frame 174 is formed of any suitable size, shape, and design and is configured to provide rigidity and support to system 10 and securely connect the first side 160 and second side 162 of rear wheel assemblies 30 together. In the arrangement shown, as one example, axle frame 174 includes a first end 246, a second end 248, flanges 250, and an angled portion 252 on the second end 162 of rear wheel assemblies 30.

In the arrangement shown, as one example, axle frame 174 may be formed of a single, unitary member that is formed in a manufacturing process such as machining, casting, forming, additive manufacturing, or the like to form a unitary and monolithic member. Alternatively, axle frame 174 may be formed of multiple pieces that are connected or assembled to one another through welding, bolting, screwing, friction fitting, or any other means of connecting two members. In the arrangement shown, as one example, axle frame 174 is formed primarily of a metallic material such as steel, aluminum, chromium, or any other metallic material, alloy, and/or composite thereof. Alternatively, axle frame 174 may be formed of a non-metallic material such as a plastic material, a fiberglass material, or any other non-metallic material and/or composite thereof.

In the arrangement shown, as one example, axle frame 174 is a generally elongated and primarily rectangular tube with a hollow interior and stiffeners which extend between first end 246 and second 248. In the arrangement shown, as one example, the first end 246 and second end 248 of axle frame 174 include flanges 250. Flanges 250 are formed of any suitable size, shape, and design and are configured to facilitate connection between axle frame 174 and the outer members 202 of slew bearings 172. In the arrangement shown, as one example, flanges 250 are generally round members with holes 254 which correspond with the holes 218 of outer member 202 such that screws, bolts, or any other fastener may be placed through holes 218 of outer member 202 and holes 254 of flanges 250 in order to connect outer member 202 of slew bearings 172 to flanges 250 of axle frame 174.

In the arrangement shown, as one example, axle frame 174 includes an angled portion 252. Angled portion 252 is formed of any suitable size, shape, and design and is configured to support the angled shape of frame assembly 32. In the arrangement shown, as one example, axle frame 174 includes a portion where there is only a thin portion of frame 174 near the second end 162 of rear wheel assemblies 30. This thin portion of frame 174 continues for a short while before reaching the angled portion 252 of axle frame 174. In the arrangement shown, as one example, the angled portion 252 of axle frame 174 extends upward from the thin portion to a point higher than the remainder of axle frame 174, and angled portion 252 extends upward at an angle outward before reaching a peak and then extending back outward at a slight downward angle until it reaches the second end 248 of axle frame 174. The portion of axle frame 174 which is thin allows for a longitudinal member 262 of frame assembly 32 to rest therein, and the longitudinal member 262 rests against the angled portion 252 such that the frame assembly 32 angles upward as it goes from the second side 162 of rear wheel assemblies 30 to the first side 160 of rear wheel assemblies 30.

While rear wheel assemblies 30 and its component parts have been described according to the arrangement shown, as one example, it will be understood by those skilled in the art that any other configuration of rear wheel assemblies 30 and its component parts may be used in order to operably connect to steering assembly 28 and frame assembly 32, and help facilitate the movement and turning of system 10 when system 10 is on the road.

### Frame Assembly 32:

In the arrangement shown, as one example, system 10 includes a frame assembly 32. Frame assembly 32 is formed of any suitable size, shape, and design and is configured to support an agricultural implement, such as a combine header, while system 10 drives on a road. In the arrangement shown, as one example, frame assembly 32 includes a front connection assembly 260, longitudinal members 262, latitudinal members 264, and support members 266.

Front Connection Assembly 260: In the arrangement shown, as one example, frame assembly 32 includes a front connection assembly 260. Front connection assembly 260 is formed of any suitable size, shape, and design and is configured to facilitate operable connection between front wheel assembly 26 and frame assembly 32. In the arrangement shown, as one example, front connection assembly 260 includes a vertical member 268 having a flange 270 and a curved member 272 having a mounting bracket 274 and a tube 276.

In the arrangement shown, as one example, front connection assembly 260 is formed of multiple pieces that are connected or assembled to one another through bolting, welding, screwing, friction fitting, or any other means of connecting or assembling multiple pieces. Alternatively, front connection assembly 260 may be formed of a single, unitary member that is formed in a manufacturing process such as machining, additive manufacturing, or any other manufacturing means to form a unitary and monolithic member. In the arrangement shown, as one example, front connection assembly 260 is formed primarily of a metallic material such as steel, aluminum, chromium, or any other metallic material, alloy, and/or composite thereof. Alternatively, front connection assembly 260 may be formed of a non-metallic material such as a plastic material, a fiberglass material, or any other non-metallic material and/or composite thereof.

In the arrangement shown, as one example, front connection assembly 260 includes a vertical member 268. Vertical member 268 is formed of any suitable size, shape, and design and is configured to operably connect to the outer member 70 of slew bearing 50 of front wheel assembly 26 in order to operably connect the frame assembly 32 to the front wheel assembly 26. In the arrangement shown, as one example, vertical member 268 is a generally square, elongated tube member, however vertical member 268 may be shaped or designed in any other manner including being elongated and generally cylindrical in shape or triangular in shape, or any other shape or design.

In the arrangement shown, as one example, vertical member 268 extends a length between a first end and a second end. In the arrangement shown, as one example, vertical member 268 includes a flange 270 at its first end. Flange 270 is formed of any suitable size, shape, and design and is configured to facilitate connection between vertical member 268 and the outer member 70 of slew bearing 50 of front wheel assembly 26. In the arrangement shown, as one example, flange 270 is generally a round, planar member with holes which correspond to holes 86 of outer member 70 of slew bearing 50, and screws, bolts, or other fasteners are configured to extend through the holes of flange 270 and the holes 86 of outer member 70 of slew bearing 50 in order to connect outer member 70 of slew bearings 50 to flanges 270 of vertical member 268. In the arrangement shown, as one example, vertical member 268 has a hollow interior which allows first tie rod 90 of steering assembly 28 to extend therethrough in order to connect to front wheel assembly 26 as well.

In the arrangement shown, as one example, vertical member 268 extends upward from its first end until it gets to its second end, where it connects to curved member 272. Curved member 272 is formed of any suitable size, shape, and design and is configured to connect vertical member 268 to the remainder of frame assembly 32. In the arrangement shown, as one example, curved member 272 connects to vertical member 268 at the first end of curved member 272 and curved member 272 extends rearward from vertical member 268 in a convexly curved manner (i.e., it is slightly higher in the middle of curved member 272 as opposed to the first end and second end of curved member 272). In the arrangement shown, as one example, curved member 272 curves sharply as it nears the second end of curved member 272. In the arrangement shown, as one example, curved member 272 connects at its second end to an inner longitudinal member 278, which connects the front connection assembly 260 to the remainder of frame assembly 32.

In the arrangement shown, as one example, curved member 272 includes a mounting bracket 274 and a tube 276 which allows the third tie rod 96 of steering assembly 28 to extend through the tube 276. In this arrangement, as one example, the third tie rod 96 of steering assembly 28 is at least partially held in place by mounting bracket 274 and tube 276 and prevented from swinging or being knocked out of place if a piece of debris were to hit an unprotected third tie rod 96.

In the arrangement shown, as one example, front connection member 260 includes an inner longitudinal member 278 which extends rearward from curved member 272 in order to connect the front connection assembly 260 to the first two latitudinal members 264 and the remainder of frame assembly 32.

Longitudinal Members 262: In the arrangement shown, as one example, frame assembly 32 includes longitudinal members 262. Longitudinal members 262 are formed of any suitable size, shape, and design and are configured to operably connect to rear wheel assemblies 30 and help support the agricultural implement, such as a combine header, being towed using system 10. In the arrangement shown, as one example, longitudinal members 262 are elongated, rectangular or tube members, however longitudinal members 262 may be shaped or designed in any other manner including being elongated and generally cylindrical in shape or triangular in shape, or any other shape or design. In the arrangement shown, as one example, longitudinal members 262 extend a length between a first end 282, at or near the forward end 12 of system 10, and a second end 284, at or near the rearward end 14 of system 10.

In the arrangement shown, as one example, longitudinal members 262 may be formed of a single, unitary member that is formed in a manufacturing process such as machining, extrusion, forming, casting, additive manufacturing, or the like to form a unitary and monolithic member. Alternatively, longitudinal members 262 may be formed of multiple pieces that are connected or assembled to one another through bolting, welding, screwing, friction fitting, or the like or any other means of connecting two members. In the arrangement shown, as one example, longitudinal members 262 is formed primarily of a metallic material such as steel, aluminum, chromium, or any other metallic material, alloy, and/or composite thereof. Alternatively, longitudinal members 262 may be formed of a non-metallic material such as a plastic material, a fiberglass material, or any other non-metallic material and/or composite thereof.

In the arrangement shown, as one example, the longitudinal member 262 resting near the second side 162 of rear wheel assembly 30 contacts the angled portion 252 of axle frame 174, thereby causing frame assembly 32 to sit at an angle upward as it moves from the second side 162 of rear wheel assembly 30 to the first side 160 of rear wheel assembly 30. In the arrangement shown, as one example, the longitudinal member 262 resting near the first side 160 of rear wheel assembly 30 is supported by support members 266.

In the arrangement shown, as one example, there are two longitudinal members 262 which are connected by latitudinal members 264.

Latitudinal Members 264: In the arrangement shown, as one example, frame assembly 32 includes latitudinal members 264. Latitudinal members 264 are formed of any suitable size, shape, and design and are configured to operably connect longitudinal members 262 and provide support to the agricultural implement, such as a combine header, being hauled by system 10.

In the arrangement shown, as one example, latitudinal members 264 are elongated, rectangular or tube members, however latitudinal members 264 may be shaped or designed in any other manner including being elongated and generally cylindrical in shape or triangular in shape, or any other shape or design. In the arrangement shown, as one example, latitudinal members 264 extend a length between a first end 286, which is operably connected to one longitudinal member 262, and a second end 288, which is operably connected to the other longitudinal member 262. In the arrangement shown, as one example, latitudinal members 264 may connect to longitudinal members 262 through welding, or any other means of connecting two members including screwing, bolting, or any other method of connecting two members.

In the arrangement shown, as one example, latitudinal members 264 may be formed of a single, unitary member that is formed in a manufacturing process such as machining, extrusion, forming, casting, additive manufacturing, or the like to form a unitary and monolithic member. Alternatively, latitudinal members 264 may be formed of multiple pieces that are connected or assembled to one another through bolting, welding, screwing, friction fitting, or the like or any other means of connecting two members. In the arrangement shown, as one example, latitudinal members 264 is formed primarily of a metallic material such as steel, aluminum, chromium, or any other metallic material, alloy, and/or composite thereof. Alternatively, latitudinal members 264 may be formed of a non-metallic material such as a plastic material, a fiberglass material, or any other non-metallic material and/or composite thereof.

Support Members 266: In the arrangement shown, as one example, frame assembly 32 includes support members 266. Support members 266 are formed of any suitable size, shape, and design and is configured to hold up the end of frame assembly 32 that is on the first side 160 of rear assemblies 30, thereby helping to keep the angle of frame assembly 32, and to help support the load of the agricultural implement, such as a combine header, which is being towed by system 10.

In the arrangement shown, as one example, support members 266 are generally triangular members which operably connect to the axle frame 174 at a, relatively, narrower end of support member 266, and then extends upward and outward on each side of support member 266 until support members 266 operably connect to the longitudinal member 262 on the first side 160 of rear wheel assemblies 30. In the arrangement shown, as one example, support members 266 may connect to longitudinal members 262 through welding, or any other means of connecting two members including screwing, bolting, or any other method of connecting two members. In the arrangement shown, as one example, support members 266 may be connected to axle frame 174 through any means of connecting two members including welding, screwing, or bolting.

In the arrangement shown, as one example, support members 266 may be formed of a single, unitary member that is formed in a manufacturing process such as machining, forming, casting, additive manufacturing, or the like to form a unitary and monolithic member. Alternatively, support members 266 may be formed of multiple pieces that are connected or assembled to one another through bolting, welding, screwing, friction fitting, or the like or any other means of connecting two members. In the arrangement shown, as one example, support members 266 is formed primarily of a metallic material such as steel, aluminum, chromium, or any other metallic material, alloy, and/or composite thereof. Alternatively, support members 266 may be formed of a non-metallic material such as a plastic material, a fiberglass material, or any other non-metallic material and/or composite thereof.

While frame assembly 32 and its component parts have been described according to the arrangement shown, as one example, it will be understood by those skilled in the art that any other configuration of frame assembly 32 and its component parts may be used in order to support an agricultural implement, such as a combine header, while system 10 drives on a road.

### In Operation:

In the arrangement shown, as one example, system 10 is configured to be towed behind a combine or other towing vehicle and support an agricultural implement, such as a combine header. In the arrangement shown, as one example, a combine may line up with system 10 such that the header of the combine extends along the length of the longitudinal members 262 of frame assembly 32 and is directly over system 10. The combine may then lower the header down onto system 10 and disconnect the header. At this point, the header is resting on system 10. With the header resting on system 10, wheels 170, which have a camber and extend upward and outward when unloaded, are now approximately perpendicular with the ground or road where system 10 is located due to the weight of the header on system 10.

With the header on system 10 in the arrangement shown, as one example, the combine or other towing vehicle may then drive and line up the hitch on such vehicle with the coupler 34 of tongue assembly 24, and the coupler 34 and hitch may be connected once properly aligned. Once the coupler 34 is connected to the hitch of the combine or other towing vehicle, the combine or other towing vehicle is ready to drive down a road.

As the combine or other vehicle is driving down the road, the wheels 48 of front wheel assembly 26, and the wheels 170 of rear wheel assemblies 30 travel straight down the road. When the combine or other vehicle needs to turn, it will turn, thereby causing the tongue assembly 24 to turn with the vehicle. In the arrangement shown, as one example, the tongue assembly 24 is operably connected to the bracket 52 of the torsion axle 46 of front wheel assembly 26. In the arrangement shown, as one example, when the tongue assembly 24 is turned, bracket 52 is also turned and/or rotated, thereby turning the wheels 48 of front wheel assembly 26. In the arrangement shown, as one example, the slew bearing 50 of front wheel assembly 26 allows this turning to progress smoothly and efficiently.

In the arrangement shown, as one example, first tie rod 90 of steering assembly 28 is operably connected to bracket 52, therefore when bracket 52 is turned, first tie rod 90 rotates. As first tie rod 90 rotates, first pivot arm 92 of steering assembly 28 also rotates, which causes second tie rod 94 to be pulled forward or pushed backward. As second tie rod 94 is pulled forward or pushed backward, the second pivot arm 98 rotates, which in turn causes third tie rod 96 and third pivot arm 100 to rotate. In the arrangement shown, as one example, the rotation of third pivot arm 100 causes steering tube 102 to be pulled forward or pushed backward and this movement of steering tube 102 causes the first rear axle pivot arm 104 to rotate. In the arrangement shown, as one example, each rear axle pivot arm 104 is operably connected to other rear axle pivot arms 104 through fourth tie rod 106. As the first rear axle pivot arm 104 rotates, the fourth tie rod 106 is pulled forward or pushed backward, thereby causing the next rear axle pivot arm 104 to rotate, and the connection of rear axle pivot arms 104 and fourth tie rods 106 operate so that all rear axle pivot arms 104 are operably connected.

In the arrangement shown, as one example, when the rear axle pivot arms 104 rotate, the spindle 146 of rear axle pivot arms 104 also rotate. In the arrangement shown, as one example, the spindle 146 of rear axle pivot arms 104 are operably connected to the first opening 190 of bracket 178 of first torsion axle 164 of rear wheel assemblies 30. In the arrangement shown, as one example, as spindle 146 rotates, bracket 178 is caused to turn and/or rotate. The rotation of bracket 178 causes the wheel 170 on the first side 160 of rear wheel assemblies 30 to turn. In the arrangement shown, as one example, bracket 178 of first torsion assembly 164 is operably connected to the bracket 230 of second torsion axle 168 through tie rod 166. As bracket 178 of first torsion assembly 164 turns and/or rotates, the tie rod 166 is pushed and/or pulled from side to side, thereby causing the bracket 230 of second torsion axle 168 to turn and/or rotate as well. This, in turn, causes the wheels 170 on the second side 162 of rear wheel assemblies 30 to rotate. In this way, steering assembly 28 operably connects front wheel assembly 26 to rear wheel assemblies 30 and provides system 10 with all-wheel drive.

This arrangement of system 10, as one example, allows system 10 to take tight turns without jackknifing and causing damage to the combine or other towing vehicles, as well as system 10 itself. Additionally, as previously described herein, the use of slew bearing 50 and slew bearings 172 allow system 10 to support the heavy load of the agricultural implement, such as a combine header, being towed by system 10, and they also facilitate smoother turning, which reduces wear and tear and required maintenance and replacements of components on system 10.

### Alternative Arrangement:

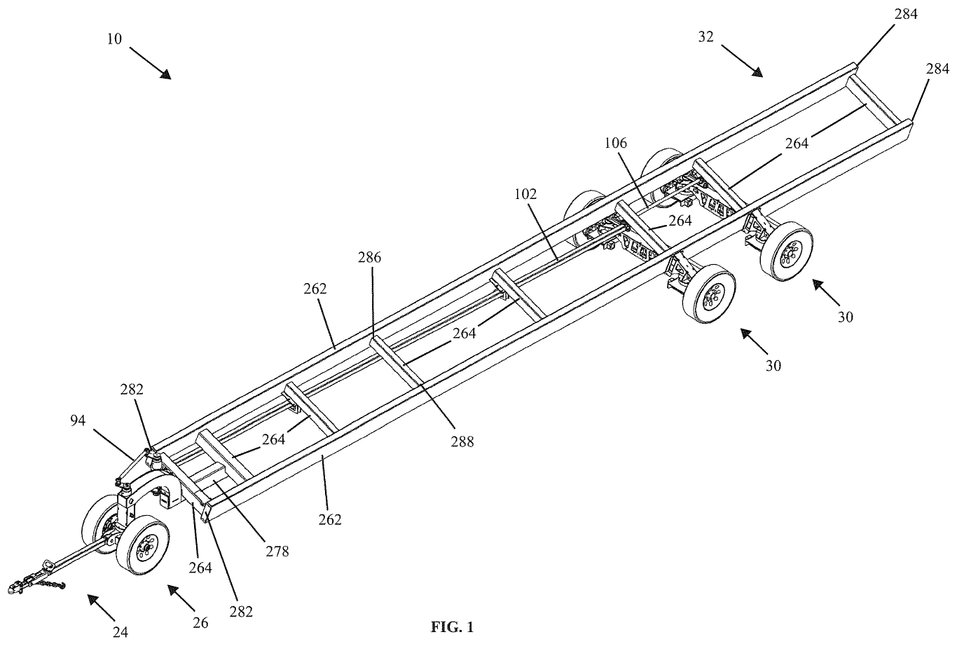

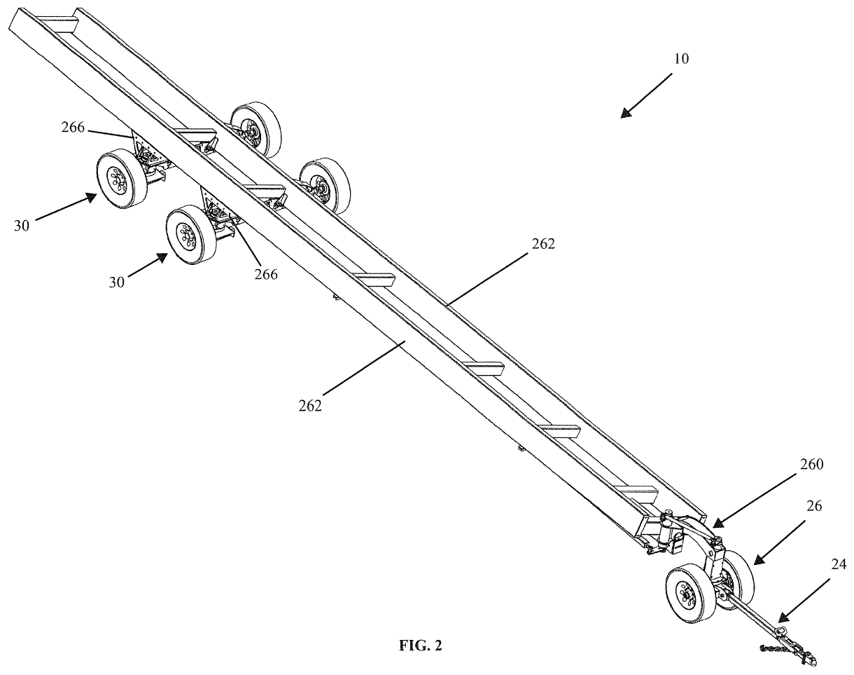

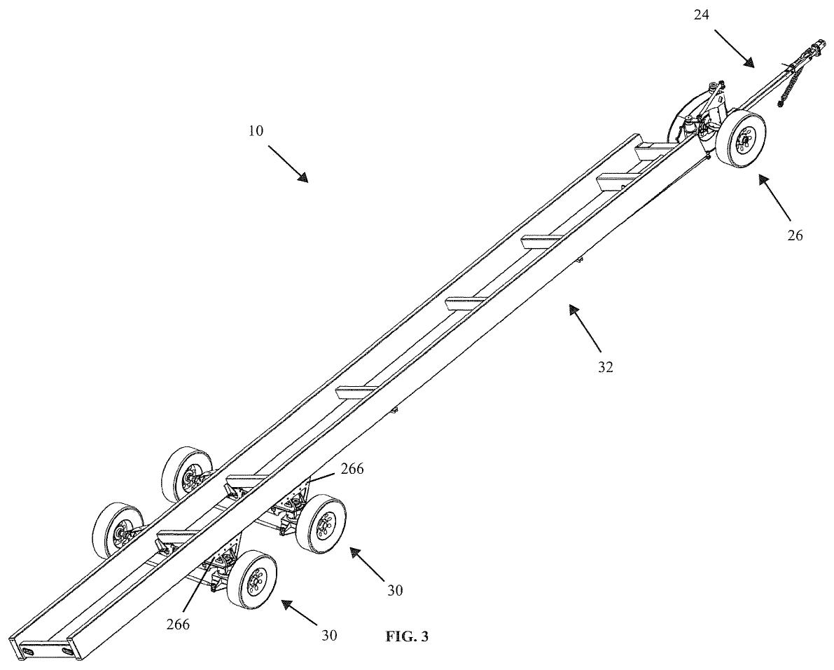

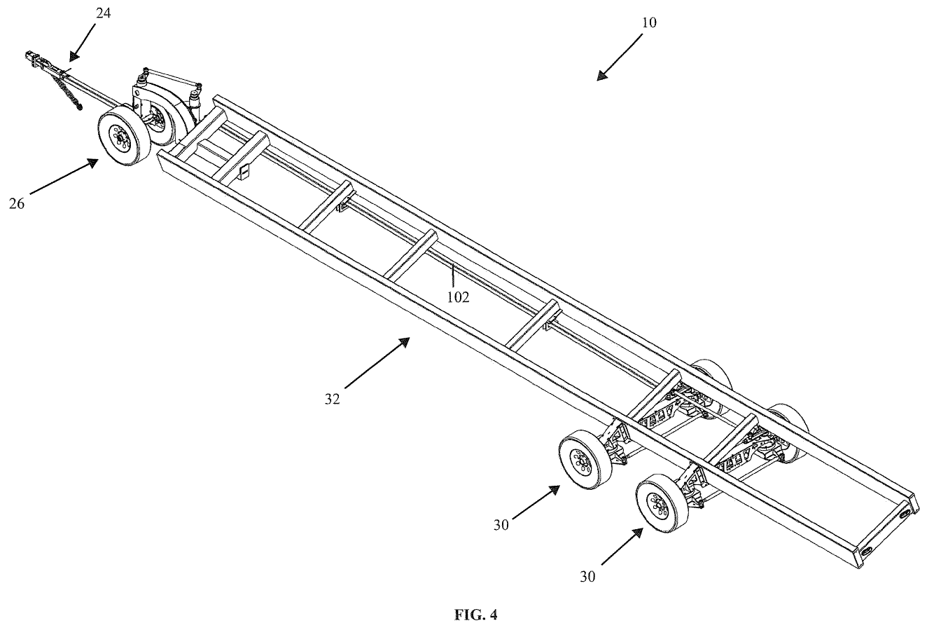

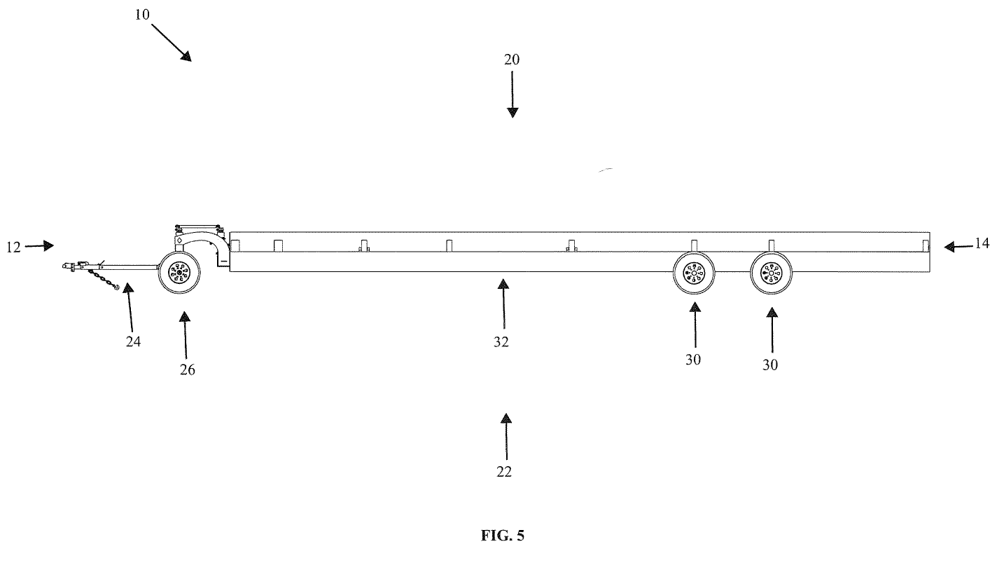

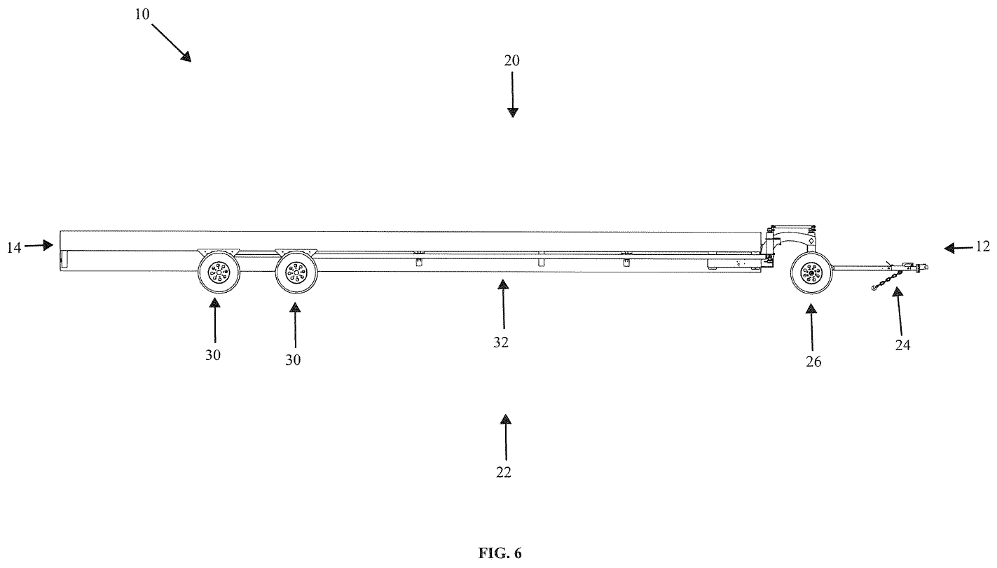

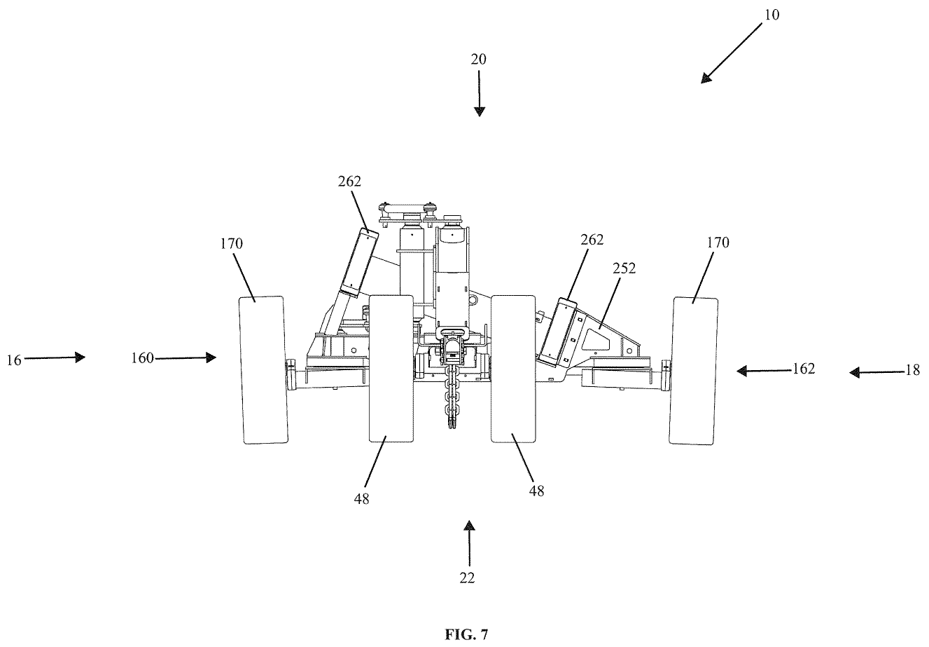

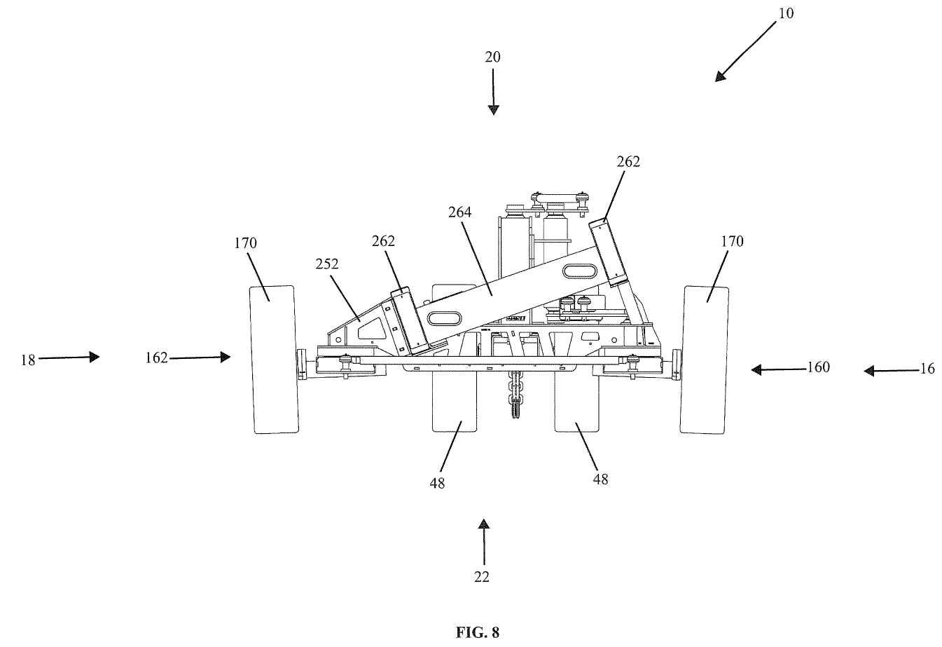

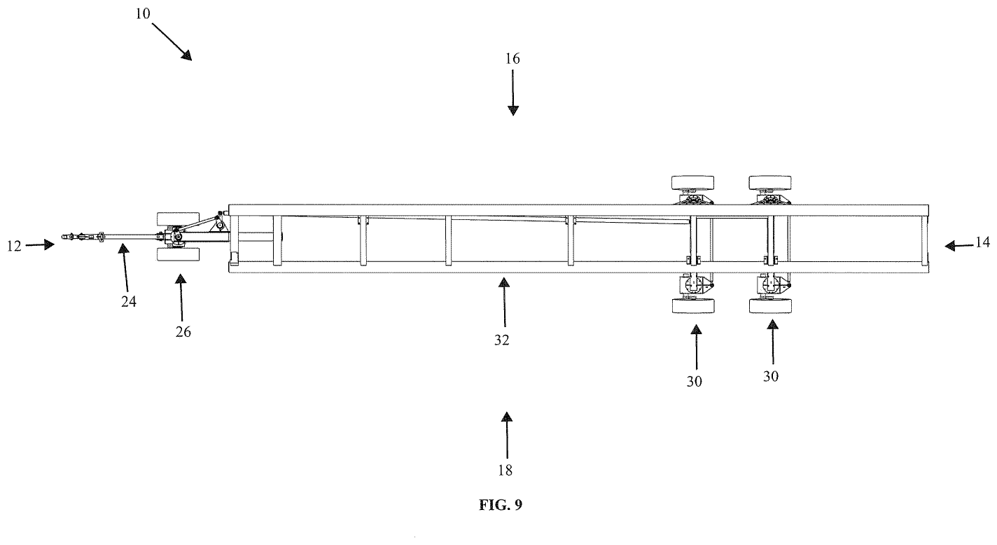

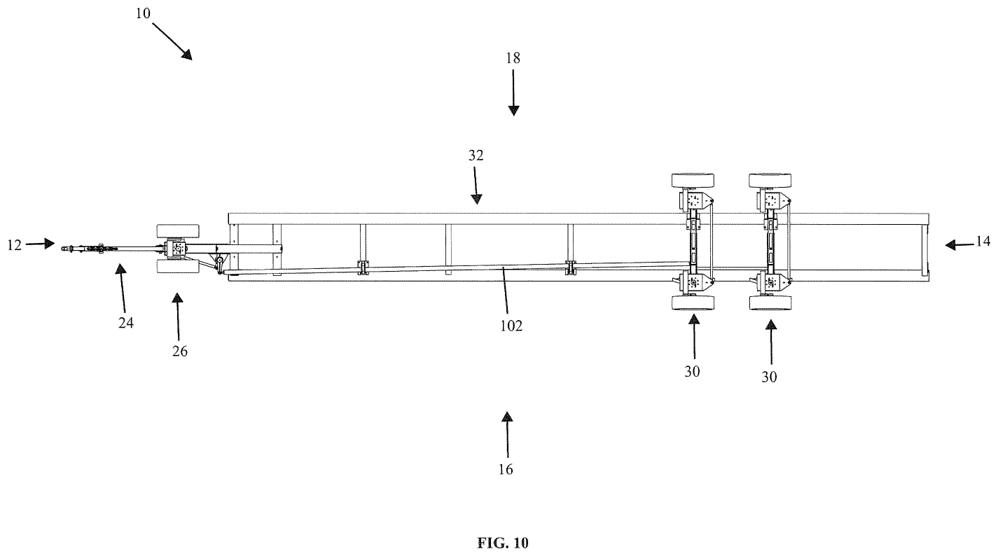

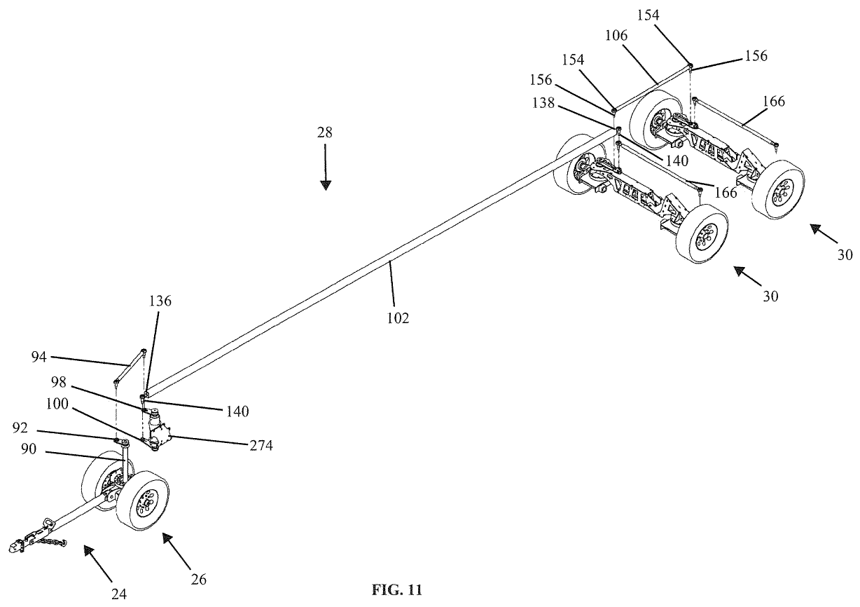

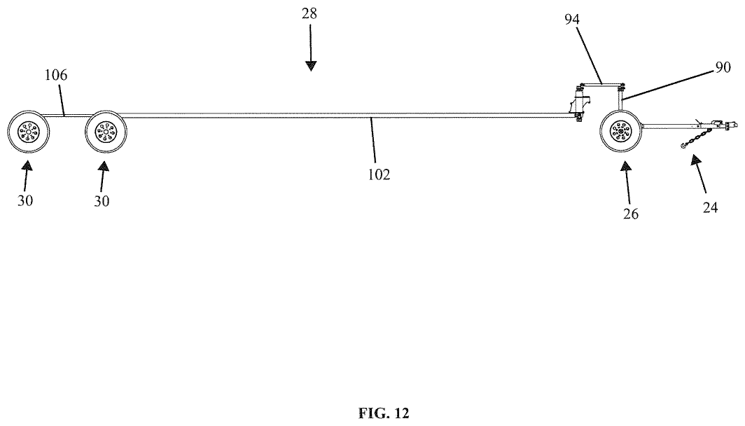

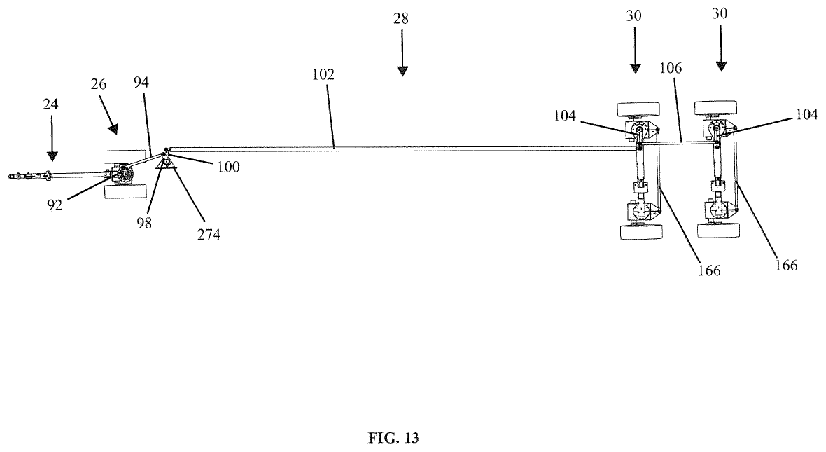

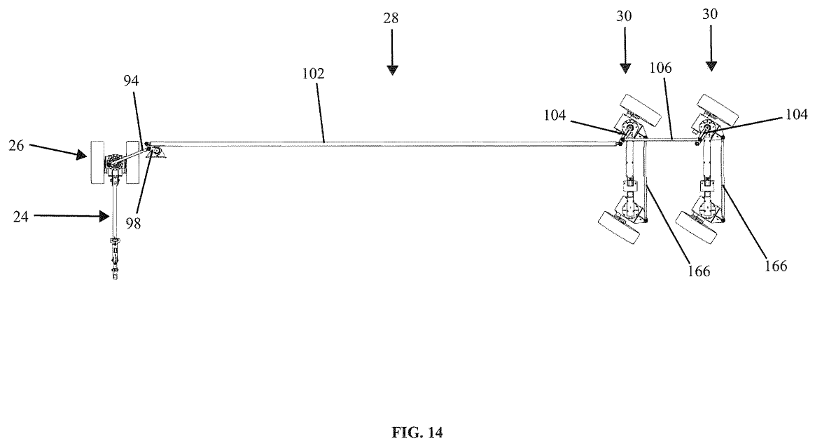

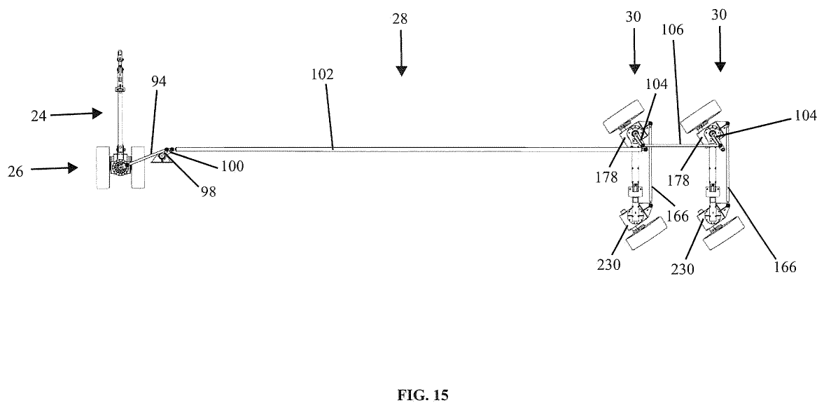

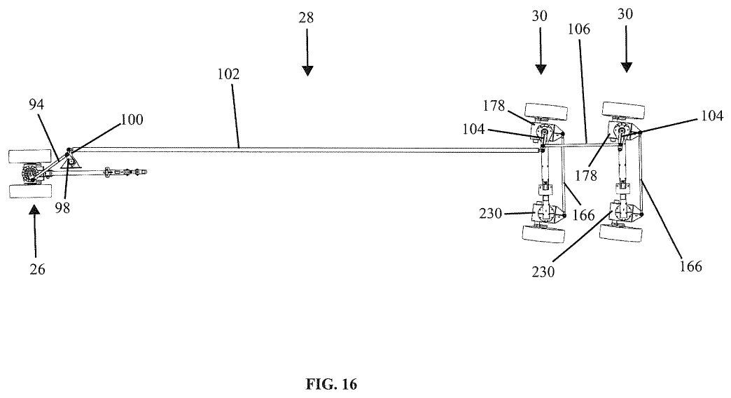

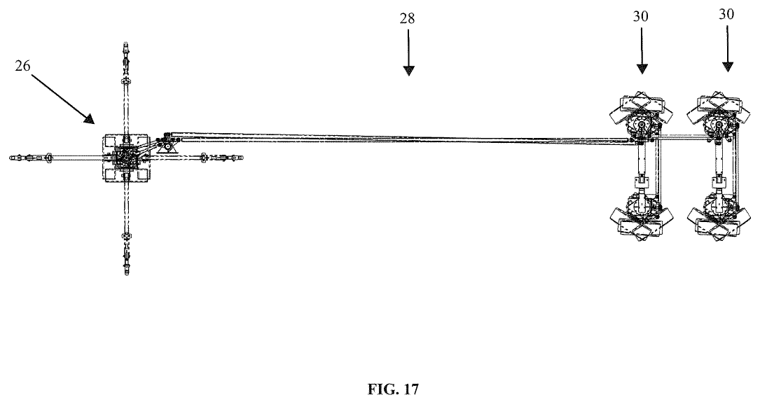

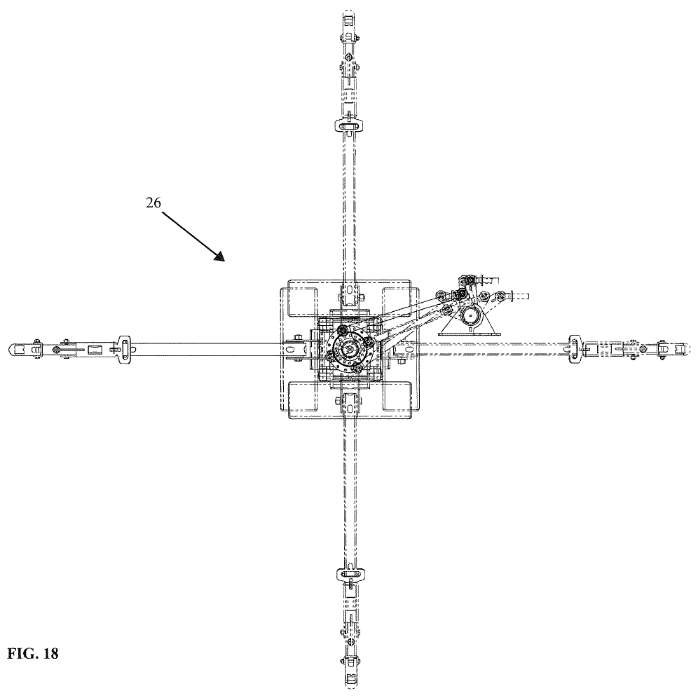

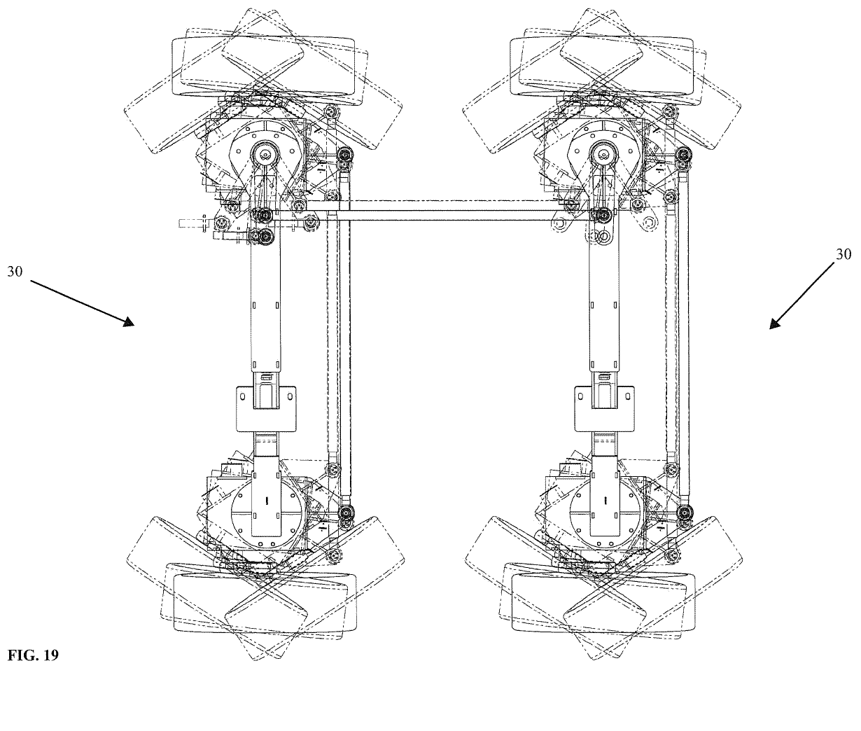

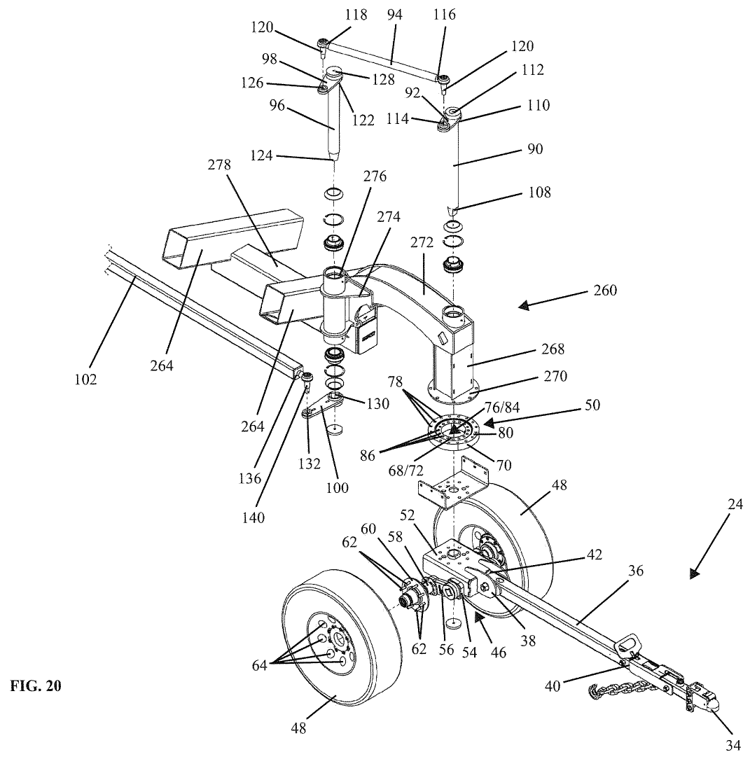

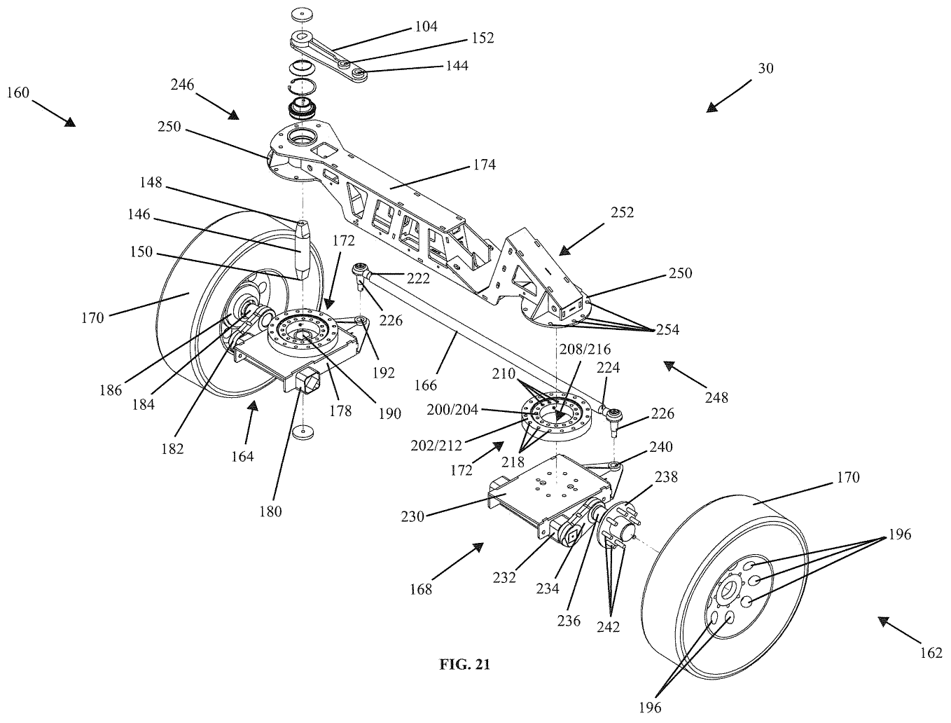

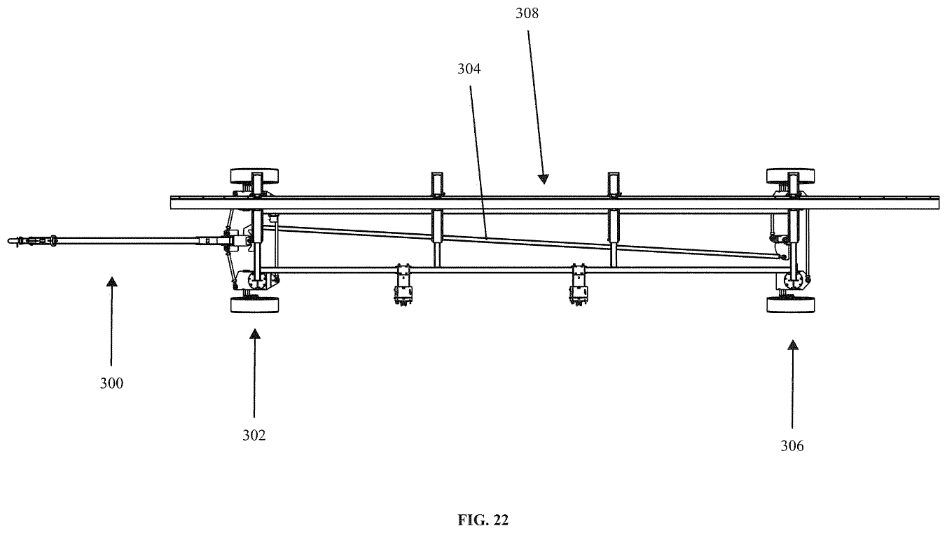

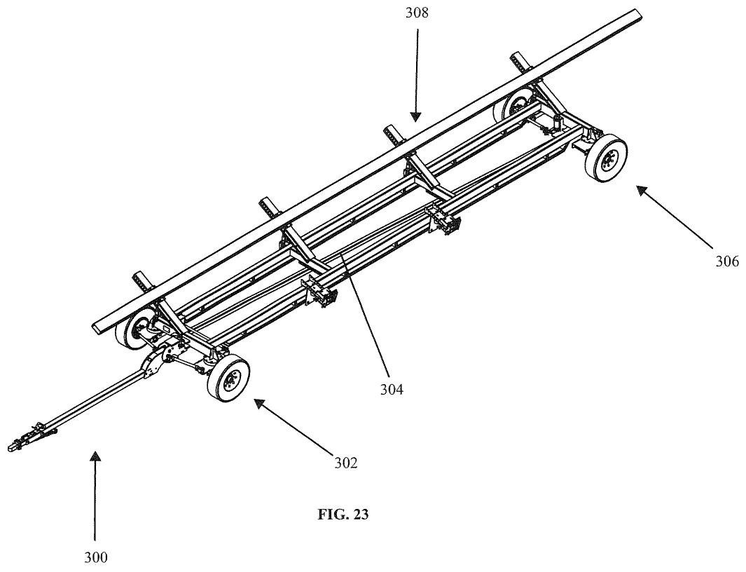

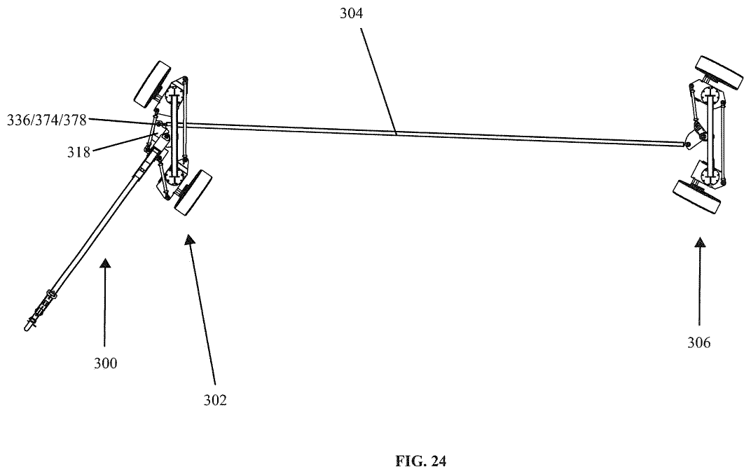

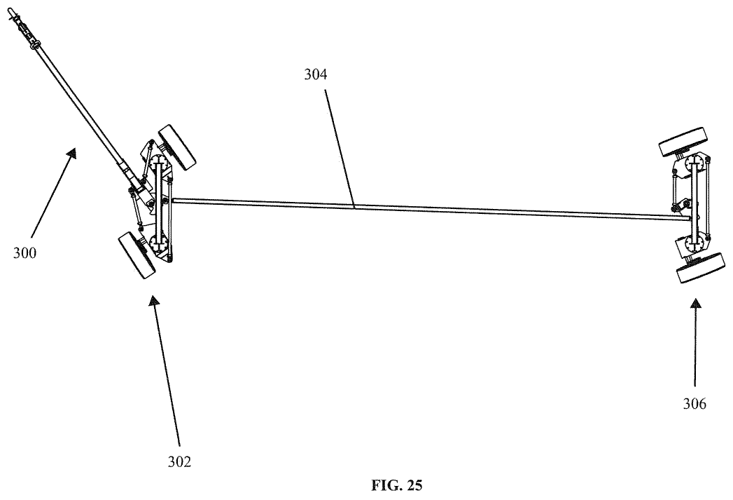

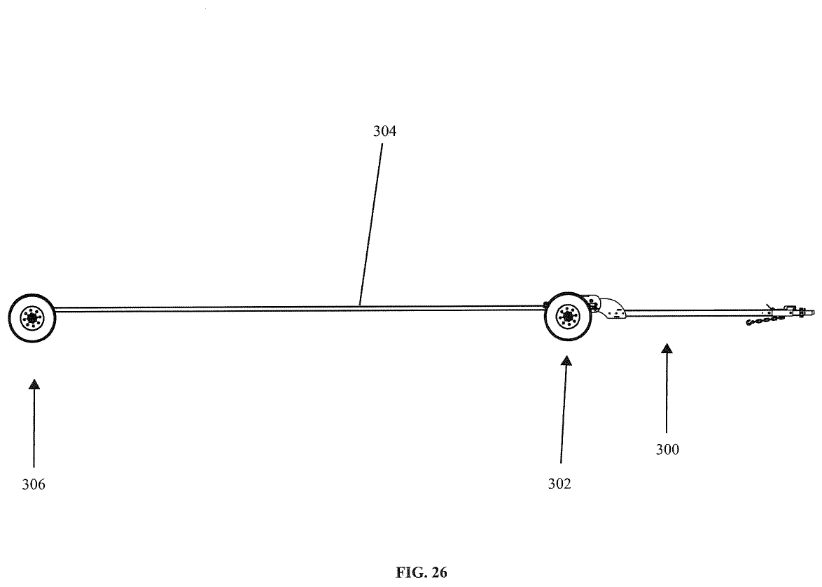

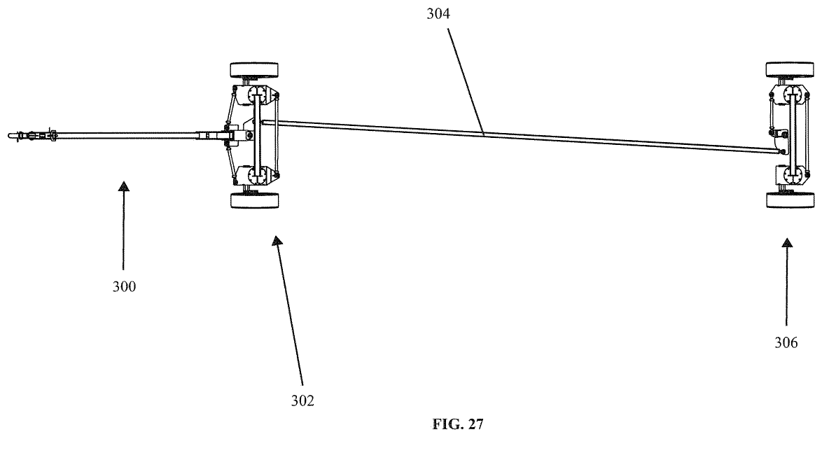

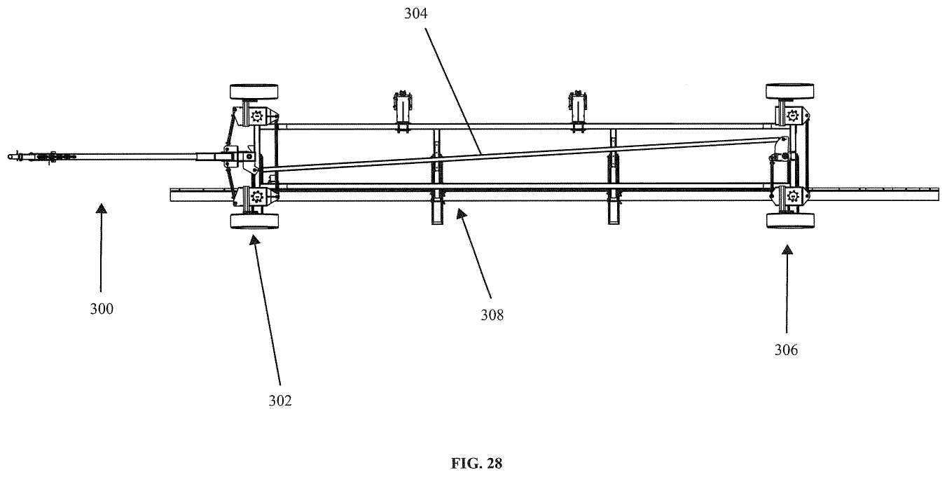

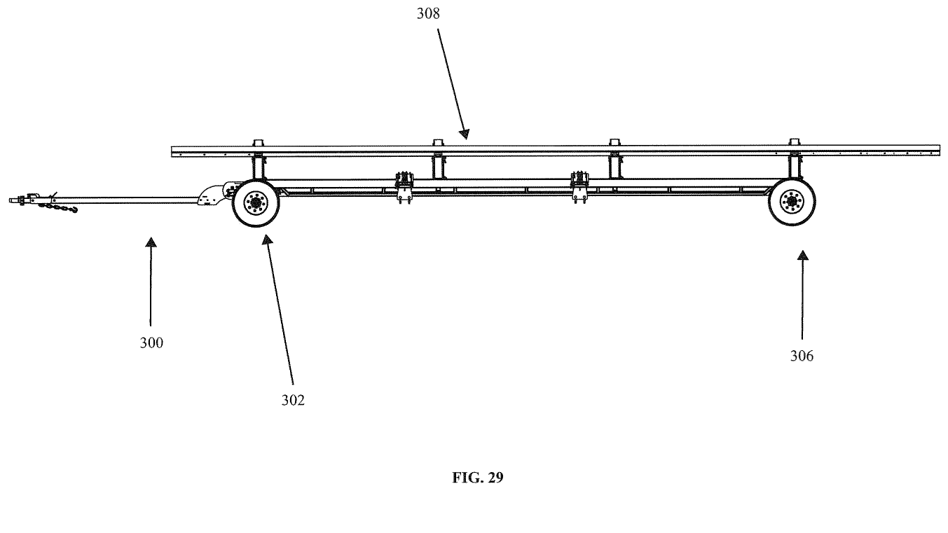

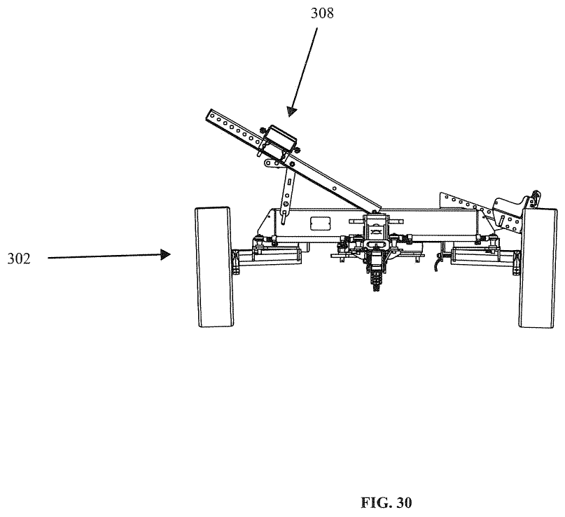

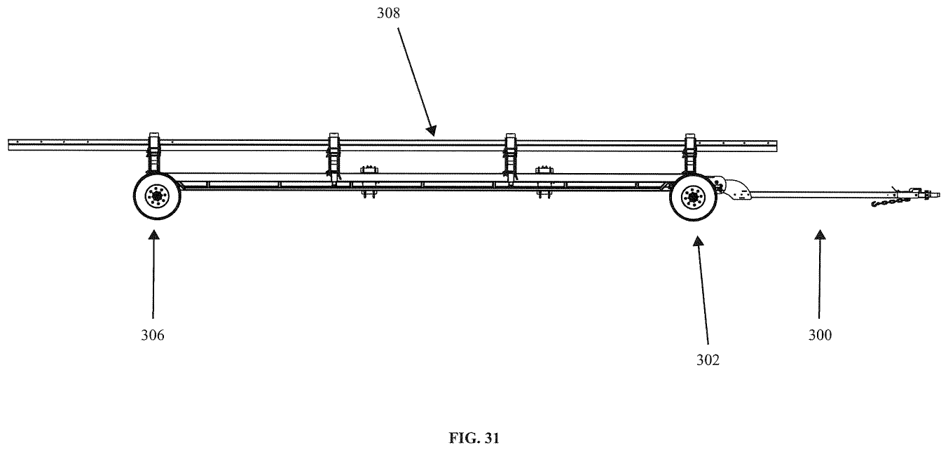

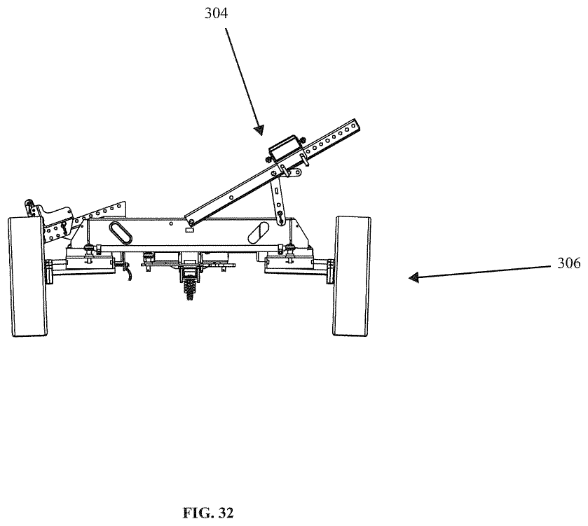

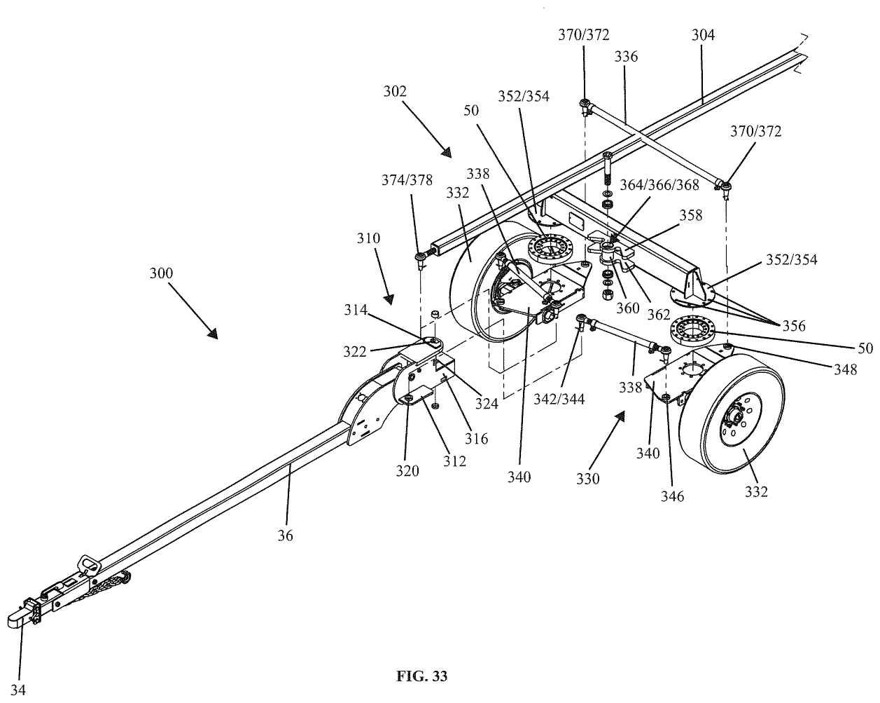

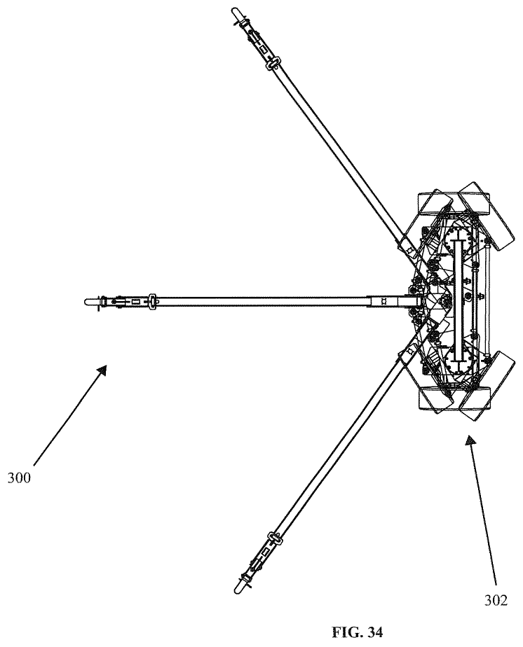

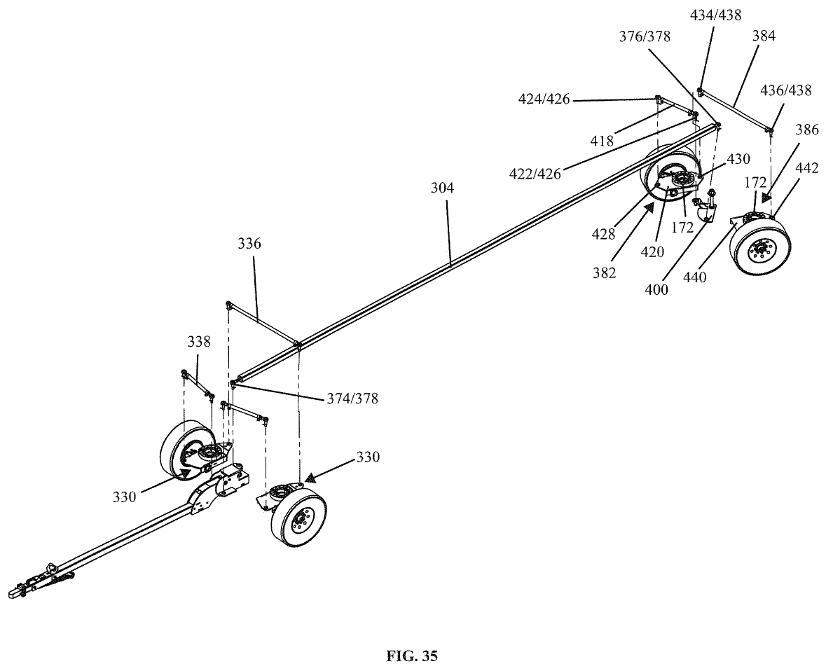

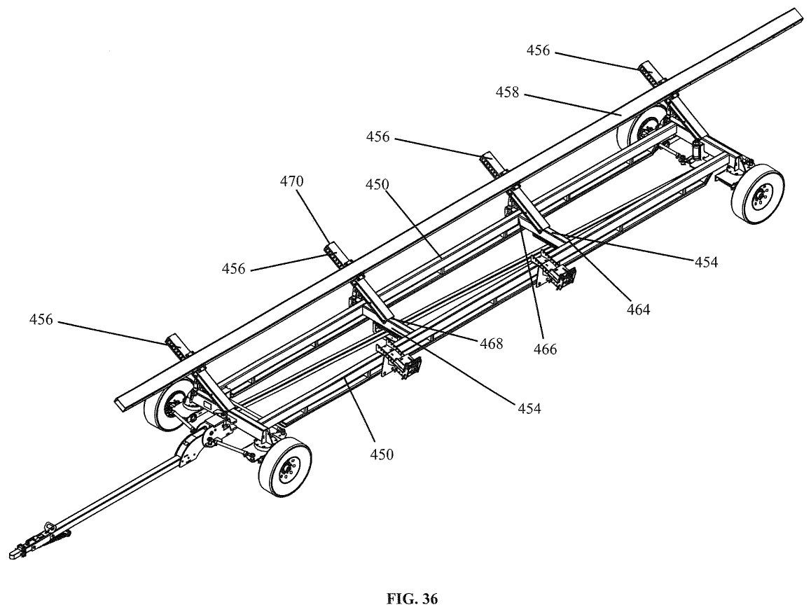

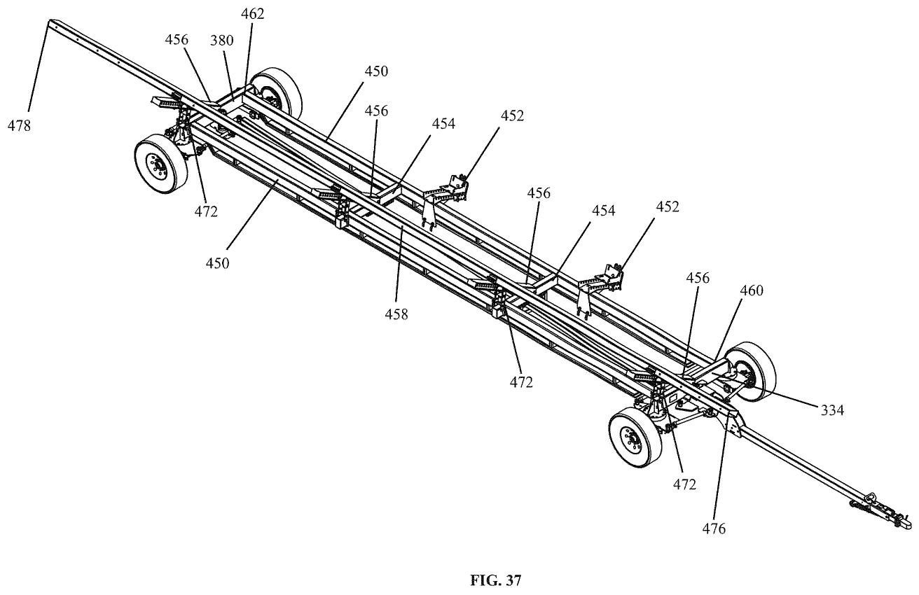

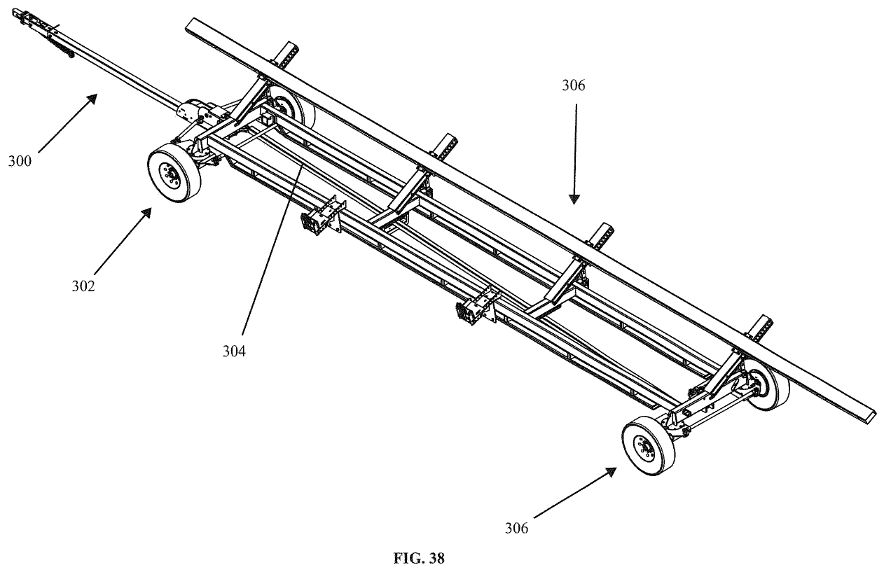

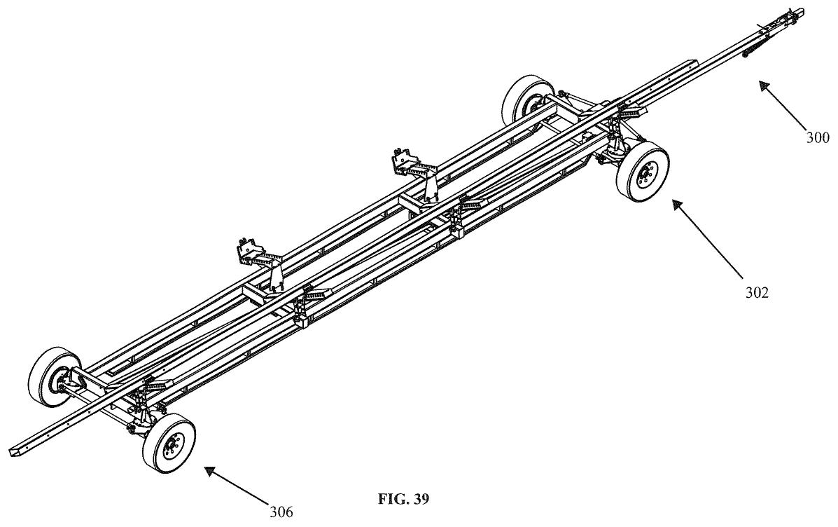

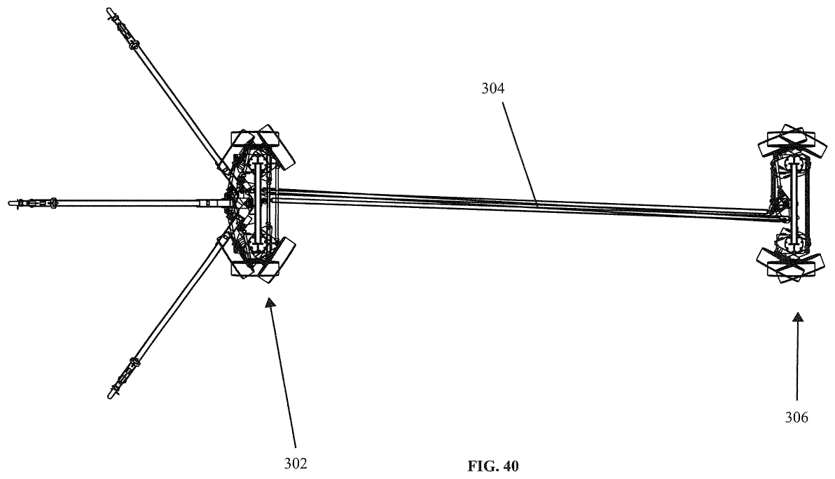

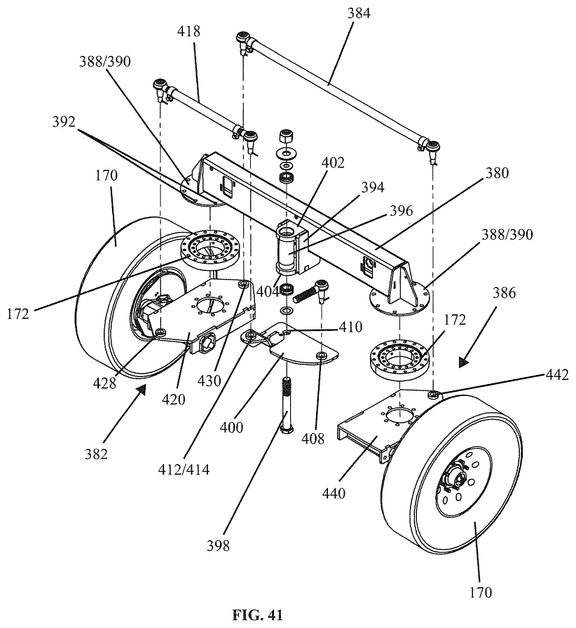

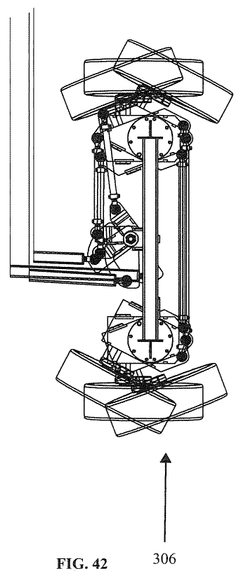

In the arrangements shown with reference to FIGS. 1-21, some example arrangements of system 10 are presented having a tongue assembly 24, a front wheel assembly 26, a steering assembly 28, rear wheel assemblies 30, and a frame assembly 32. The arrangements shown FIGS. 22-42 are similar to those shown in FIGS. 1-21 with slightly different configurations of the components of system 10. In the arrangements shown with reference to FIGS. 22-42, some example arrangements of system 10 are presented having a tongue assembly 300, a front wheel assembly 302, a steering tube 304, a rear wheel assembly 306, and a frame assembly 308. Accordingly, the disclosure related to the arrangements shown in FIGS. 1-21 applies to the arrangements shown in FIGS. 22-42 unless stated specifically herein. Specifically, unless stated specifically herein, (i) the disclosure related to arrangements of tongue assembly 24 apply to the arrangements of tongue assembly 300; (ii) the disclosure related to arrangements of front wheel assembly 26 apply to the arrangements of front wheel assembly 302; (iii) the disclosure related to arrangements of steering assembly 28 apply to the arrangements of steering tube 304; (iv) the disclosure related to arrangements of rear wheel assemblies 30 apply to the arrangements of rear wheel assembly 306; and (v) the disclosure related to arrangements of frame assembly 32 apply to the arrangements of frame assembly 308.

### Tongue Assembly 300:

In the alternative arrangements shown, as examples, system 10 includes tongue assembly 300. Tongue assembly 300 is formed of any suitable size, shape, and design and is configured to connect system 10 to a combine or other towing vehicle in order to transport system 10 and the agricultural implements placed on system 10, such as a combine header. In the arrangement shown, as one example, tongue assembly 300 includes coupler 34 and elongated tube 36 as previously described herein. Additionally, tongue assembly 300 includes connection member 310.

As previously described herein and in the arrangements shown, as examples, elongated tube 36 is an elongated square tube extending between first end 40 and second end 42. While in the arrangement shown, as one example, elongated tube 36 is shown as a square tube, any other shape, design, or layout of elongated tube 36 may be used in order to connect coupler 34 to the remainder of system 10. In the arrangement shown, as one example, elongated tube 36 operably connects to coupler 34 at its first end 40, and to connection member 310 at its second end 42.

### Connection Member 310:

In the arrangement shown, as one example, tongue assembly 300 includes connection member 310. Connection member 310 is formed of any suitable size, shape, and design and is configured to operably connect tongue assembly 300 to front wheel assembly 302 and steering tube 304. In the arrangement shown, as one example, connection member 310 includes tabs 312, a first protrusion 314, a second protrusion 316, and a shelf 318.

Tabs 312: In the arrangement shown, as one example, connection member 310 includes tabs 312. Tabs 312 are formed of any suitable size, shape, and design and are configured to facilitate operably connection between tongue assembly 24 and front wheel assembly 302. More specifically, tabs 312 are configured to facilitate connection between connection member 310 and the first tie rod 338 of the torsion axles 330 of front wheel assembly 302. In the arrangement shown, as one example, there is a tab 312 present on each side of connection member 310. In the arrangement shown, as one example, the tabs 312 are generally flat and planar and rectangular in shape and extend outward from each side of connection member 310. In the arrangement shown, as one example, tabs 312 include an opening 320 which is configured to receive an engagement member 344 of first tie rod 338 of the torsion axles 330 of front wheel assembly 302.

First Protrusion 314 and Second Protrusion 316: In the arrangement shown, as one example, connection member 310 also includes a first protrusion 314 and a second protrusion 316. First protrusion 314 and second protrusion 316 are formed of any suitable size, shape, and design and are configured to facilitate operable connection between tonnage assembly 24 and front wheel assembly 302. More specifically, first protrusion 314 and second protrusion 316 are configured to facilitate connection between connection member 310 and axle frame 334 of front wheel assembly 302.

In the arrangement shown, as one example, first protrusion 314 extends outward from a rear end of connection member 310 and first protrusion 314 is aligned such that the top surface of connection member 310 and the top surface of first protrusion 314 generally form one continuous, planar member. In the arrangement shown, as one example, first protrusion 314 includes an opening 322.

In the arrangement shown, as one example, second protrusion 316 extends outward from the rear end of connection member 310 at a point below first protrusion 314 such that there is an open space between first protrusion 314 and second protrusion 316. In the arrangement shown, as one example, second protrusion 316 is a generally square or rectangular block and includes an opening 324 in the top surface of second protrusion 316.

In the arrangement shown, as one example, the opening 322 in first protrusion 314 and the opening 324 in second protrusion 316 are generally aligned such a bolt or other fastener can pass through both opening 322 in first protrusion 314 and opening 324 in second protrusion 316. In the arrangement shown, as one example, the open space between first protrusion 314 and second protrusion 316 is generally shaped such that the first protrusion 358, cylinder 360, and second protrusion 362 of axle frame 334 of front wheel assembly 302 can fit within such open space. In the arrangement shown, as one example, when first protrusion 358, cylinder 360, and second protrusion 362 of axle frame 334 are positioned between first protrusion 314 and second protrusion 316 of connection member 310, a bolt (or other fastener) can be passed through opening 322 of first protrusion 314 of connection member 310, as well as through opening 364 of first protrusion 358, opening 366 of cylinder 360, and opening 368 of second protrusion 362 of axle frame 334, and finally through the opening 324 in second protrusion of connection member 310. When such bolt (or other fastener) has been passed through each of these openings in this way, a nut or other securing device can be placed on the bolt (or other fastener) in order to securely connecting connection member 310 to axle frame 334, thereby facilitating operable connection between tongue assembly 300 and front wheel assembly 302.

Shelf 318: In the arrangement shown, as one example, connection member 310 includes shelf 318. Shelf 318 is formed of any suitable size, shape, and design and is configured to facilitate operable connection between tongue assembly 24 and steering tube 304. In the arrangement shown, as one example, shelf 318 is a generally flat and planar member which extends outward from one side of connection member 310. In the arrangement shown, as one example, shelf 318 includes an opening 326 which is configured to receive an engagement member 378 of steering tube 304, thereby facilitating operable connection between tongue assembly 300 and steering tube 304.

While tongue assembly 300 and its component parts have been described according to the arrangement shown, as one example, it will be understood by those skilled in the art that any other configuration of tongue assembly 300 and its component parts may be used in order to connect system 10 to a combine or other towing vehicle in order to transport system 10 and the agricultural implements placed on system 10, such as a combine header.

### Front Wheel Assembly 302:

In the alternative arrangements shown, as examples, system 10 includes front wheel assembly 302. Front wheel assembly 302 is formed of any suitable size, shape, and design and is configured to operably connect to tongue assembly 300, steering tube 304, and frame assembly 308, and help facilitate the movement and turning of system 10 when system 10 is on the road. In the arrangement shown, as one example, front wheel assembly 302 includes torsion axles 330, wheels 332, an axle frame 334, and a second tie rod 336. Additionally, in the arrangement shown, as one example, front wheel assembly 302 includes slew bearings 50 as previously described herein.

### Torsion Axles 330:

In the arrangement shown, as one example, front wheel assembly 302 includes torsion axles 330. Torsion axles 330 are formed of any suitable size, shape, and design and are configured to operably connect front wheel assembly 302 to tongue assembly 300 and to operably connect the wheels 332 of front wheel assembly 302 to slew bearing 50. In the arrangement shown, as one example, there are two torsion axles 330, one on the left side 16 and one on the right side 18 of system 10. In the arrangement shown, as one example, each torsion axle 330 includes a first tie rod 338 and a bracket 340. Additionally, each torsion axle 330 includes an axle tube 54, an arm 56, a spindle 58, and a hub 60 as previously described herein.

In the arrangement shown, as one example, torsion axles 330 include first tie rods 338. First tie rods 338 are formed of any suitable size, shape, and design and are configured to facilitate operable connection between tongue assembly 300 and front wheel assembly 302 and transfer the rotation and/or turning of tongue assembly 300 to front wheel assembly 302 in order to facilitate the rotation and/or turning of wheels 332 and, subsequently, system 10. In the arrangement shown, as one example, first tie rod 338 is generally cylindrical and elongated, however first tie rod 338 may be shaped or designed in any other manner including being elongated and generally rectangular in shape or triangular in shape, or any other shape or design.

In the arrangement shown, as one example, first tie rod 338 may be formed of a single, unitary member that is formed in a manufacturing process such as machining, extrusion, forming, casting, additive manufacturing, or the like to form a unitary and monolithic member. Alternatively, first tie rod 338 may be formed of multiple pieces that are connected or assembled to one another through bolting, welding, screwing, friction fitting, or the like or any other means of connecting two members. In the arrangement shown, as one example, first tie rod 338 is formed primarily of a metallic material such as steel, aluminum, chromium, or any other metallic material, alloy, and/or composite thereof. Alternatively, first tie rod 338 may be formed of a non-metallic material such as a plastic material, a fiberglass material, or any other non-metallic material and/or composite thereof.

In the arrangement shown, as one example, first tie rod 338 extends a length between opposing ends 342, and engagement members 344 are present at each of the ends 342 of first tie rod 338. In the arrangement shown, as one example, the first end 342 of first tie rod 338 is configured to operably connect to a tab 312 of connection member 310. More specifically, in the arrangement shown, as one example, the engagement member 344 present at the first end 342 of first tie rod 338 is configured to be inserted through the opening 320 of such tab 312 and is operably connected to such tab 312 through any means of connection including screwing, bolting, welding, friction fitting, or any other means of connection. In this way, first tie rod 338 is operably connected to such tab 312 and to connection member 310.

In the arrangement shown, as one example, the engagement member 344 present at the second end 342 of first tie rod 338 is configured to operably connect to the first opening 346 in bracket 340. More specifically, in the arrangement shown, as one example, the engagement member 344 present at the second end 342 of first tie rod 338 is configured to be inserted through the first opening 346 of such bracket 340 and is operably connected to such bracket 340 through any means of connection including screwing, bolting, welding, friction fitting, or any other means of connection. In this way, first tie rod 338 is operably connected to such bracket 340.

In the arrangement shown, as one example, each torsion axle 330 includes a bracket 340. Bracket 340 is formed of any suitable size, shape, and design and is configured to operably connect to the first tie rod 338, to the inner member 68 of slew bearing 50, and to the second tie rod 336. In the arrangement shown, as one example, bracket 340 is a metallic, generally planar member and bracket 340 includes a first opening 346, a second opening 348, various holes configured to receive screws, bolts, or other means of connection therein in order to operably connect bracket 340 to the inner member 68 of slew bearing 50, and also an additional opening (not shown) for axle tube 54 to operably connect to bracket 340.

In the arrangement shown, as one example, first opening 346 is positioned near the front end of bracket 340. In the arrangement shown, as one example, first opening 346 is configured to operably receive an engagement member 344 of first tie rod 338 therein in order to operably connect first tie rod 338 to bracket 340. This connection between first tie rod 338 and bracket 340 also operably connects bracket 340 to tongue assembly 300. Due to this connection, bracket 340 rotates and/or turns when tongue assembly 300 is rotated and/or turned by the vehicle that is towing system 10.

That is, when the vehicle that is towing system 10 turns, tongue assembly 300 rotates and/or turns, which causes first tie rod 338 to be pushed or pulled. When first the rod 338 is pushed or pulled, it causes the front of bracket 340 to likewise be pushed or pulled to the side, which causes the rotation of bracket 340 itself. When bracket 340 itself rotates, then wheels 332 of front wheel assembly 302 turn, thereby causing system 10 to turn along with the vehicle towing system 10.

In the arrangement shown, as one example, second opening 348 is positioned near the rear end of bracket 340. In the arrangement shown, as one example, second opening 348 is configured to operably receive an engagement member 372 of second tie rod 336 therein in order to operably connect the brackets 340 of each torsion axle 330, and thereby connect the two torsion axles 330 of front wheel assembly 302.

In the arrangement shown, as one example, each torsion axle 330 includes axle tube 54. Axle tube 54 is formed of any suitable size, shape, and design and is configured to connect to bracket 340 and arm 56 of torsion axle 330. In the arrangement shown, as one example, axle tube 54 extends through an opening (not shown) in the side of bracket 340 in order to operably connect to bracket 340. In the arrangement shown, as one example, axle tube 54 connects to arm 56. Arm 56 is formed of any suitable size, shape, and design and is configured to operably connect to axle tube 54 and spindle 58. In the arrangement shown, as one example, spindle 58 is formed of any suitable size, shape, and design and is configured to connect to both arm 56 and hub 60. In the arrangement shown, as one example, hub 60 is configured to connect to the wheels 332 of front wheel assembly 302. In the arrangement shown, as one example, hub 60 includes threaded members 62 which are configured to extend through openings in wheels 332 in order to properly position and connect wheels 332 to hub 60. In this way, torsion axles 330 operably connect wheels 332 of front wheel assembly 302 to the remainder of front wheel assembly 302.

### Wheels 332:

In the arrangement shown, as one example, front wheel assembly 302 includes wheels 332. Wheels 332 are formed of any suitable size, shape, and design and are configured to facilitate the driving of system 10 on a road. In the arrangement shown, as one example, wheels 332 include openings which are configured to allow the threaded members 62 of hubs 60 to extend through wheels 332 in order to properly position and connect wheels 332 to hubs 60. More specifically, bolts are configured to be threaded onto threaded members 62 after the threaded members 62 are extended through the openings of wheels 332, thereby connecting wheels 332 to hubs 60. In the arrangement shown, as one example, wheels 332 may be any type of wheel in the industry.

In the arrangement shown, as one example, wheels 332 contain a camber which, when system 10 is at rest and unloaded, causes wheels 332 to extend upward from the ground at an angle outward. This camber is included to help accommodate for the weight of the agricultural implements, such as combine headers, that system 10 may be used to transport. Such agricultural implements, such as combine headers, weigh a massive amount and they are designed to be placed on the frame assembly 308 located primarily between the wheelbase of system 10. With the heavy weight placed primarily between the wheelbase, the wheels 332 of front wheel assembly 302 tend to want to angle inward under such heavy loads. In order to accommodate for this, a camber is placed on wheels 332 such that they are angled outward when unloaded but are approximately perpendicular to the road when a load is placed on system 10.

In the arrangement shown, as one example, wheels 332 (and torsion axles 330) are allowed to rotate relative to axle frame 334 of front wheel assembly 302 and frame assembly 308 due to slew bearings 50.

### Slew Bearings 50:

In the arrangement shown, as one example, front wheel assembly 302 includes slew bearings 50. In the arrangement shown, as one example, when used in front wheel assembly 302, slew bearings 50 are formed of any suitable size, shape, and design and are configured to operably connect to torsion axles 330 as well as axle frame 334, and to help facilitate the turning of wheels 332. In the arrangement shown, as one example, slew bearings 50 include an inner member 68, ball bearings (not shown), and an outer member 70.

In the arrangement shown, as one example, inner member 68 is a generally circular, planar member made of a metallic material. In the arrangement shown, as one example, inner member 68 has a thickness between an upper surface 72 and a lower surface (not shown) and an opening 76 extending through the geographic center of inner member 68. In the arrangement shown, as one example, inner member 68 also includes holes 78 configured to receive bolts therethrough.

In the arrangement shown, as one example, outer member 70 is also a generally circular, planar member made of a metallic material. In the arrangement shown, as one example, outer member 70 has a thickness between an upper surface 80 and a lower surface (not shown) and an opening 84 extending through the geographic center of outer member 70. In the arrangement shown, as one example, outer member 70 also includes holes 86 configured to receive bolts therethrough.

In the arrangement shown, as one example, the opening 84 in the center of outer member 70 is approximately sized such that the inner member 68 may rest within the opening 84 in outer member 70. In this manner, outer member 70 and inner member 68 form approximately concentric circles. In the arrangement shown, as one example, inner member 68 and outer member 70 includes grooves (not shown). In the arrangement shown, as one example, the groove in the outer member 70 is on its interior surface (not shown) and the groove in the inner member 68 is on its exterior surface (not shown). In the arrangement shown, as one example, ball bearings are placed in the grooves such that they rest within both the grooves in the inner member 68 and outer member 70. In this way, inner member 68 and outer member 70 are operably connected by the ball bearings, but the ball bearings allow inner member 68 and outer member 70 to rotate relative to each other.

In the arrangement shown, as one example, the inner member 68 of slew bearings 50 is configured to operably connect to the brackets 340 of torsion axles 330 by passing a bolt, screw, or other fastening member through the holes 78 of inner member 68 and through corresponding holes in bracket 340. In this way, slew bearings 50 operably connect to torsion axles 330. In the arrangement shown, as one example, the outer member 70 of slew bearings 50 operably connect to the flange 354 of axle frame 334. In this way, slew bearing 50 also operably connects to axle frame 334.

In the arrangement shown, as one example, this set up of slew bearings 50 provides a number of benefits and slew bearing 50 is advantageous to use in system 10. Specifically, compared to other types of bearings, slew bearings generally have lower friction, which leads to much greater durability, which means slew bearings 50 will not need to be replaced as often as other types of bearings may need to be. Further, slew bearings allow for smoother and more controlled rotation of the inner member 68 relative to the outer member 70, which produces smoother and more efficient turns of system 10. Finally, slew bearings are capable of supporting heavier loads than other types of bearings and because combine headers and other agricultural implements are extremely heavy, slew bearings 50 are capable of use even when other bearings would fail under the load. Therefore, it is advantageous to use slew bearings 50 compared to other bearings.

In the arrangement shown, as one example, when the vehicle towing system 10 turns, the tongue assembly 300 moves in the direction the vehicle is turning, which causes the front of brackets 340 of torsion axles 330 to move in that direction as well. When the front of brackets 340 of torsion axle 46 move, the inner member 68 of slew bearings 50 rotate in that direction and the wheels 332 of front wheel assembly 302 of system 10 turn in that direction. In the arrangement shown, as one example, the ball bearings of slew bearings 50, which operably connect inner member 68 to outer member 70, allow inner member 68 to rotate while outer member 70 remains approximately unmoved relative to inner member 68. That is, while inner member 68 rotates, outer member 70 does not rotate (or at least not as much as inner member 68). In this manner, slew bearings 50 operate to allow wheels 332 to turn without bending or putting pressure on the axle frame 334 of front wheel assembly 302 or on frame assembly 308 of system 10. In the arrangement shown, as one example, when brackets 340 of torsion axles 330 move and/or rotate, this also causes the second tie rod 336 of front wheel assembly 302 to move.

### Axle Frame 334:

In the arrangement shown, as one example, front wheel assembly 302 includes axle frame 334. Axle frame 334 is formed of any suitable size, shape, and design and is configured to provide rigidity and support to system 10 and securely connect the torsion axles 330 of front wheel assembly 302 together. In the arrangement shown, as one example, axle frame 334 includes opposing ends 352 and flanges 354.

In the arrangement shown, as one example, axle frame 334 may be formed of a single, unitary member that is formed in a manufacturing process such as machining, casting, forming, additive manufacturing, or the like to form a unitary and monolithic member. Alternatively, axle frame 334 may be formed of multiple pieces that are connected or assembled to one another through welding, bolting, screwing, friction fitting, or any other means of connecting two members. In the arrangement shown, as one example, axle frame 334 is formed primarily of a metallic material such as steel, aluminum, chromium, or any other metallic material, alloy, and/or composite thereof. Alternatively, axle frame 334 may be formed of a non-metallic material such as a plastic material, a fiberglass material, or any other non-metallic material and/or composite thereof.

In the arrangement shown, as one example, axle frame 334 is a generally elongated and primarily rectangular tube which extends between opposing ends 352. In the arrangement shown, as one example, each opposing end 352 of axle frame 334 includes flanges 354. Flanges 354 are formed of any suitable size, shape, and design and are configured to facilitate connection between axle frame 334 and the outer members 70 of slew bearings 50. In the arrangement shown, as one example, flanges 354 are generally round members with holes 356 which correspond with the holes 86 of outer members 70 such that screws, bolts, or any other fastener may be placed through holes 86 of outer members 70 and the holes 356 of flanges 354 in order to connect outer members 70 of slew bearings 50 to flanges 354 of axle frame 334.

In the arrangement shown, as one example, axle frame 334 is configured to connect to connection member 310 of tongue assembly 300. In the arrangement shown, as one example, to facilitate such connection, axle frame 334 includes a first protrusion 358, a cylinder 360, and a second protrusion 362.

First protrusion 358 is formed of any suitable size, shape, and design and is configured to help position and hold cylinder 360 in place and operably engage with the first protrusion 314 of connection member 310 of tongue assembly 300. In the arrangement shown, as one example, first protrusion 358 includes an opening 364 extending vertically through first protrusion 358 in order to receive a bolt (or other fastener) therethrough.

Cylinder 360 is formed of any suitable size, shape, and design and is configured to rest between first protrusion 358 and second protrusion 362 and receive a bolt (or other fastener) in an opening 366 extending through cylinder 360 in order to encompass such bolt (or other fastener) to provide greater safety, to protect against wear and tear, and/or to provide a better visual appearance of system 10.

Second protrusion 362 is formed of any suitable size, shape, and design and is configured to help position and hold cylinder 360 in place and operably engage with the second protrusion 316 of connection member 310 of tongue assembly 300. In the arrangement shown, as one example, second protrusion 362 includes an opening 368 extending vertically through second protrusion 362 in order to receive a bolt (or other fastener) therethrough.

In the arrangement shown, as one example, the opening 364 in first protrusion 358, the opening 366 in cylinder 360, and the opening 368 in second protrusion 362 are generally aligned such a bolt or other fastener can pass through such openings. In the arrangement shown, as one example, the open space between first protrusion 314 and second protrusion 316 is generally shaped such that the first protrusion 358, cylinder 360, and second protrusion 362 of axle frame 334 of front wheel assembly 302 can fit within such open space. In the arrangement shown, as one example, when first protrusion 358, cylinder 360, and second protrusion 362 of axle frame 334 are positioned between first protrusion 314 and second protrusion 316 of connection member 310, a bolt (or other fastener) can be passed through opening 322 of first protrusion 314 of connection member 310, as well as through opening 364 of first protrusion 358, opening 366 of cylinder 360, and opening 368 of second protrusion 362 of axle frame 334, and finally through the opening 324 in second protrusion of connection member 310. When such bolt (or other fastener) has been passed through each of these openings in this way, a nut or other securing device can be placed on the bolt (or other fastener) in order to securely connecting connection member 310 to axle frame 334, thereby facilitating operable connection between tongue assembly 300 and front wheel assembly 302.

### Second Tie Rod 336:

In the arrangement shown, as one example, front wheel assembly 302 also includes second tie rod 336. Second tie rod 336 is formed of any suitable size, shape, and design and is configured to operably connect the back ends of torsion axles 330 of front wheel assembly 302 together and to help transfer rotation of one bracket 340 to the other bracket 340. In the arrangement shown, as one example, second tie rod 336 is generally cylindrical and elongated, however tie rod 336 may be shaped or designed in any other manner including being elongated and generally rectangular in shape or triangular in shape, or any other shape or design.

In the arrangement shown, as one example, second tie rod 336 may be formed of a single, unitary member that is formed in a manufacturing process such as machining, extrusion, forming, casting, additive manufacturing, or the like to form a unitary and monolithic member. Alternatively, second tie rod 336 may be formed of multiple pieces that are connected or assembled to one another through bolting, welding, screwing, friction fitting, or the like or any other means of connecting two members. In the arrangement shown, as one example, second tie rod 336 is formed primarily of a metallic material such as steel, aluminum, chromium, or any other metallic material, alloy, and/or composite thereof. Alternatively, second tie rod 336 may be formed of a non-metallic material such as a plastic material, a fiberglass material, or any other non-metallic material and/or composite thereof.

In the arrangement shown, as one example, second tie rod 336 extends a length between opposing ends 370, and engagement members 372 are present at each of the opposing ends 370 of second tie rod 336. In the arrangement shown, as one example, the engagement members 372 are configured to be inserted through the second opening 348 of each bracket 340 of torsion axles 330 and engagement members 372 are operably connected to brackets 340 through any means of connection including screwing, bolting, welding, friction fitting, or any other means of connection. In this way, second tie rod 336 is operably connected to each bracket 340, thereby connecting the brackets 340 of the torsion axles 330 of the front wheel assembly 302.

While front wheel assembly 302 and its component parts have been described according to the arrangement shown, as one example, it will be understood by those skilled in the art that any other configuration of front wheel assembly 302 and its component parts may be used in order to operably connect to tongue assembly 300, steering tube 304, and frame assembly 308, and help facilitate the movement and turning of system 10 when system 10 is on the road.

### Steering Tube 304:

In the alternative arrangements shown, as examples, system 10 includes steering tube 304. Steering tube 304 is formed of any suitable size, shape, and design and is configured to operably connect to tongue assembly 300 and rear wheel assembly 306 and transfer turning and/or rotation of tongue assembly 300 to the turning of the wheels 170 of rear wheel assembly 306. In the arrangement shown, as one example, steering tube 304 is a generally square and elongated tube member, however steering tube 304 may be shaped or designed in any other manner including being elongated and generally cylindrical in shape or triangular in shape, or any other shape or design.

In the arrangement shown, as one example, steering tube 304 may be formed of a single, unitary member that is formed in a manufacturing process such as machining, extrusion, forming, casting, additive manufacturing, or the like to form a unitary and monolithic member. Alternatively, steering tube 304 may be formed of multiple pieces that are connected or assembled to one another through bolting, welding, screwing, friction fitting, or the like or any other means of connecting two members. In the arrangement shown, as one example, steering tube 304 is formed primarily of a metallic material such as steel, aluminum, chromium, or any other metallic material, alloy, and/or composite thereof. Alternatively, steering tube 304 may be formed of a non-metallic material such as a plastic material, a fiberglass material, or any other non-metallic material and/or composite thereof.

In the arrangement shown, as one example, steering tube 304 extends a length between a first end 374 and a second end 376, and engagement members 378 are present at each of the first end 374 and second end 376 of steering tube 304. In the arrangement shown, as one example, the first end 374 of steering tube 304 is configured to operably connect to the shelf 318 of connection member 310 of tongue assembly 300. In the arrangement shown, as one example, the engagement member 378 present at the first end 374 of steering tube 304 is configured to be inserted through the opening 326 of shelf 318 and is operably connected to shelf 318 through any means of connection including screwing, bolting, welding, friction fitting, or any other means of connection. In this way, steering tube 304 is operably connected to tongue assembly 300.

In the arrangement shown, as one example, the engagement member 378 present at the second end 376 of steering tube 304 is configured to operably connect to the shelf 400 of axle frame 380 of rear wheel assembly 306. More specifically, in the arrangement shown, as one example, the engagement member 378 present at the second end 376 of steering tube 304 is configured to be inserted through the first opening 408 of shelf 400 of axle frame 380 and is operably connected to the shelf 400 of axle frame 380 through any means of connection including screwing, bolting, welding, friction fitting, or any other means of connection. In this way, steering tube 304 is operably connected to rear wheel assembly 306.

In the arrangement shown, as one example, when the vehicle that is towing system 10 turns, tongue assembly 300 rotates and/or turns, which causes connection member 310 of tongue assembly 300 to turn. When connection member 310 moves, shelf 318 of connection member 310 also moves. When shelf 318 moves, steering tube 304 is pushed backwards or pulled forwards depending on the way shelf 318 moves. When steering tube 304 is pushed backwards or pulled forwards, the shelf 400 of axle frame 380 rotates as well. As shelf 400 rotates, the third tie rod 418 of first torsion axle 382 of rear wheel assembly 306 is pushed or pulled side to side, which causes the forward end of bracket 420 of first torsion axle 382 to move side to side, which causes the turning of the wheels 170 of rear wheel assembly 306. In this way, steering tube 304 transfers the turning and/or rotation of tongue assembly 300 to the turning of wheels 170 of rear wheel assembly 306.

In the arrangement shown, as one example, steering tube 304 is configured to turn the wheels 170 or rear wheel assembly 306 in the opposite direction of the wheels 332 of front wheel assembly 302. That is, in the arrangement shown, as one example, when the vehicle towing system 10 turns right, the wheels 332 of front wheel assembly 302 also turn right while the wheels 170 of rear wheel assembly 306 turn left. The advantage for this is that system 10 can be taken around tight corners without worry of system 10 going off the road. That is, in the arrangement shown, as one example, when system 10 is taking a sharp turn to the right, the rear end of system 10 swings out to the left, rather than cutting closer in to the right, allowing system 10 to take tighter turns without fear of the rear end of system 10 going off the road. Likewise, when the vehicle towing system 10 turns left, the wheels 332 of front wheel assembly 302 alto turn left while the wheels 170 of rear wheel assembly 306 turn right. The advantage of this, again, is that system 10 can be taken around tight corners without worry of system 10 going off the road. That is, in the arrangement shown, as one example, when system 10 is taking a sharp turn to the left, the rear end of system 10 swings out to the right, rather than cutting closer in to the left, allowing system 10 to take tighter turns without fear of the rear end of system 10 going off the road.

While steering tube 304 and its component parts have been described according to the arrangement shown, as one example, it will be understood by those skilled in the art that any other configuration of steering tube 304 and its component parts may be used in order to operably connect to tongue assembly 300 and rear wheel assembly 306 and transfer turning and/or rotation of tongue assembly 300 to the turning of the wheels 170 of rear wheel assembly 306.

### Rear Wheel Assembly 306:

In the alternative arrangements shown, as examples, system 10 includes rear wheel assembly 306. Rear wheel assembly 306 is formed of any suitable size, shape, and design and is configured to operably connect to steering tube 304 and frame assembly 32 and help facilitate the movement and turning of system 10 when system 10 is on the road. In the arrangement shown, as one example, rear wheel assembly 306 includes axle frame 380, first torsion axle 382, fourth tie rod 384, and second torsion axle 386. Additionally, in the arrangement shown, as one example, rear wheel assembly 306 includes wheels 170 and slew bearings 172 as previously described herein.

### Axle Frame 380:

In the arrangement shown, as one example, rear wheel assembly 306 includes axle frame 380. Axle frame 380 is formed of any suitable size, shape, and design and is configured to provide rigidity and support to system 10, help support frame assembly 308, and securely connect the first torsion axle 382 and second torsion axle 386 of rear wheel assembly 306. In the arrangement shown, as one example, axle frame 380 includes opposing ends 388 and flanges 390 with holes 392. In the arrangement shown, as one example, axle frame 380 also includes a protrusion 394, a cylinder 396, a connection member 398, and a shelf 400.

In the arrangement shown, as one example, axle frame 380 may be formed of a single, unitary member that is formed in a manufacturing process such as machining, casting, forming, additive manufacturing, or the like to form a unitary and monolithic member. Alternatively, axle frame 380 may be formed of multiple pieces that are connected or assembled to one another through welding, bolting, screwing, friction fitting, or any other means of connecting two members. In the arrangement shown, as one example, axle frame 380 is formed primarily of a metallic material such as steel, aluminum, chromium, or any other metallic material, alloy, and/or composite thereof. Alternatively, axle frame 380 may be formed of a non-metallic material such as a plastic material, a fiberglass material, or any other non-metallic material and/or composite thereof.

In the arrangement shown, as one example, axle frame 380 is a generally elongated and primarily rectangular tube which extends between opposing ends 388. In the arrangement shown, as one example, each opposing end 388 of axle frame 380 includes flanges 390. Flanges 390 are formed of any suitable size, shape, and design and are configured to facilitate connection between axle frame 380 and the outer members 202 of slew bearings 172. In the arrangement shown, as one example, flanges 390 are generally round members with holes 392 which correspond with the holes 218 of outer members 202 such that screws, bolts, or any other fastener may be placed through holes 218 of outer members 202 and the holes 392 of flanges 390 in order to connect outer members 202 of slew bearings 172 to flanges 390 of axle frame 380.

In the arrangement shown, as one example, axle frame 380 includes protrusion 394. Protrusion 394 is formed of any suitable size, shape, and design and is configured to help rotatably connect shelf 400 to axle frame 380, thereby helping to facilitate operable connection between rear wheel assembly 306 and steering tube 304. In the arrangement shown, as one example, protrusion 394 includes an upper tab 402 and a lower tab 404. In the arrangement shown, as one example, upper tab 402 and lower tab 404 include openings therethrough which align with one another and the opening in cylinder 396 and these openings together form an aperture through which connection member 398 can pass in order to rotatably connect shelf 400 to axle frame 380.

In the arrangement shown, as one example, cylinder 396 is configured to rest between the upper tab 402 and lower tab 404 of protrusion 394. Cylinder 396 is formed of any suitable size, shape, and design and is configured to receive connection member 398 therein in an opening extending through cylinder 396 in order to encompass connection member 398 to provide greater safety of system 10, to protect against wear and tear on connection member 398, and/or to provide a better visual appearance of system 10.

In the arrangement shown, as one example, axle frame 380 includes shelf 400. Shelf 400 is formed of any suitable size, shape, and design and is configured to rotatably connect to the protrusion 394 of axle frame 380 and connect to steering tube 304 in order to help transfer the turning and/or rotation of tongue assembly 300 to the turning of wheels 170 of rear wheel assembly 306. In the arrangement shown, as one example, shelf 400 includes a first opening 408, a second opening 410, a raised tab 412, and a third opening 414.

In the arrangement shown, as one example, shelf 400 includes first opening 408. First opening 408 is formed of any suitable size, shape, and design and is configured to receive an engagement member 378 of steering tube 304 therein in order to facilitate operable connection between steering tube 304 and rear wheel assembly 306. In the arrangement shown, as one example, the engagement member 378 on the second end 376 of steering tube 304 is configured to be inserted through the first opening 408 of shelf 400 and the engagement member 378 is connected to the shelf 400 through any means of connection including screwing, bolting, welding, friction fitting, or any other means of connection. In this way, shelf 400 operably connects steering tube 304 to rear wheel assembly 306.

In the arrangement shown, as one example, shelf 400 includes second opening 410. Second opening 410 is formed of any suitable size, shape, and design and is configured to allow connection member 398 to pass therethrough in order to connect shelf 400 to protrusion 394 of axle frame 380. In the arrangement shown, as one example, connection member 398 is a bolt, pint, rod, or other cylindrical member which is configured to be inserted through second opening 410. When connection member 398 is inserted through second opening 410 and secured such that shelf 400 is connected to protrusion 394, shelf 400 is connected to protrusion 394 at a single point. Additionally, in the arrangement shown, as one example, the connection of shelf 400 to protrusion 394 using connection member 398 allows for shelf 400 to rotate relative to axle frame 380 without disconnecting or breaking off of axle frame 380.

More specifically, in the connection member 398 is configured to pass through second opening 410 of shelf 400, then subsequently through the opening in the lower tab 404 of protrusion 394, then through the opening in cylinder 396, then finally through the opening in the upper tab 402 of protrusion 394. Once connection member 398 is passed through the second opening 410 of shelf 400 and through the aperture created by the openings of upper tab 402, lower tab 404, and cylinder 396, a nut or other securing device can be placed on connection member 398 in order to securely connect shelf 400 to protrusion 394, and shelf 400 is able to rotate relative to protrusion 394 and axle frame 380.

In the arrangement shown, as one example, shelf 400 includes a raised tab 412 with third opening 414. Raised tab 412 and third opening 414 are formed of any suitable size, shape, and design and are configured to be positioned upward relative to the main body of shelf 400 and allow shelf 400 to operably connect to third tie rod 418 of first torsion axle 382 in a position that allows third tie rod 418 to be level. In the arrangement shown, as one example, shelf 400 connects to axle frame 380 at a position than is lower than the position of first torsion axle 382, In the arrangement shown, as one example, in order for third tie rod 418 of first torsion axle 382 to most efficiently work, it must connect to shelf 400 while being in a relatively level position. Therefore, shelf 400 includes raised tab 412 in order to raise the position of the third opening 414 of shelf 400 in order for third tie rod 418 to connect to shelf 400 while maintaining a relatively level position.

### First Torsion Axle 382:

In the arrangement shown, as one example, rear wheel assembly 306 includes first torsion axle 382. First torsion axle 382 is formed of any suitable size, shape, and design and is configured to engage with and operably connect to shelf 400 of axle frame 380, thereby operably connecting rear wheel assembly 306 to steering tube 304. First torsion axle 382 is also formed of any suitable size, shape, and design and is configured to operably connect wheels 170 of rear wheel assembly 306 to slew bearings 172. In the arrangement shown, as one example, first torsion axle 382 a third tie rod 418 and a bracket 420. Additionally, in the arrangement shown, as one example, first torsion axle 382 includes an axle tube 180, an arm 182, a spindle 184, and a hub 186 as previously described herein.

In the arrangement shown, as one example, first torsion axle 382 is formed of multiple pieces that are connected or assembled to one another through welding, bolting, and friction fitting, however any other means of connecting or assembling the multiple pieces may be used. In the arrangement shown, as one example, first torsion axle 382 is formed primarily of a metallic material such as steel, aluminum, chromium, or any other metallic material, alloy, and/or composite thereof. Alternatively, first torsion axle 382 may be formed of a non-metallic material such as a plastic material, a fiberglass material, or any other non-metallic material and/or composite thereof.

In the arrangement shown, as one example, first torsion axle 382 includes a third tie rod 418 is formed of any suitable size, shape, and design and is configured to facilitate operably connection between shelf 400 and first torsion axle 382 and transfer the rotation and/or turning of shelf 400 (due to the movement of steering tube 304) to first torsion axle 382 in order to facilitate the turning of wheels 170 and, subsequently, system 10. In the arrangement shown, as one example, third tie rod 418 is generally cylindrical and elongated, however third tie rod 418 may be shaped or designed in any other manner including being elongated and generally rectangular in shape or triangular in shape, or any other shape or design.

In the arrangement shown, as one example, third tie rod 418 may be formed of a single, unitary member that is formed in a manufacturing process such as machining, extrusion, forming, casting, additive manufacturing, or the like to form a unitary and monolithic member. Alternatively, third tie rod 418 may be formed of multiple pieces that are connected or assembled to one another through bolting, welding, screwing, friction fitting, or the like or any other means of connecting two members. In the arrangement shown, as one example, third tie rod 418 is formed primarily of a metallic material such as steel, aluminum, chromium, or any other metallic material, alloy, and/or composite thereof. Alternatively, third tie rod 418 may be formed of a non-metallic material such as a plastic material, a fiberglass material, or any other non-metallic material and/or composite thereof.

In the arrangement shown, as one example, third tie rod 418 extends a length between a first end 422 and a second end 424, and engagement members 426 are present at each of the first end 422 and second end 424 of third tie rod 418. In the arrangement shown, as one example, the first end 422 of third tie rod 418 is configured to operably connect to shelf 400 of axle frame 380. More specifically, in the arrangement shown, as one example, the engagement member 426 present at the first end 422 of third tie rod 418 is configured to be inserted through the third opening 414 on the raised tab 412 of shelf 400 and is operably connected to such raised tab 412 through any means of connection including screwing, bolting, welding, friction fitting, or any other means of connection. In this way, third tie rod 418 is operably connected to such raised tab 412 and to shelf 400 of axle frame 380.

In the arrangement shown, as one example, the engagement member 426 present at the second end 424 of third tie rod 418 is configured to operably connect to the first opening 428 in bracket 420. More specifically, in the arrangement shown, as one example, the engagement member 426 present at the second end 424 of third tie rod 418 is configured to be inserted through the first opening 428 in bracket 420 and is operably connected to bracket 420 through any means of connection including screwing, bolting, welding, friction fitting, or any other means of connection. In this way, third tie rod 418 is operably connected to bracket 420.

In the arrangement shown, as one example, each first torsion axle 382 includes a bracket 420. Bracket 420 is formed of any suitable size, shape, and design and is configured to operably connect to the third tie rod 418, to the inner member 200 of slew bearing 172, and to the fourth tie rod 384. In the arrangement shown, as one example, bracket 420 is a metallic, generally planar member and bracket 420 includes a first opening 428, a second opening 430, various holes configured to receive screws, bolts, or other means of connection therein in order to operably connect bracket 420 to the inner member 200 of slew bearing 172, and also an additional opening (not shown) for axle tube 180 to operably connect to bracket 420.

In the arrangement shown, as one example, first opening 428 is positioned near the front end of bracket 420. In the arrangement shown, as one example, first opening 428 is configured to operably receive an engagement member 426 of third tie rod 418 therein in order to operably connect third tie rod 418 to bracket 420. This connection between third tie rod 418 and bracket 420 also operably connects bracket 420 to steering tube 304 and tongue assembly 300. Due to this connection, bracket 420 rotates and/or turns when tongue assembly 300 is rotated and/or turned by the vehicle that is towing system 10.

That is, when the vehicle that is towing system 10 turns, tongue assembly 300 rotates and/or turns, which causes steering tube 304 to be pushed or pulled. When steering tube 304 is pushed or pulled, it causes shelf 400 to rotate and/or move. When shelf 400 rotates and/or moves, third tie rod 418 is pushed or pulled side to side. In the arrangement shown, as one example, when third tie rod 418 is pushed or pulled side to side, the front of bracket 420 is likewise pushed or pulled side to side, which causes the rotation of bracket 420 itself. When bracket 420 itself rotates, then wheels 170 of rear wheel assembly 306 turn, thereby causing system 10 to turn along with the vehicle towing system 10.

In the arrangement shown, as one example, second opening 430 is positioned near the rear end of bracket 420. In the arrangement shown, as one example, second opening 430 is configured to operably receive an engagement member 438 of fourth tie rod 384 therein in order to operably connect brackets 420 of first torsion axle 382 to bracket 440 of second torsion axle 386, and thereby help to operably connect the first torsion axles 382 and second torsion axle 386.

In the arrangement shown, as one example, first torsion axle 382 includes axle tube 180. Axle tube 180 is formed of any suitable size, shape, and design and is configured to connect to bracket 420 and arm 182 of first torsion axle 382. In the arrangement shown, as one example, axle tube 180 extends through an opening (not shown) in bracket 420, thereby operably connecting to bracket 420.

In the arrangement shown, as one example, axle tube 180 connects to arm 182. Arm 182 is formed of any suitable size, shape, and design and is configured to operably connect to axle tube 180 and spindle 184 of first torsion axle 382. In the arrangement shown, as one example, spindle 184 is formed of any suitable size, shape, and design and is configured to connect to both arm 182 and hub 186. In the arrangement shown, as one example, hub 186 is configured to connect to a wheel 170 of rear wheel assembly 306. In the arrangement shown, as one example, hub 186 includes threaded members (not shown) which are configured to extend through openings 196 in a wheel 170 in order to properly position and connect the wheel 170 to hub 186. In this way, first torsion axle 382 operably connects the wheel 170 of rear wheel assembly 306 to the remainder of rear wheel assembly 306.

### Fourth Tie Rod 384:

In the arrangement shown, as one example, rear wheel assembly 306 includes fourth tie rod 384. Fourth tie rod 384 is formed of any suitable size, shape, and design and is configured to help transfer the rotation of bracket 420 of first torsion axle 382 to bracket 440 of second torsion axle 386 of rear wheel assembly 306.

In the arrangement shown, as one example, fourth tie rod 384 is generally cylindrical and elongated, however fourth tie rod 384 may be shaped or designed in any other manner including being elongated and generally rectangular in shape or triangular in shape, or any other shape or design.

In the arrangement shown, as one example, fourth tie rod 384 may be formed of a single, unitary member that is formed in a manufacturing process such as machining, extrusion, forming, casting, additive manufacturing, or the like to form a unitary and monolithic member. Alternatively, fourth tie rod 384 may be formed of multiple pieces that are connected or assembled to one another through bolting, welding, screwing, friction fitting, or the like or any other means of connecting two members. In the arrangement shown, as one example, fourth tie rod 384 is formed primarily of a metallic material such as steel, aluminum, chromium, or any other metallic material, alloy, and/or composite thereof. Alternatively, fourth tie rod 384 may be formed of a non-metallic material such as a plastic material, a fiberglass material, or any other non-metallic material and/or composite thereof.

In the arrangement shown, as one example, fourth tie rod 384 extends a length between a first end 434 and a second end 436, and engagement members 438 are present at each of the first end 434 and second end 436 of fourth tie rod 384. In the arrangement shown, as one example, the first end 434 of fourth tie rod 384 is configured to operably connect to bracket 420 of first torsion axle 382. In the arrangement shown, as one example, the engagement member 438 present at the first end 434 of fourth tie rod 384 is configured to be inserted through the second opening 430 of bracket 420 of first torsion axle 382 and is operably connected to bracket 420 through any means of connection including screwing, bolting, welding, friction fitting, or any other means of connection. In this way, fourth tie rod 384 is operably connected to first torsion axle 382.

In the arrangement shown, as one example, the engagement member 438 present at the second end 436 of fourth tie rod 384 is configured to operably connect to bracket 440 of second torsion axle 386 of rear wheel assembly 306. More specifically, in the arrangement shown, as one example, the engagement member 438 present at the second end 436 of fourth tie rod 384 is configured to be inserted through the opening 442 of bracket 440 of second torsion axle 386 and is operably connected to bracket 440 of second torsion axle 386 through any means of connection including screwing, bolting, welding, friction fitting, or any other means of connection. In this way, fourth tie rod 384 is operably connected to second torsion axle 386.

### Second Torsion Axle 386:

In the arrangement shown, as one example, rear wheel assembly 306 includes second torsion axle 386. Second torsion axle 386 is formed of any suitable size, shape, and design and is configured to engage with and operably connect to fourth tie rod 384, thereby operably connecting second torsion axle 386 to first torsion axle 382 such that when the wheel 170 connected to first torsion axle 382 rotates and/or turns, the wheel 170 connected to the second torsion axle 386 also rotates and/or turns. Second torsion axle 386 is also configured to operably connect a wheel 170 to a slew bearing 172 of rear wheel assembly 306. In the arrangement shown, as one example, second torsion axle 386 includes a bracket 440. Additionally, in the arrangement shown, as one example, second torsion axle 386 includes an axle tube 180, an arm 182, a spindle 184, and a hub 186 as previously described herein.

In the arrangement shown, as one example, second torsion axle 386 is formed of multiple pieces that are connected or assembled to one another through welding, bolting, and friction fitting, however any other means of connecting or assembling the multiple pieces may be used. In the arrangement shown, as one example, second torsion axle 386 is formed primarily of a metallic material such as steel, aluminum, chromium, or any other metallic material, alloy, and/or composite thereof. Alternatively, second torsion axle 386 may be formed of a non-metallic material such as a plastic material, a fiberglass material, or any other non-metallic material and/or composite thereof.

In the arrangement shown, as one example, second torsion axle 386 includes a bracket 440. Bracket 440 is formed of any suitable size, shape, and design and is configured to operably connect to the inner member 200 of slew bearing 172 and to the fourth tie rod 384. In the arrangement shown, as one example, bracket 440 is a metallic, generally planar member and bracket 440 includes an opening 442, various holes configured to receive screws, bolts, or other means of connection therein in order to operably connect bracket 440 to the inner member 200 of slew bearing 172, and also an additional opening (not shown) for axle tube 180 to operably connect to bracket 440.

In the arrangement shown, as one example, opening 442 is positioned near the rear end of bracket 440. In the arrangement shown, as one example, opening 442 is configured to operably receive an engagement member 438 of fourth tie rod 384 therein in order to operably connect bracket 440 of second torsion axle 386 to bracket 420 of first torsion axle 382, and thereby help to operably connect the first torsion axles 382 and second torsion axle 386.

In the arrangement shown, as one example, second torsion axle 386 includes axle tube 180. Axle tube 180 is formed of any suitable size, shape, and design and is configured to connect to bracket 440 and arm 182 of second torsion axle 386. In the arrangement shown, as one example, axle tube 180 extends through an opening (not shown) in bracket 440, thereby operably connecting to bracket 440.

In the arrangement shown, as one example, axle tube 180 connects to arm 182. Arm 182 is formed of any suitable size, shape, and design and is configured to operably connect to axle tube 180 and spindle 184 of second torsion axle 386. In the arrangement shown, as one example, spindle 184 is formed of any suitable size, shape, and design and is configured to connect to both arm 182 and hub 186. In the arrangement shown, as one example, hub 186 is configured to connect to a wheel 170 of rear wheel assembly 306. In the arrangement shown, as one example, hub 186 includes threaded members (not shown) which are configured to extend through openings 196 in a wheel 170 in order to properly position and connect the wheel 170 to hub 186. In this way, second torsion axle 386 operably connects the wheel 170 of rear wheel assembly 306 to the remainder of rear wheel assembly 306

Wheels 170: In the arrangement shown, as one example, rear wheel assembly 306 includes wheels 170. Wheels 170 are formed of any suitable size, shape, and design and are configured to facilitate the driving of system 10 on a road. In the arrangement shown, as one example, wheels 170 include openings 196 which are configured to receive and connect to hub 186 of either first torsion axle 382 or second torsion axle 386. In the arrangement shown, as one example, wheels 170 include openings 196 which are configured to allow the threaded members (not shown) of hub 186 to extend through a portion of the wheels 170 in order to properly position and connect the wheels 170 to hub 186. More specifically, bolts are configured to be threaded onto the threaded members (not shown) of hub 186 after they are extended through wheels 170, thereby connecting wheels 170 to the threaded members (not shown) of hub 186, and also to hub 186 itself. In the arrangement shown, as one example, wheels 170 may be any type of wheel used in the industry.

In the arrangement shown, as one example, wheels 170 contain a camber which, when system 10 is at rest and unloaded, causes wheels 170 to extend upward from the ground at an angle outward. This camber is included to help accommodate for the weight of the agricultural implements, such as combine headers, that system 10 may be used to transport. Such agricultural implements, such as combine headers, weigh a massive amount and they are designed to be placed on the frame assembly 26 located in between the wheelbase of system 10. With the heavy weight placed in the middle of the wheelbase, the wheels 170 of rear wheel assemblies 30 tend to want to angle inward under such heavy loads. In order to accommodate for this, a camber is placed on wheels 170 such that they are angled outward when unloaded but are approximately perpendicular to the road when a load is placed on system 10.

In the arrangement shown, as one example, wheels 170 (and first torsion axle 382 and second torsion axle 386) are allowed to rotate relative to frame assembly 308 and axle frame 380 of rear wheel assembly 306 due to slew bearings 172.

Slew Bearings 172: In the arrangement shown, as one example, rear wheel assembly 306 includes slew bearings 172 on each side of rear wheel assembly 306. Slew bearings 172 are formed of any suitable size, shape, and design and are configured to operably connect to first torsion axle 382 and second torsion axle 386, respectively, as well as axle frame 380, and to help facilitate the turning of wheels 170. In the arrangement shown, as one example, slew bearings 172 include an inner member 200, ball bearings (not shown), and an outer member 202.

In the arrangement shown, as one example, inner member 200 is a generally circular, planar member made of a metallic material. In the arrangement shown, as one example, inner member 200 has a thickness between an upper surface 204 and a lower surface (not shown) and an opening 208 extending through the geographic center of inner member 200. In the arrangement shown, as one example, inner member 200 also includes holes 210 configured to receive bolts therethrough.

In the arrangement shown, as one example, outer member 202 is also a generally circular, planar member made of a metallic material. In the arrangement shown, as one example, outer member 202 has a thickness between an upper surface 212 and a lower surface (not shown) and an opening 216 extending through the geographic center of outer member 202. In the arrangement shown, as one example, outer member 202 also includes holes 218 configured to receive bolts therethrough.

In the arrangement shown, as one example, the opening 216 in the center of outer member 202 is approximately sized such that the inner member 200 may rest within outer member 202. In this manner, outer member 202 and inner member 200 form approximately concentric circles. In the arrangement shown, as one example, inner member 200 and outer member 202 include grooves (not shown). In the arrangement shown, as one example, the groove in the outer member 202 is on its interior surface (not shown) and the groove in the inner member 200 is on its exterior surface (not shown). In the arrangement shown, as one example, ball bearings are placed in the grooves such that they rest within both the grooves in the inner member 200 and outer member 202. In this way, inner member 200 and outer member 202 are operably connected by the ball bearings, but the ball bearings allow inner member 200 and outer member 202 to rotate relative to each other.

In the arrangement shown, as one example, the inner member 200 of one of the slew bearings 172 is configured to operably connect to the bracket 420 of first torsion axle 382 and the inner member 200 of the other slew bearing 172 is configured to operably connect to the bracket 440 of second torsion axle 386. In the arrangement shown, as one example, the inner members 200 of slew bearings 172 are connected to their respective brackets by passing a bolt, screw, or other fastening member through the holes 210 of inner member 200 and through corresponding holes in the respective brackets. In this way, slew bearings 172 operably connect to first torsion axle 382 and second torsion axle 386. In the arrangement shown, as one example, the outer member 202 of slew bearings 172 operably connect to the flanges 390 of axle frame 380 of rear wheel assembly 306. In this way, slew bearings 172 also operably connect to axle frame 380.

In the arrangement shown, as one example, this set up of slew bearings 172 provide a number of benefits and slew bearings 172 are advantageous to use in system 10. Specifically, compared to other types of bearings, slew bearings generally have lower friction, which leads to much greater durability, which means slew bearings 172 will not need to be replaced as often as other types of bearings may need to be. Further, slew bearings allow for smoother and more controlled rotation of the inner member 200 relative to the outer member 202, which produces smoother and more efficient turns of system 10. Finally, slew bearings are capable of supporting heavier loads than other types of bearings and because combine headers and other agricultural implements are extremely heavy, slew bearings 172 are capable of use even when other bearings would fail under the load. Therefore, it is advantageous to use slew bearings 172 compared to other bearings.

While rear wheel assembly 306 and its component parts have been described according to the arrangement shown, as one example, it will be understood by those skilled in the art that any other configuration of rear wheel assembly 306 and its component parts may be used in order to operably connect to steering tube 304 and frame assembly 32 and help facilitate the movement and turning of system 10 when system 10 is on the road.

### Frame Assembly 308:

In the alternative arrangement shown, as one example, system 10 includes a frame assembly 308. Frame assembly 308 is formed of any suitable size, shape, and design and is configured to support an agricultural implement, such as a combine header, while system 10 drives on a road. In the arrangement shown, as one example, frame assembly 308 includes longitudinal members 450, support members 452, latitudinal members 454, and angled members 456, and an upper longitudinal member 458.

Longitudinal Members 450: In the arrangement shown, as one example, frame assembly 308 includes longitudinal members 450. Longitudinal members 450 are formed of any suitable size, shape, and design and are configured to operably connect to front wheel assembly 302 and rear wheel assembly 306 and help support the agricultural implement, such as a combine header, being towed using system 10. In the arrangement shown, as one example, longitudinal members 450 are elongated, rectangular or tube members, however longitudinal members 450 may be shaped or designed in any other manner including being elongated and generally cylindrical in shape or triangular in shape, or any other shape or design. In the arrangement shown, as one example, longitudinal members 450 extend a length between a first end 460, at or near the forward end 12 of system 10, and a second end 462, at or near the rearward end 14 of system 10.

In the arrangement shown, as one example, longitudinal members 450 may be formed of a single, unitary member that is formed in a manufacturing process such as machining, extrusion, forming, casting, additive manufacturing, or the like to form a unitary and monolithic member. Alternatively, longitudinal members 450 may be formed of multiple pieces that are connected or assembled to one another through bolting, welding, screwing, friction fitting, or the like or any other means of connecting two members. In the arrangement shown, as one example, longitudinal members 450 is formed primarily of a metallic material such as steel, aluminum, chromium, or any other metallic material, alloy, and/or composite thereof. Alternatively, longitudinal members 450 may be formed of a non-metallic material such as a plastic material, a fiberglass material, or any other non-metallic material and/or composite thereof.

In the arrangement shown, as one example, the longitudinal members 450 connect to axle frame 334 of front wheel assembly 302 at the first end 460 of longitudinal members 450 and to axle frame 380 of rear wheel assembly 306 at the second end 462 of longitudinal members 450. Additionally, in the arrangement shown, as one example, there are two longitudinal members 450, one at the left side 16 and one at the right side 18 of system 10, and the two longitudinal members 450 are connected by latitudinal members 454.

Support Members 452: In the arrangement shown, as one example, frame assembly 308 includes support members 452. Support members 452 are formed of any suitable size, shape, and design and are configured to help support and hold the agricultural implement placed on system 10. In the arrangement shown, as one example, support members 452 are positioned on one of the longitudinal members 450 along the length of such longitudinal member 450 and they contact the agricultural implement placed on system 10 and prevent it from slipping or falling off system 10 since the agricultural implement is placed at an angle on system 10.

Latitudinal Members 454: In the arrangement shown, as one example, frame assembly 308 includes latitudinal members 454. Latitudinal members 454 are formed of any suitable size, shape, and design and are configured to operably connect longitudinal members 450 and provide support to the agricultural implement, such as a combine header, being hauled by system 10.

In the arrangement shown, as one example, latitudinal members 454 are elongated, rectangular or tube members, however latitudinal members 454 may be shaped or designed in any other manner including being elongated and generally cylindrical in shape or triangular in shape, or any other shape or design. In the arrangement shown, as one example, latitudinal members 454 extend a length between a first end 464, which is operably connected to one longitudinal member 450, and a second end 466, which is operably connected to the other longitudinal member 450. In the arrangement shown, as one example, latitudinal members 454 may connect to longitudinal members 450 through welding, or any other means of connecting two members including screwing, bolting, or any other method of connecting two members.

In the arrangement shown, as one example, latitudinal members 454 may be formed of a single, unitary member that is formed in a manufacturing process such as machining, extrusion, forming, casting, additive manufacturing, or the like to form a unitary and monolithic member. Alternatively, latitudinal members 454 may be formed of multiple pieces that are connected or assembled to one another through bolting, welding, screwing, friction fitting, or the like or any other means of connecting two members. In the arrangement shown, as one example, latitudinal members 454 is formed primarily of a metallic material such as steel, aluminum, chromium, or any other metallic material, alloy, and/or composite thereof. Alternatively, latitudinal members 454 may be formed of a non-metallic material such as a plastic material, a fiberglass material, or any other non-metallic material and/or composite thereof.

Angled Members 456: In the arrangement shown, as one example, frame assembly 308 includes angled members 456. Angled members 456 are formed of any suitable size, shape, and design and are configured to give a slope to frame assembly 308 to help keep the agricultural implement being towed by system 10 within road width limits, and to help support the load of the agricultural implement, such as a combine header, which is being towed by system 10.

In the arrangement shown, as one example, angled members 456 are elongated, rectangular or tube members, however angled members 456 may be shaped or designed in any other manner including being elongated and generally cylindrical in shape or triangular in shape, or any other shape or design. In the arrangement shown, as one example, angled members 456 extend a length between a first end 468, which is positioned near the middle of system 10 and connects to a latitudinal member 454, and a second end 470, which extends upward at an angle as it travels towards a side of system 10. In the arrangement shown, as one example, the first end of angled members 456 may connect to latitudinal members 454 through welding, or any other means of connecting two members including screwing, bolting, or any other method of connecting two members.

In the arrangement shown, as one example, angled members 456 may be formed of a single, unitary member that is formed in a manufacturing process such as machining, extrusion, forming, casting, additive manufacturing, or the like to form a unitary and monolithic member. Alternatively, angled members 456 may be formed of multiple pieces that are connected or assembled to one another through bolting, welding, screwing, friction fitting, or the like or any other means of connecting two members. In the arrangement shown, as one example, angled members 456 is formed primarily of a metallic material such as steel, aluminum, chromium, or any other metallic material, alloy, and/or composite thereof. Alternatively, angled members 456 may be formed of a non-metallic material such as a plastic material, a fiberglass material, or any other non-metallic material and/or composite thereof.

In the arrangement shown, as one example, angled members 456 include one or more vertical members 472. Vertical members 472 of angled members 456 are formed of any suitable size, shape, and design and are configured to operably connect to a longitudinal member 450 and extend upward from such longitudinal member 450 in order to create the angle of angled members 456, and also to support angled member 456 when the heavy weight of an agricultural implement is on system 10 and the angled members 456. In the arrangement shown, as one example, vertical members 472 are strong, rigid, primarily rectangular members which are strong enough to support very heavy loads and not fail under such loads. In one or more arrangements, as examples, vertical members 472 may be formed of a metallic material or any other non-metallic material of composite thereof which has the required strength to withstand the loads of the agricultural implements placed on system 10.

In the arrangement shown, as one example, vertical members 472 connect to latitudinal members 454 and extend upward until they meet angled members 456. In the arrangement shown, as one example, vertical members 472 are positioned such that they are also positioned approximately below the upper longitudinal member 458. In the arrangement shown, as one example, when an agricultural implement is placed on system 10, because upper longitudinal member 458 will contact the agricultural implement and bear a weight at that point on system 10, vertical members 472 are positioned at that spot, approximately below the upper longitudinal member 458, in order to provide greater support in that spot to help better support the agricultural implement placed on system 10.

Upper Longitudinal Member 458: In the arrangement shown, as one example, frame assembly 308 includes upper longitudinal member 458. Upper longitudinal member 458 is formed of any suitable size, shape, and design and is configured to help support the agricultural implement, such as a combine header, being towed using system 10. In the arrangement shown, as one example, upper longitudinal member 458 is an elongated, rectangular or tube member, however upper longitudinal member 458 may be shaped or designed in any other manner including being elongated and generally cylindrical in shape or triangular in shape, or any other shape or design. In the arrangement shown, as one example, upper longitudinal member 458 extends a length between a first end 476, at the forward end 12 of system 10, and a second end 478, at or near the rearward end 14 of system 10.

In the arrangement shown, as one example, upper longitudinal member 458 may be formed of a single, unitary member that is formed in a manufacturing process such as machining, extrusion, forming, casting, additive manufacturing, or the like to form a unitary and monolithic member. Alternatively, upper longitudinal member 458 may be formed of multiple pieces that are connected or assembled to one another through bolting, welding, screwing, friction fitting, or the like or any other means of connecting two members. In the arrangement shown, as one example, upper longitudinal member 458 is formed primarily of a metallic material such as steel, aluminum, chromium, or any other metallic material, alloy, and/or composite thereof. Alternatively, upper longitudinal member 458 may be formed of a non-metallic material such as a plastic material, a fiberglass material, or any other non-metallic material and/or composite thereof.

In the arrangement shown, as one example, the upper longitudinal member 458 connects to the angled members 456 of frame assembly 308, thereby being supported by the angled members 456 and vertical members 472 of angled members 456. In this way, upper longitudinal members 458 are properly supported to bear the load of the agricultural implement being placed on system 10.

While frame assembly 308 and its component parts have been described according to the arrangement shown, as one example, it will be understood by those skilled in the art that any other configuration of frame assembly 308 and its component parts may be used in order to support an agricultural implement, such as a combine header, while system 10 drives on a road.

From the above discussion it will be appreciated that a header trailer system 10 is presented herein which improves upon the state of the art. Specifically, in one or more arrangements, a header trailer system 10 is presented which: improves upon the state of the art; is safe to operate; is able to comply with road travel restrictions; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; and/or is efficient to use and operate.

What is claimed:

1. A trailer system, comprising;
a front wheel assembly;
the front wheel assembly having a first set of wheels;
a rear wheel assembly;
the rear wheel assembly having a second set of wheels;
wherein the wheels of the front wheel assembly turn when the trailer is performing a turn;
wherein the wheels of the rear wheel assembly turn when the trailer is performing a turn;
wherein the trailer is configured to support an agricultural implement.

2. The system of claim 1, wherein the front wheel assembly includes a torsion axle.

3. The system of claim 1, wherein the rear wheel assembly includes a torsion axle.

4. The system of claim 1, wherein the front wheel assembly includes a slew bearing.

5. The system of claim 1, wherein the rear wheel assembly include a slew bearing.

6. The system of claim 1, wherein the front wheel assembly is operably connected to the rear wheel assembly through a steering assembly.

7. The system of claim 1, wherein the front wheel assembly is operably connected to the rear wheel assembly through a steering assembly; wherein the steering assembly transfers the turning of the first set of wheels of the front wheel assembly to the turning of second set of wheels of the rear wheel assembly.

8. A trailer system, comprising;
a front wheel assembly;
the front wheel assembly having a first set of wheels;
the front wheel assembly having slew bearings;
a rear wheel assembly;
the rear wheel assembly having a second set of wheels;
the rear wheel assembly having slew bearings;
wherein the first set of wheels of the front wheel assembly turn when the trailer is performing a turn;
wherein the slew bearings of the front wheel assembly allow for smooth turning of the first set of wheels of the front wheel assembly and the slew bearings of the rear wheel assembly allow for smooth turning of the second set of wheels of the rear wheel assembly when the trailer is performing a turn;
wherein the trailer is configured to support an agricultural implement.

9. The system of claim 8, wherein the front wheel assembly includes a torsion axle.

10. The system of claim 8, wherein the rear wheel assembly includes a torsion axle.

11. The system of claim 8, wherein the front wheel assembly is operably connected to the rear wheel assembly through a steering assembly.

12. The system of claim 8, wherein the front wheel assembly is operably connected to the rear wheel assembly through a steering assembly; wherein the steering assembly transfers the turning of the first set of wheels of the front wheel assembly to the turning of second set of wheels of the rear wheel assembly.

13. A trailer system, comprising;
a front wheel assembly;
the front wheel assembly having a first set of wheels;
wherein the wheels of the front wheel assembly can be rotated 360 degrees;
a rear wheel assembly;
the rear wheel assembly having a second set of wheels;
wherein the first set of wheels of the front wheel assembly turn when the trailer is performing a turn;
wherein the second set of wheels of the rear wheel assembly turn when the trailer is performing a turn;
wherein the trailer is configured to support an agricultural implement.

14. The system of claim 13, wherein the front wheel assembly includes a torsion axle.

15. The system of claim 13, wherein the rear wheel assembly includes a torsion axle.

16. The system of claim 13, wherein the front wheel assembly includes a slew bearing.

17. The system of claim 13, wherein the rear wheel assembly include a slew bearing.

18. The system of claim 13, wherein the front wheel assembly is operably connected to the rear wheel assembly through a steering assembly.

19. The system of claim 13, wherein the front wheel assembly is operably connected to the rear wheel assembly through a steering assembly; wherein the steering assembly transfers the turning of the first set of wheels of the front wheel assembly to the turning of the second set of wheels of the rear wheel assembly.

20. A trailer system, comprising;
a tongue assembly;
a front wheel assembly;
the front wheel assembly having a first set of wheels;
the front wheel assembly operably connected to the tongue assembly;
a steering assembly;
the steering assembly operably connected to the front wheel assembly;
a rear wheel assembly;
the rear wheel assembly having a second set of wheels;
the rear wheel assembly operably connected to the steering assembly;
wherein the trailer is configured to support an agricultural implement;
wherein the tongue assembly connects to a vehicle and when the vehicle performs a turn, the tongue causes the first set of wheels of the front wheel assembly to turn;
wherein the steering assembly translates the turning of the first set of wheels of the front wheel assembly to the rear wheel assembly, thereby causing the second set of wheels of the rear wheel assembly to turn.

21. The system of claim 20, wherein the front wheel assembly includes a torsion axle.

22. The system of claim 20, wherein the rear wheel assembly includes a torsion axle.

23. The system of claim 20, wherein the first set of wheels of the front wheel assembly may be rotated 360 degrees.

24. The system of claim 20, wherein the front wheel assembly includes a slew bearing.

25. The system of claim 20, wherein the rear wheel assembly includes a slew bearing.
